(19) United States
(12) Patent Application Publication
(10) Pub. No.: US 2025/0162789 A1
(43) Pub. Date: May 22, 2025

(54) THROTTLE DEVICE

(71) Applicant: Altria Client Services LLC, Richmond, VA (US)

(72) Inventors: Henry CHANG, Midlothian, VA (US); Dwight David WILLIAMS, Powhatan, VA (US); Travis Martin GARTHAFFNER, Midlothian, VA (US)

(73) Assignee: Altria Client Services LLC, Richmond, VA (US)

(21) Appl. No.: 18/947,904

(22) Filed: Nov. 14, 2024

Related U.S. Application Data
(60) Provisional application No. 63/602,059, filed on Nov. 22, 2023.

(51) Int. Cl. B65D 88/66; B65D 90/62

(52) U.S. Cl. CPC B65D 88/66; B65D 90/626; B65D 2588/64

(57) ABSTRACT

A doser apparatus includes a throttle device on a doser mechanism. The throttle device includes a vibratory hopper and a vibration device. The vibratory hopper is configured to hold a granular material within a vibratory hopper conduit that tapers towards a bottom opening and is configured to induce bridging of the granular material at the bottom opening. The vibration device is configured to break the bridging of the granular material at the bottom opening to induce flow of the granular material through the bottom opening to a doser reservoir of the doser mechanism, based on inducing vibration of the vibratory hopper. The throttle device is configured to control a head pressure of the granular material at a portion of a conveyor device of the doser mechanism extending into the doser reservoir based on operating the vibration device to adjustably control the flow of granular material through the bottom opening.

### CROSS-REFERENCE TO RELATED APPLICATION

This application claims priority to and the benefit of U.S. Provisional Patent Application No. 63/602,059 filed in the United States Patent and Trademark Office on Nov. 22, 2023, the entire contents of which are incorporated herein by reference.

### BACKGROUND

### Field

The present inventive concepts relate to portioning of granular materials, including powder materials, and more particularly to controlling a pressure of granular material acting on a doser mechanism configured to convey and supply particular amounts (e.g., portions, doses, indexes, etc.) of granular material based on controlling a flow rate of granular material supplied to a hopper from which the doser mechanism draws the granular material, to provide improved reliability and consistency of supply of amounts of granular material having a controllable volume.

### Description of Related Art

Some products, including some consumer goods, include packaged portions (“portioned instances”) of a granular material (also referred to herein as simply a “material”). In some cases, such portioned instances may be produced (“provided,” “manufactured,” etc.) based on portioning (e.g., dividing) and/or supplying a relatively large (“bulk”) instance of the material into multiple smaller portioned instances (e.g., doses, indexes, dose amounts, index amounts, or the like), and packaging the portioned instances.

### SUMMARY

According to some example embodiments, a doser apparatus may include a doser mechanism and a throttle device on the doser mechanism. The doser mechanism may include a conveyor device and one or more inner surfaces defining a doser reservoir. The doser reservoir may have a reservoir inlet opening and a reservoir outlet opening. At least a portion of the conveyor device may extend into the doser reservoir through the reservoir outlet opening. The doser mechanism may be configured to discharge an index amount of a granular material based on operation of the conveyor device to draw a portion of the granular material from the doser reservoir through the reservoir outlet opening and to discharge the portion of the granular material from a doser outlet. The throttle device may include a vibratory hopper defining a vibratory hopper conduit tapering from a vibratory hopper top opening towards a vibratory hopper bottom opening. The vibratory hopper may be configured to hold a first amount of the granular material within the vibratory hopper conduit. The vibratory hopper may be configured to induce bridging of the granular material at the vibratory hopper bottom opening. The throttle device may include a vibration device mechanically coupled to the vibratory hopper. The vibration device may be configured to break the bridging of the granular material at the vibratory hopper bottom opening to induce a flow of the granular material from the vibratory hopper conduit to the doser reservoir through the vibratory hopper bottom opening, based on inducing vibration of the vibratory hopper. The throttle device may be configured to control a head pressure of the granular material at the portion of the conveyor device extending into the doser reservoir based on operating the vibration device to adjustably control the flow of the granular material from the vibratory hopper conduit to the doser reservoir through the vibratory hopper bottom opening.

The doser apparatus may further include a supply hopper on the throttle device. The supply hopper may be configured to hold a supply amount of the granular material within a supply hopper conduit at least partially tapering from a supply hopper top opening towards a supply hopper bottom opening. The supply hopper may be configured to direct a supply flow of the granular material from the supply hopper conduit to the vibratory hopper conduit through the supply hopper bottom opening.

The doser apparatus may further include a plurality of doser mechanisms. The plurality of doser mechanisms may include the doser mechanism. The plurality of doser mechanisms may each have a separate doser reservoir and a separate conveyor device, the plurality of doser mechanisms configured to discharge separate, respective amounts of the granular material in parallel. The doser apparatus may include a plurality of throttle devices coupled between the supply hopper and separate, respective doser mechanisms of the plurality of doser mechanisms. The plurality of throttle devices may include the throttle device. The plurality of throttle devices may be configured to supply multiple, parallel flows of the granular material from the supply hopper to separate, respective doser reservoirs of the plurality of doser mechanisms.

The throttle device may be configured to enable the vibratory hopper to move in relation to the doser mechanism.

At least a portion of the vibratory hopper may extend into the doser reservoir such that the vibratory hopper bottom opening is between an inlet opening of the doser reservoir and an outlet opening of the doser reservoir that exposes the conveyor device to the doser reservoir.

The throttle device may include an intake hopper on the vibratory hopper. The intake hopper may define an intake hopper conduit at least partially tapering from an intake hopper top opening to an intake hopper bottom opening. The intake hopper may be configured to direct an intake flow of the granular material from the intake hopper conduit through the intake hopper bottom opening and into the vibratory hopper conduit through the vibratory hopper top opening.

The intake hopper may be fixed in position in relation to the doser mechanism. The throttle device may be configured to enable movement of the vibratory hopper in relation to the intake hopper.

A bottom portion of the intake hopper may extend vertically through the vibratory hopper top opening and into the vibratory hopper conduit, such that the vibratory hopper at least partially surrounds the bottom portion of the intake hopper, and the throttle device is configured to mitigate flow of the granular material out of the vibratory hopper conduit through an annular portion of the vibratory hopper top opening defined between an outer surface of the bottom portion of the intake hopper and an inner surface of the vibratory hopper defining an upper portion of the vibratory hopper conduit.

The bottom portion of the intake hopper that extends into the vibratory hopper conduit may be isolated from direct contact with the vibratory hopper.

The doser apparatus may further include a supply hopper on the throttle device. The supply hopper may be configured to hold a supply amount of the granular material within a supply hopper conduit at least partially tapering from a supply hopper top opening towards a supply hopper bottom opening. The supply hopper may be configured to direct a supply flow of the granular material from the supply hopper conduit to the intake hopper conduit through the supply hopper bottom opening and the intake hopper top opening.

A bottom portion of the supply hopper may extend vertically through the intake hopper top opening and into the intake hopper conduit, such that the intake hopper at least partially surrounds the bottom portion of the supply hopper, and the throttle device is configured to mitigate flow of the granular material out of the intake hopper conduit through an annular portion of the intake hopper top opening defined between an outer surface of the bottom portion of the supply hopper and an inner surface of the intake hopper defining an upper portion of the intake hopper conduit.

The bottom portion of the supply hopper that extends into the intake hopper conduit may be isolated from direct contact with the intake hopper.

According to some example embodiments, a packaging machine may include the doser apparatus. The packaging machine may include a packaging supply device configured to supply a strip of packaging material that is folded to establish a folded strip of packaging material that defines an open enclosure having an enclosure opening, wherein the doser apparatus is configured to discharge the index amount of the granular material into the open enclosure through the enclosure opening to at least partially fill a distal portion of the open enclosure with the index amount of the granular material. The packaging machine may include a sealing device configured to join opposing surfaces of the folded strip of packaging material to isolate the distal portion of the open enclosure from a remainder of the open enclosure that includes the enclosure opening such that the isolated distal portion of the open enclosure establishes a sealed enclosure that contains the index amount of the granular material in the folded strip of packaging material. The packaging machine may include a cutting device configured to separate the sealed enclosure from a remainder of the folded strip of packaging material to establish an article of packaging that contains the index amount of the granular material.

According to some example embodiments, a method of operating the doser apparatus may include: controlling the conveyor device of the doser mechanism to operate to draw a granular material out of the doser reservoir and to discharge the granular material from the doser mechanism via the doser outlet; and operating the vibration device of the throttle device on the doser mechanism to induce a flow of the granular material from the vibratory hopper conduit to the doser reservoir through the vibratory hopper bottom opening based on inducing vibration of the vibratory hopper to overcome the bridging of the first amount of the granular material in the vibratory hopper conduit. The vibration device may be operated to control the flow of the granular material from the vibratory hopper conduit to the doser reservoir through the vibratory hopper bottom opening concurrently with the operating of the conveyor device to cause the head pressure of the granular material at the portion of the conveyor device that is exposed to the doser reservoir to be less than a threshold pressure magnitude that is associated with bridging of the granular material at the conveyor device in the doser reservoir.

According to some example embodiments, a doser apparatus may include a doser mechanism and a throttle device on the doser mechanism. The doser mechanism may include a conveyor device and one or more inner surfaces defining a doser reservoir. The doser reservoir may have a reservoir inlet opening and a reservoir outlet opening. At least a portion of the conveyor device may extend into the doser reservoir through the reservoir outlet opening. The conveyor device may further extend at least between the reservoir outlet opening and a doser outlet opening. The throttle device may include a vibratory hopper defining a vibratory hopper conduit tapering from a vibratory hopper top opening towards a vibratory hopper bottom opening, the vibratory hopper bottom opening vertically overlapping the reservoir inlet opening. The throttle device may include a vibration device mechanically coupled to the vibratory hopper.

The doser apparatus may further include a supply hopper on the throttle device. The supply hopper may define a supply hopper conduit tapering from a supply hopper top opening towards a supply hopper bottom opening. The supply hopper bottom opening may vertically overlap the vibratory hopper top opening.

At least a portion of the supply hopper may extend into the vibratory hopper conduit such that the supply hopper bottom opening is between the vibratory hopper top opening and the vibratory hopper bottom opening.

The doser apparatus may include a plurality of doser mechanisms. The plurality of doser mechanisms may include the doser mechanism. The plurality of doser mechanisms may each have a separate doser reservoir and a separate conveyor device at least partially extending into the separate doser reservoir. The doser apparatus may include a plurality of throttle devices coupled between the supply hopper and separate, respective doser reservoirs of separate, respective doser mechanisms of the plurality of doser mechanisms, the plurality of throttle devices including the throttle device.

The throttle device may include an interface structure coupled to the doser mechanism such that the interface structure is fixed in position in relation to the doser mechanism, and at least one standoff member configured to couple the vibratory hopper to the interface structure such that the vibratory hopper is structurally supported on the interface structure by the at least one standoff member, the at least one standoff member configured to enable the vibratory hopper to move in relation to the interface structure.

At least a portion of the vibratory hopper may extend into the doser reservoir such that the vibratory hopper bottom opening is between an inlet opening of the doser reservoir and an outlet opening of the doser reservoir that exposes the conveyor device to the doser reservoir.

The portion of the vibratory hopper extending into the doser reservoir may be isolated from direct contact with any inner surface of the doser mechanism defining the doser reservoir.

The doser mechanism may include a doser cartridge that is removably coupled to a remainder of the doser mechanism, the doser cartridge including the conveyor device and defining a lower portion of the doser reservoir, the remainder of the doser mechanism defining an upper portion of the doser reservoir. The portion of the vibratory hopper extending into the doser reservoir may be entirely within the upper portion of the doser reservoir and is spaced apart from the lower portion of the doser reservoir that is defined by the doser cartridge.

The throttle device may include an intake hopper on the vibratory hopper. The intake hopper may define an intake hopper conduit tapering from an intake hopper top opening towards an intake hopper bottom opening, the intake hopper bottom opening vertically overlapping the vibratory hopper top opening.

At least a portion of the intake hopper may extend into the vibratory hopper conduit such that the intake hopper bottom opening is between the vibratory hopper top opening and the vibratory hopper bottom opening.

The portion of the intake hopper extending into the vibratory hopper conduit may be isolated from direct contact with any inner surface of the vibratory hopper defining the vibratory hopper conduit.

The intake hopper may be fixed in position in relation to the doser mechanism, and the vibratory hopper may be movable in relation to the intake hopper.

The doser apparatus may include a supply hopper on the throttle device. The supply hopper may define a supply hopper conduit tapering from a supply hopper top opening towards a supply hopper bottom opening. The supply hopper bottom opening may vertically overlap the intake hopper top opening. The supply hopper bottom opening may be between the supply hopper top opening and the intake hopper top opening.

At least a portion of the supply hopper may extend into the intake hopper conduit such that the supply hopper bottom opening is between the intake hopper top opening and the intake hopper bottom opening.

The vibration device may be a pneumatic ball vibration device.

According to some example embodiments, a packaging machine may include the doser apparatus. The packaging machine may include a packaging supply device configured to supply a strip of packaging material that is folded to establish a folded strip of packaging material that defines an open enclosure having an enclosure opening, wherein the doser apparatus is configured to discharge an index amount of a granular material into the open enclosure through the enclosure opening to at least partially fill a distal portion of the open enclosure with the index amount of the granular material. The packaging machine may include a sealing device configured to join opposing surfaces of the folded strip of packaging material to isolate the distal portion of the open enclosure from a remainder of the open enclosure that includes the enclosure opening such that the isolated distal portion of the open enclosure establishes a sealed enclosure that contains the index amount of the granular material in the folded strip of packaging material. The packaging machine may include a cutting device configured to separate the sealed enclosure from a remainder of the folded strip of packaging material to establish an article of packaging that contains the index amount of the granular material.

According to some example embodiments, a method of operating the doser apparatus may include: controlling the conveyor device of the doser mechanism to operate to draw a granular material out of the doser reservoir and to discharge the granular material from the doser mechanism via the doser outlet; and causing a flow of the granular material to be supplied from the vibratory hopper of the throttle device to the doser reservoir via the vibratory hopper bottom opening, based on operating the vibration device to controllably overcome bridging of the granular material in the vibratory hopper conduit of the vibratory hopper.

The operating of the vibration device may cause a head pressure of the granular material at the portion of the conveyor device extending into the doser reservoir to be less than a threshold head pressure associated with bridging of the granular material at the conveyor device.

### BRIEF DESCRIPTION OF THE DRAWINGS

The various features and advantages of the non-limiting example embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a perspective view of a doser apparatus according to some example embodiments.

FIG. 2A is a perspective cross-sectional view of the doser apparatus of FIG. 1 along cross-sectional view line IIA-IIA′ in FIG. 1, according to some example embodiments.

FIG. 2B is an elevation cross-sectional view of the doser apparatus of FIG. 1 along cross-sectional view line IIA-IIA′ in FIG. 1, according to some example embodiments.

FIG. 2C is an expanded view of region 2C of FIG. 2B, according to some example embodiments.

FIG. 2D is a perspective cross-sectional view of the doser apparatus of FIG. 1 along cross-sectional view line IID-IID′ in FIG. 2B, according to some example embodiments.

FIG. 3A is a perspective cross-sectional view of the doser apparatus of FIG. 1 along cross-sectional view line IIIA-IIIA′ in FIG. 2B, according to some example embodiments.

FIG. 3B is an elevation cross-sectional view of the doser apparatus of FIG. 1 along cross-sectional view line IIIA-IIIA′ in FIG. 2B, according to some example embodiments.

FIG. 3C is an expanded view of region 3C of FIG. 3B, according to some example embodiments.

FIG. 4A is a perspective top view of a throttle device, according to some example embodiments.

FIG. 4B is a cross-sectional view of the throttle device of FIG. 4A along cross-sectional view line IVB-IVB′ in FIG. 4A, according to some example embodiments.

FIG. 4C is a cross-sectional view of the throttle device of FIG. 4A along cross-sectional view line IVC-IVC′ in FIG. 4A, according to some example embodiments.

FIG. 5A is a perspective top view of a doser apparatus including a throttle device, according to some example embodiments.

FIG. 5B is a cross-sectional view of the doser apparatus of FIG. 5A along cross-sectional view line VB-VB′ in FIG. 5A, according to some example embodiments.

FIG. 5C is a cross-sectional view of the doser apparatus of FIG. 5A along cross-sectional view line VC-VC′ in FIG. 5A, according to some example embodiments.

FIG. 6 is a schematic view of a packaging machine that includes at least one doser apparatus, according to some example embodiments.

FIGS. 7A, 7B, 7C, 7D, and 7E are expanded perspective views of respective regions A, B, C, D, and E of the packaging machine of FIG. 6, according to some example embodiments.

FIG. 8 is a perspective view of region C of the packaging machine of FIG. 6, according to some example embodiments.

FIG. 9 is a flowchart illustrating a method of operating a doser apparatus that includes a throttle device, according to some example embodiments.

FIG. 10 is a flowchart illustrating a method of operating a packaging machine that includes a doser apparatus that further includes a throttle device, according to some example embodiments.

### DETAILED DESCRIPTION

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures, and redundant descriptions thereof are omitted.

It should be understood that when an element is referred to as being “on,” “connected to,” “coupled to,” or “covering” another element, it may be directly on, connected to, coupled to, or covering the other element or intervening elements or layers may be present. In contrast, when an element is referred to as being “directly on,” “directly connected to,” or “directly coupled to” another element, there are no intervening elements present. Like numbers refer to like elements throughout the specification. As used herein, the term “and/or” includes any and all combinations of one or more of the associated listed items.

It should be understood that, although the terms first, second, third, etc. may be used herein to describe various elements, regions, layers and/or sections, these elements, regions, layers, and/or sections should not be limited by these terms. These terms are only used to distinguish one element, region, layer, or section from another region, layer, or section. Thus, a first element, region, layer, or section discussed below could be termed a second element, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. The device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, and/or elements, but do not preclude the presence or addition of one or more other features, integers, steps, operations, elements, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing.

Unless otherwise defined, all terms (including technical and scientific terms) used herein have the same meaning as commonly understood by one of ordinary skill in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

It will be understood that elements and/or properties thereof (e.g., structures, surfaces, directions, or the like), which may be referred to as being “perpendicular,” “parallel,” “coplanar,” or the like with regard to other elements and/or properties thereof (e.g., structures, surfaces, directions, or the like) may be “perpendicular,” “parallel,” “coplanar,” or the like or may be “substantially perpendicular,” “substantially parallel,” “substantially coplanar,” respectively, with regard to the other elements and/or properties thereof.

Elements and/or properties thereof (e.g., structures, surfaces, directions, or the like) that are “substantially perpendicular”, “substantially parallel”, or “substantially coplanar” with regard to other elements and/or properties thereof will be understood to be “perpendicular”, “parallel”, or “coplanar”, respectively, with regard to the other elements and/or properties thereof within manufacturing tolerances and/or material tolerances and/or have a deviation in magnitude and/or angle from “perpendicular”, “parallel”, or “coplanar”, respectively, with regard to the other elements and/or properties thereof that is equal to or less than 10% (e.g., a. tolerance of ±10%).

It will be understood that elements and/or properties thereof may be recited herein as being “the same” or “equal” as other elements, and it will be further understood that elements and/or properties thereof recited herein as being “identical” to, “the same” as, or “equal” to other elements may be “identical” to, “the same” as, or “equal” to or “substantially identical” to, “substantially the same” as or “substantially equal” to the other elements and/or properties thereof. Elements and/or properties thereof that are “substantially identical” to, “substantially the same” as or “substantially equal” to other elements and/or properties thereof will be understood to include elements and/or properties thereof that are identical to, the same as, or equal to the other elements and/or properties thereof within manufacturing tolerances and/or material tolerances. Elements and/or properties thereof that are identical or substantially identical to and/or the same or substantially the same as other elements and/or properties thereof may be structurally the same or substantially the same, functionally the same or substantially the same, and/or compositionally the same or substantially the same. While the term “same,” “equal” or “identical” may be used in description of some example embodiments, it should be understood that some imprecisions may exist. Thus, when one element is referred to as being the same as another element, it should be understood that an element or a value is the same as another element within a desired manufacturing or operational tolerance range (e.g., ±10%).

It will be understood that elements and/or properties thereof described herein as being “substantially” the same and/or identical encompasses elements and/or properties thereof that have a relative difference in magnitude that is equal to or less than 10%. Further, regardless of whether elements and/or properties thereof are modified as “substantially,” it will be understood that these elements and/or properties thereof should be construed as including a manufacturing or operational tolerance (e.g., ±10%) around the stated elements and/or properties thereof.

When the terms “about” or “substantially” are used in this specification in connection with a numerical value, it is intended that the associated numerical value includes a manufacturing or operational tolerance (e.g., ±10%) around the stated numerical value. Moreover, when the words “about” and “substantially” are used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes. When ranges are specified, the range includes all values therebetween such as increments of 0.1%.

As described herein, when an operation is described to be performed, or an effect such as a structure is described to be established “by” or “through” performing additional operations, it will be understood that the operation may be performed and/or the effect/structure may be established “based on” the additional operations, which may include performing said additional operations alone or in combination with other further additional operations.

As described herein, an element that is described to be “spaced apart” from another element, in general and/or in a particular direction (e.g., vertically spaced apart, laterally spaced apart, etc.) and/or described to be “separated from” the other element, may be understood to be isolated from direct contact with the other element, in general and/or in the particular direction (e.g., isolated from direct contact with the other element in a vertical direction, isolated from direct contact with the other element in a lateral or horizontal direction, etc.). Similarly, elements that are described to be “spaced apart” from each other, in general and/or in a particular direction (e.g., vertically spaced apart, laterally spaced apart, etc.) and/or are described to be “separated” from each other, may be understood to be isolated from direct contact with each other, in general and/or in the particular direction (e.g., isolated from direct contact with each other in a vertical direction, isolated from direct contact with each other in a lateral or horizontal direction, etc.). Similarly, a structure described herein to be between two other structures to separate the two other structures from each other may be understood to be configured to isolate the two other structures from direct contact with each other.

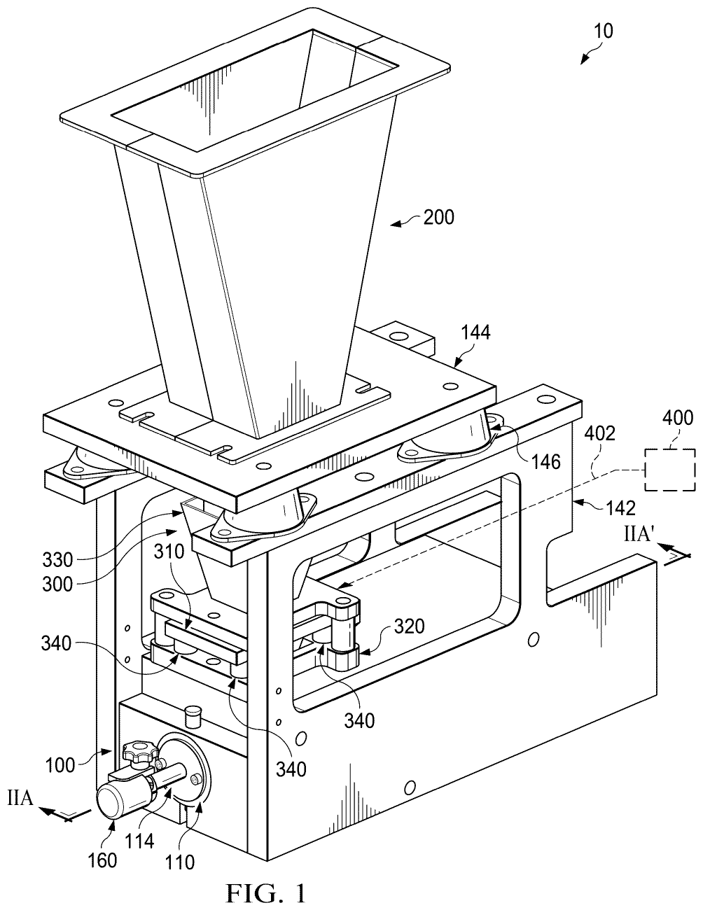

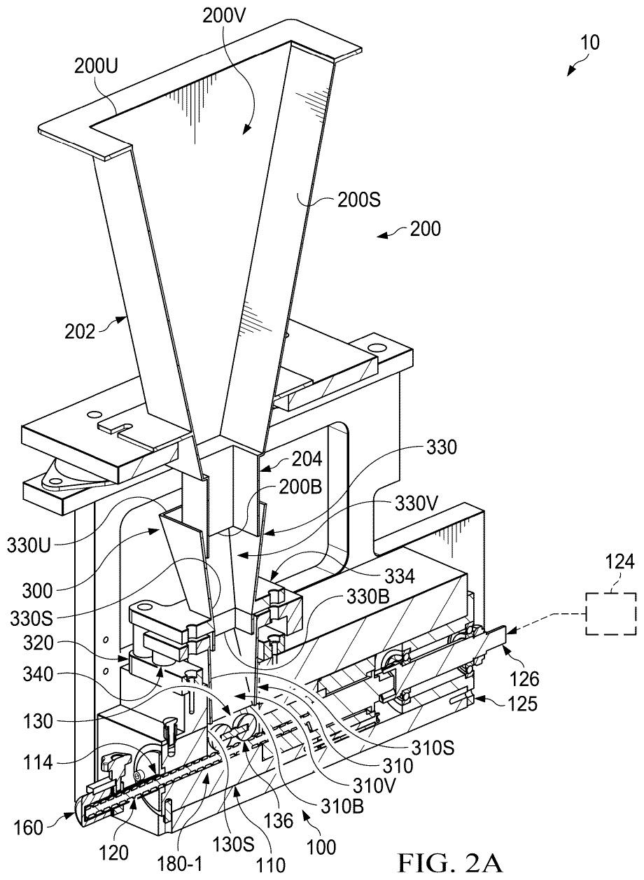

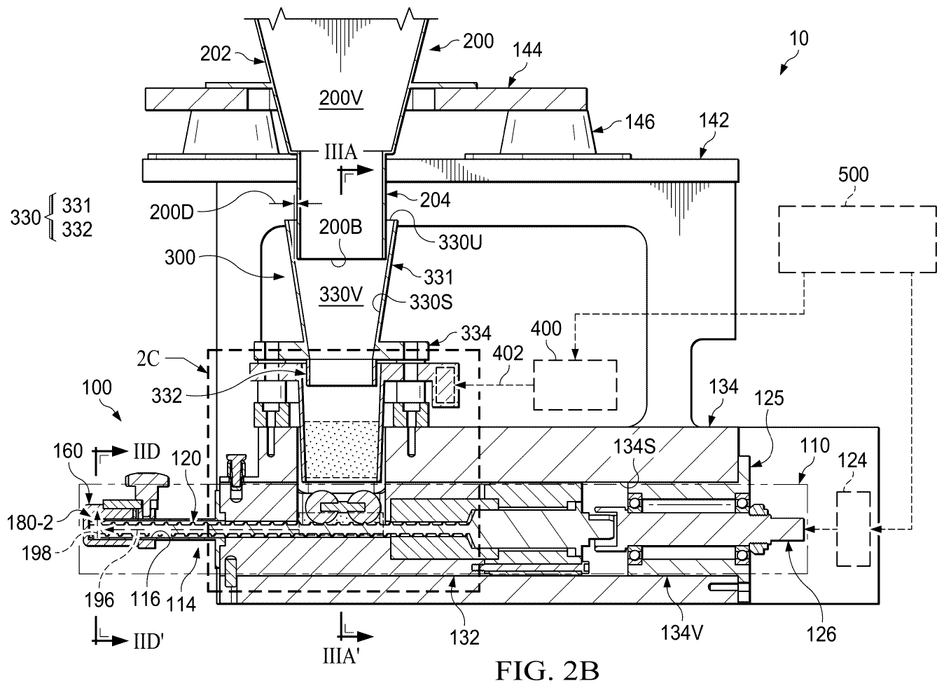

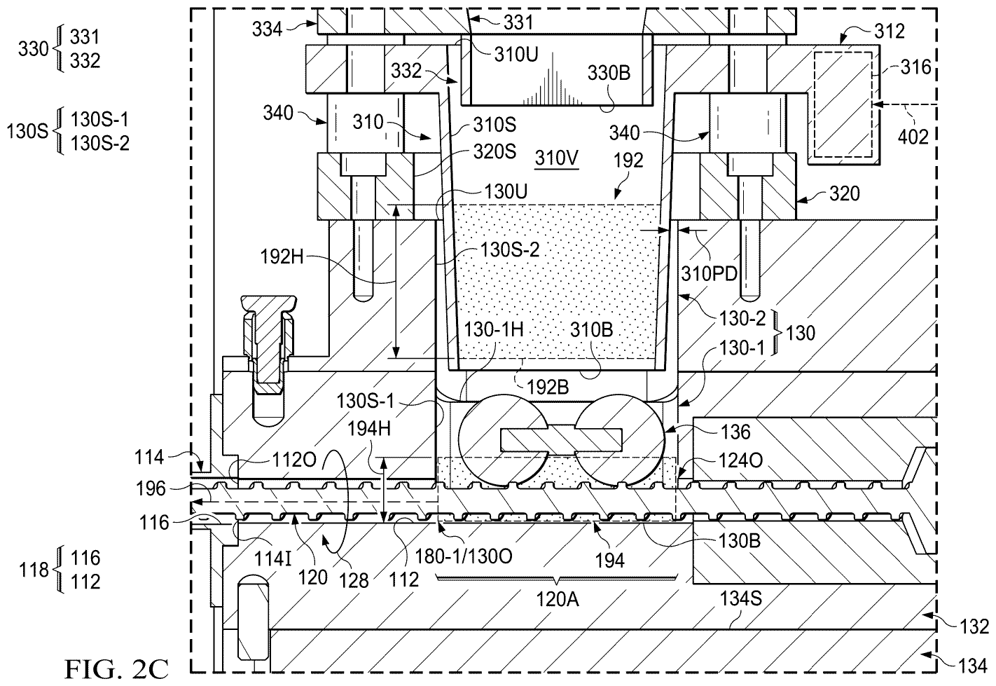

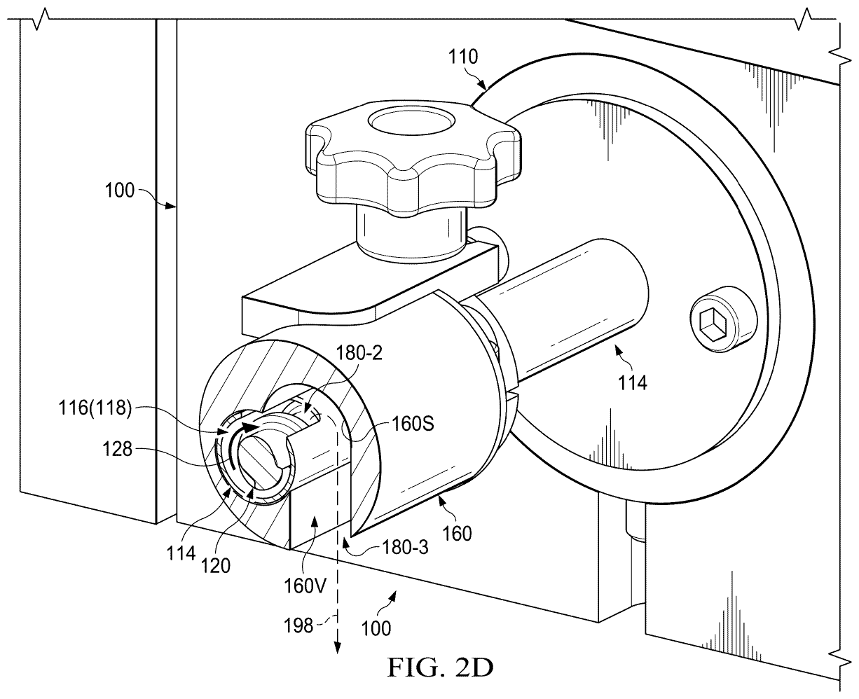

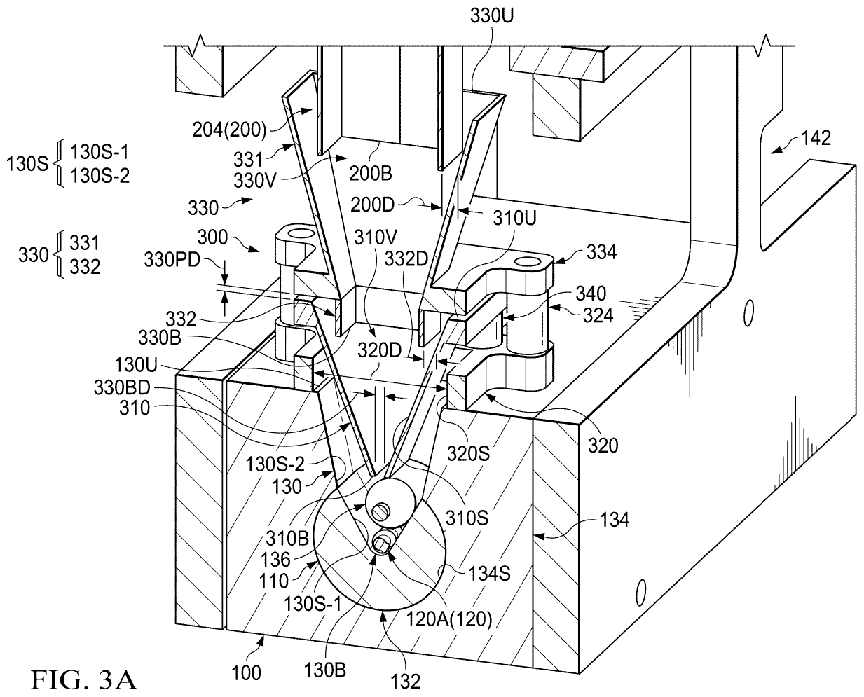

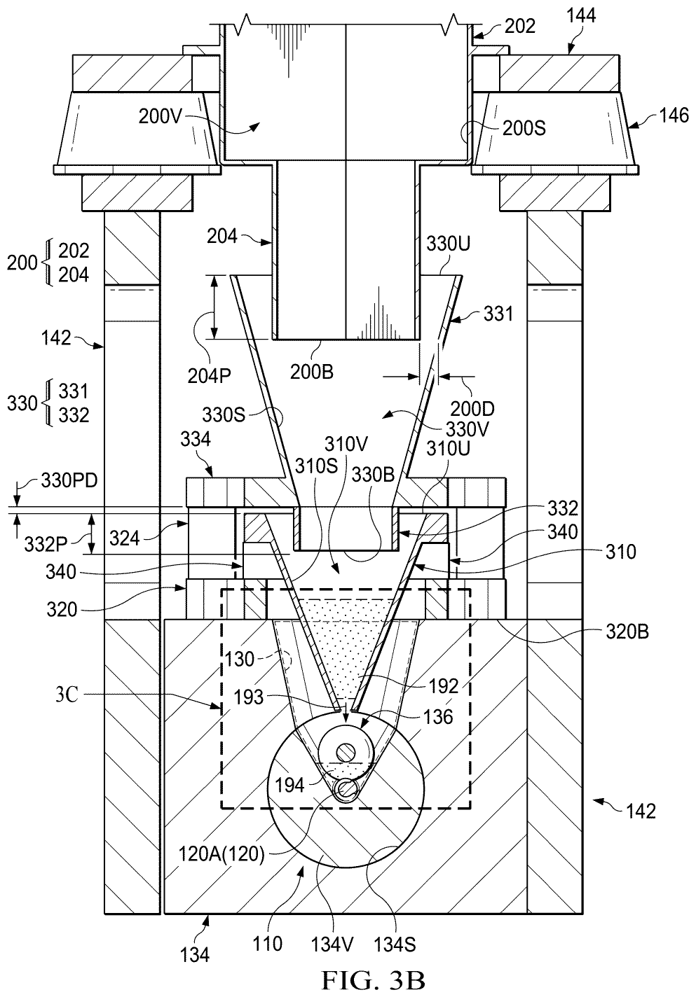

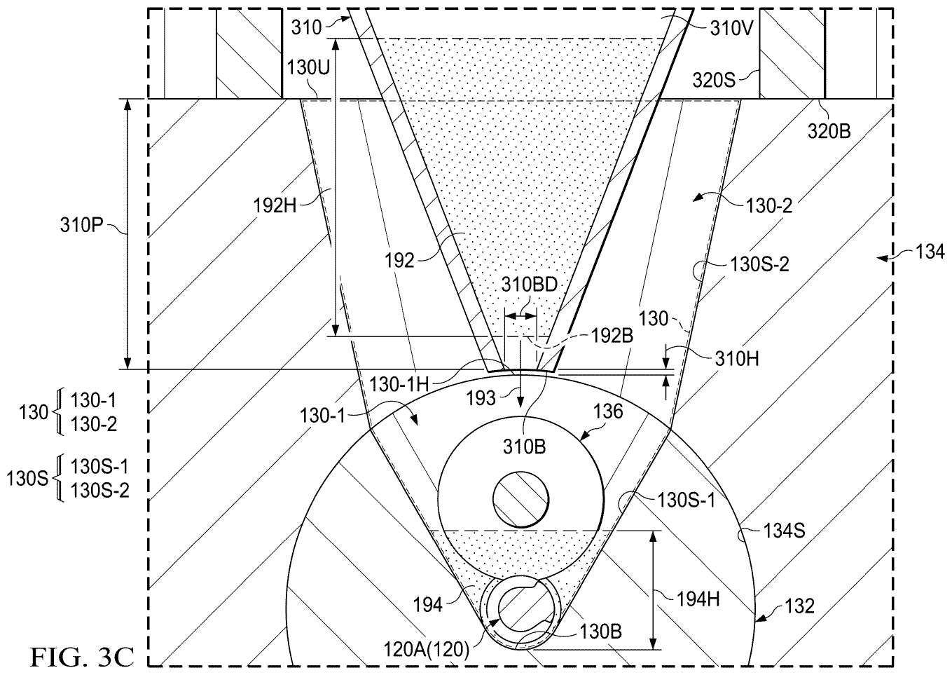

FIG. 1 is a perspective view of a doser apparatus according to some example embodiments. FIG. 2A is a perspective cross-sectional view of the doser apparatus of FIG. 1 along cross-sectional view line IIA-IIA′ of FIG. 1, according to some example embodiments. FIG. 2B is an elevation cross-sectional view of the doser apparatus of FIG. 1 along cross-sectional view line IIA-IIA′ of FIG. 1, according to some example embodiments. FIG. 2C is an expanded view of region 2C of FIG. 2B, according to some example embodiments. FIG. 2D is a perspective cross-sectional view of the doser apparatus of FIG. 1 along cross-sectional view line IID-IID′ of FIG. 2B, according to some example embodiments. FIG. 3A is a perspective cross-sectional view of the doser apparatus of FIG. 1 along cross-sectional view line IIIA-IIIA′ of FIG. 2B, according to some example embodiments. FIG. 3B is an elevation cross-sectional view of the doser apparatus of FIG. 1 along cross-sectional view line IIIA-IIIA′ of FIG. 2B, according to some example embodiments. FIG. 3C is an expanded view of region 3C of FIG. 3B, according to some example embodiments.

Referring generally to FIGS. 1 to 3C, in some example embodiments a doser apparatus 10 includes a doser mechanism 100. The doser mechanism 100 may include a conveyor device 120 and a doser reservoir 130. The doser mechanism 100 may be controllable (e.g., to operate for a particular period of time, at a particular operating speed, etc.) to cause the conveyor device 120 to draw granular material from the doser reservoir 130 and to discharge the granular material from the doser mechanism 100 via an outlet opening, such that the doser mechanism causes a particular amount (e.g., “dose”) of granular material to be discharged (e.g., indexed as part of an indexing operation). As a result, the doser mechanism 100 may be configured to “index” a controllable amount of granular material at a controllable time interval.

The doser mechanism 100 may include one or more inner surfaces 130S that collectively partially or entirely define the doser reservoir 130. The enclosure of the doser reservoir 130 which is at least partially defined by the one or more inner surfaces 130S may be referred to as a doser reservoir enclosure, a doser reservoir interior, or the like. The doser reservoir 130 that is at least partially defined by the one or more inner surfaces 130S may have a doser reservoir inlet opening 130U, also referred to herein interchangeably as a doser reservoir top opening, that is exposed (e.g., open) to an exterior of the doser mechanism 100. The doser reservoir 130 may taper downwards from the doser reservoir inlet opening 130U to a bottom 130B (e.g., lowermost portion) of the doser reservoir 130. The doser reservoir 130 may include a doser reservoir outlet opening 130O, also referred to herein as a doser reservoir bottom opening at or proximate to the bottom 130B of the doser reservoir 130.

As shown, the doser mechanism 100 (e.g., one or more surfaces thereof) may define a conduit 112 extending from the doser reservoir outlet opening 130O at the bottom 130B of the doser reservoir 130, such that the conduit 112 is in flow communication with the doser reservoir 130. The doser mechanism 100 may include a tubular structure 114 defining an internal tubular conduit 116 having a first opening 116I coupled to an outlet opening 1120 of the conduit 112 to establish a tubular conduit 118 extending from the doser reservoir outlet opening 130O, also referred to as a conveyor inlet opening 180-1, to an opposite conveyor outlet opening 180-2, also referred to herein as a doser outlet opening, of the tubular conduit 118. The doser mechanism 100 may include an additional opening 124O at the bottom of the doser reservoir 130, but example embodiments are not limited thereto. In some example embodiments, the tubular conduit 118 may be defined by any quantity of conduits extending between the doser reservoir outlet opening 130O and an opening that is exposed to the exterior of the doser mechanism 100.

The conveyor device 120 may be configured to convey a granular material from the doser reservoir 130 to be discharged from the doser mechanism 100. The conveyor device 120 may be controllable (e.g., to operate for a particular period of time, at a particular operating speed, etc.) to cause a particular amount (e.g., “dose”) of granular material to be conveyed from the doser reservoir 130 (e.g., indexed as part of an indexing operation). As shown, the conveyor device 120 may include an auger conveyor that is configured to convey a granular material along the longitudinal axis of the auger conveyor based on the auger conveyor rotating 128 around the longitudinal axis of the auger conveyor. As shown, at least a portion of the conveyor device 120 may extend through the tubular conduit 118 from the conveyor inlet opening 180-1 (doser reservoir outlet opening 130O) to the conveyor outlet opening 180-2. As further shown, at least a portion 120A of the conveyor device 120 may extend through the conveyor inlet opening 180-1, which is the doser reservoir outlet opening 130O, and into the doser reservoir 130 (e.g., at the bottom 130B of the doser reservoir 130), such that the portion 120A of the conveyor device 120 may be located in the doser reservoir 130 at the bottom 130B thereof and thus may be exposed to the doser reservoir 130 (e.g., directly exposed to granular material 194 held in the doser reservoir 130). In some example embodiments, the portion 120A of the conveyor device 120 may not extend through the doser reservoir outlet opening 130O into the doser reservoir 130 (e.g., may be limited to being entirely within the tubular conduit 118) and may be exposed to the doser reservoir 130 through the doser reservoir outlet opening 130O.

The doser apparatus 10 may include a drive motor 124 that is mechanically coupled (e.g., via driveshaft 126) to the conveyor device 120 (e.g., based on the conveyor device 120 extending through the additional opening 124O of the doser reservoir 130). As shown, the doser mechanism 100 may include the driveshaft 126 that is coupled (e.g., mechanically coupled) to the conveyor device 120. The doser mechanism 100 may include a bearing assembly 125 which may include any known bearing to enable relative movement of the driveshaft 126 in relation to a fixed portion of the doser mechanism 100. As shown, the drive motor 124 may be external to the doser mechanism 100 and coupled thereto via the driveshaft 126, but example embodiments are not limited thereto. As shown, the driveshaft 126 may be included as a part of the doser mechanism 100, but example embodiments are not limited thereto, and in some example embodiments the conveyor device 120 may be configured to be mechanically coupled to a drive shaft that is external to the doser mechanism 100. The drive motor 124 may be any known drive motor, electric motor, servomechanism, servoactuator, or the like. The drive motor 124 may be directly coupled to the driveshaft 126 in a direct drive configuration, but example embodiments are not limited thereto. The conveyor device 120 may be configured to operate (e.g., rotate 128 around its longitudinal axis) based on operation of the drive motor 124. The drive motor 124 may be communicatively (e.g., electrically) coupled to a control device 500 that may be configured to control the operation of the drive motor 124 (e.g., adjustably control a supply of electrical power to the drive motor 124) to control operation of the conveyor device 120.

As shown in at least FIGS. 2B to 2D, the doser mechanism 100 may include a discharge device 160 coupled to the tubular conduit 118 at the outlet opening 180-2 which may be at the distal end of the tubular conduit 116 and which may be an opening through a sidewall of the tubular structure 114 so that the conveyor device 120 is configured to discharge granular material conveyed to the distal end of the tubular conduit 118 to exit the tubular conduit 118 based on moving perpendicular to the longitudinal axis of the tubular conduit 118. As shown, the outlet 180-2 may face at least partially or entirely in the upwards direction opposite the direction of gravity, so that the doser mechanism 100 is configured to cause the granular material moved through the tubular conduit 118 to the outlet opening 180-2 to move at least partially upwards and opposite to the direction of gravity to be discharged out of the tubular conduit 118.

The discharge device 160 may include one or more inner surfaces 160S defining a conduit 160V extending from the outlet 180-2 of the tubular conduit 118 (which may be at least partially upwards facing against the direction of gravity) to an opposite discharge outlet 180-3 that may face downwards in the direction of gravity. The discharge device 160 may thus be configured to redirect granular material 198 discharged upwards through the outlet opening 180-2 to be discharged from the doser mechanism 100 in a downwards direction to be more easily discharged into a container, sealable enclosure, etc. The upwards-facing outlet 180-2 may configure the doser mechanism 100 to retain granular material in the tubular conduit 118 under the force of gravity when the conveyor device 120 is stopped, thereby improving accuracy and precision of the amount of each “dose” of granular material 198 that is “indexed” from the doser mechanism 100 based on operating the conveyor device 120 for a particular period of time. The doser mechanism 100 may be configured to, based on operation of the conveyor device 120, draw granular material 196 from an amount of granular material 194 held in the doser reservoir 130 through the doser reservoir outlet opening 130O and to discharge a portion of the drawn granular material 196 from a doser outlet 180-3 to discharge (“index”) an index amount 198 of the granular material. The doser mechanism 100 may further include a structure 136 located in the doser reservoir 130 above the conveyor device 120, where the structure 136 is configured to distribute granular material 194 held in the doser reservoir 130 to be more easily engaged and conveyed by the conveyor device 120 out of the doser reservoir 130 via the doser reservoir outlet opening 130O.

Still referring to FIGS. 1 to 3C, the conveyor device 120, the driveshaft 126, the bearing assembly 125, the tubular structure 114, the discharge device 160, a cartridge structure 132 defining the conduit 112 and a lower portion 130-1 of the doser reservoir 130, or any combination thereof may comprise a doser cartridge 110 that is configured be removably coupled (e.g., detachably coupled) with a remainder fixed structure 134 (e.g., a remainder of the doser mechanism 100) to collectively comprise the doser mechanism 100. The remainder fixed structure 134 may include one or more inner surfaces 134S defining a conduit 134V configured to receive the doser cartridge 110. The remainder fixed structure 134 may include one or more inner surfaces 130S-2 defining an upper portion 130-2 of the doser reservoir 130 including the doser reservoir inlet opening 130U and extending to the conduit defined by the inner surfaces 134S. The doser cartridge 110 may include one or more cartridge structures 132 having one or more inner surfaces 130S-1 defining a lower portion 130-1 of the doser reservoir 130, for example including the doser reservoir outlet opening 130O, through which a portion 120A of the conveyor device 120 may be exposed to the doser reservoir 130, and defining the bottom 130B of the doser reservoir 130. The doser mechanism 100 may be configured to align the inner surface 130S-2 of the remainder fixed structure 134 with the inner surface 130S-1 of the doser cartridge 110 based on the doser cartridge 110 being inserted into the conduit 134V, to combine the upper and lower reservoir spaces 130-2 and 130-1 to establish the doser reservoir 130. The doser cartridge 110 may be removed from the doser mechanism 100 and replaced with another doser cartridge 110, thereby enabling easy and rapid replacement of the movable elements included in the doser cartridge 110 (e.g., the conveyor device 120, the driveshaft 126, the bearing assembly 125, etc.) to facilitate easy and rapid repair and/or maintenance of the doser mechanism 100.

Still referring to FIGS. 1, 2A to 2C, and 3A to 3C, the doser apparatus 10 may include a throttle device 300 on the doser mechanism 100. The throttle device 300 may be directly connected (e.g., fixed, fastened via one or more fasteners, etc.) to the doser mechanism 100 or may be positioned in a particular, fixed position in relation to the doser mechanism 100 without being directly connected to the doser mechanism 100. In some example embodiments, the throttle device 300 may be configured to adjustably control (e.g., throttle, meter, restrict, etc.) a head pressure of the granular material 194 at the portion 120A of the conveyor device 120 exposed to the doser reservoir 130, said head pressure corresponding to the depth 194H of the granular material on the exposed portion 120A of the conveyor device 120, based on controlling a flow 193 (e.g., flow rate) of the granular material into the doser reservoir 130 through the doser reservoir inlet opening 130U. For example, based on controlling the magnitude of the flow 193 to be less than or equal to the rate at which granular material 196 is drawn from the doser reservoir 130 via the conveyor device 120, the throttle device 300 may be configured to prevent the depth 194H of granular material 194 at the portion 120A of the conveyor device 120 exposed to (e.g., within) the doser reservoir 130, and thus the corresponding head pressure of said granular material 194 at the exposed portion 120A of the conveyor device 120, from exceeding a certain threshold magnitude corresponding to bridging of the granular material 194. As a result, flow restrictions in the doser reservoir 130 due to excessive head pressure of the granular material 194 at the exposed portion 120A of the conveyor device 120, for example bridging of the granular material 194, ratholing of the granular material 194, etc. may be reduced, minimized, or prevented based on the throttle device 300 adjustably controlling (e.g., throttling, metering, restricting, etc.) the flow 193 (e.g., the flow rate thereof) into the doser reservoir 130 (e.g., to replace granular material 196 drawn out of the doser reservoir 130 by the conveyor device 120).

As shown, the depth 194H of the granular material 194 at the portion 120A may be understood to be a depth of the granular material 194 from a top surface of the granular material 194 in the doser reservoir 130 to the bottom 130B of the doser reservoir 130. Accordingly, the depth 194H may be a depth of the granular material 194 in the doser reservoir 130, a depth of the granular material 194 from the bottom 130B of the doser reservoir 130, or the like. However, example embodiments are not limited thereto. For example, in some example embodiments the depth 194H may refer to a depth of the granular material 194 from a top surface of the granular material 194 in the doser reservoir 130 to an uppermost surface of the portion 120A of the conveyor device 120 in the doser reservoir 130.

In some example embodiments, the throttle device 300 may be configured to adjustably control (e.g., throttle, meter, restrict, etc.) the depth 194H of the granular material 194 based on controlling the flow 193 (e.g., flow rate) of the granular material into the doser reservoir 130 through the doser reservoir inlet opening 130U. For example, based on controlling the magnitude of the flow 193 to be less than or equal to the rate at which granular material 196 is drawn from the doser reservoir 130 via the conveyor device 120, the throttle device 300 may be configured to prevent the depth 194H of granular material 194 from exceeding a certain threshold magnitude. Such a threshold magnitude may be the vertical distance (e.g., height) of a top end 130-1H (e.g., uppermost portion) of the inner surface 130-1S of the cartridge structure 132 defining the lower portion 130-1 of the doser reservoir 130 from the bottom 130B of the doser reservoir 130. Such a threshold magnitude may be the vertical distance (e.g., height) of the doser reservoir inlet opening 130U (e.g., doser reservoir top opening) from the bottom 130B of the doser reservoir 130. As a result, the possibility of overfilling of the doser reservoir 130 and/or at least the lower portion 130-1 thereof, and thus the possibility of overflow of granular material from the doser reservoir 130 and/or at least the lower portion 130-1 thereof, may be reduced, minimized, or prevented based on the throttle device 300 adjustably controlling (e.g., throttling, metering, restricting, etc.) the flow 193 (e.g., the flow rate thereof) into the doser reservoir 130 (e.g., to replace granular material 196 drawn out of the doser reservoir 130 by the conveyor device 120).

Still referring to FIGS. 1, 2A to 2C, and 3A to 3C, the throttle device 300 may include a vibratory hopper 310. The vibratory hopper 310 may include one or more structures, inner surfaces 310S, or the like defining a vibratory hopper conduit 310V tapering from a vibratory hopper top opening 310U towards a vibratory hopper bottom opening 310B. As shown, the vibratory hopper 310 may be configured to hold an amount (e.g., a first amount) of granular material 192 within the vibratory hopper conduit 310V. The throttle device 300 may position the vibratory hopper 310 to at least partially vertically overlap the doser reservoir 130 of the doser mechanism 100, for example, such that the vibratory hopper bottom opening 310B vertically overlaps the doser reservoir inlet opening 130U. As a result, the vibratory hopper 310 may be configured to enable material held in the vibratory hopper conduit 310V to flow downwards, under the influence of gravity, from the vibratory hopper conduit 310V via the vibratory hopper bottom opening 310B and into the doser reservoir 130. For example, as shown, the vibratory hopper 310 may hold a granular material 192 in the vibratory hopper conduit 310V and may be configured to enable a flow 193 of granular material from the vibratory hopper conduit 310V to the doser reservoir 130 via the vibratory hopper bottom opening 310B to be held in the doser reservoir 130 as granular material 194.

As shown, the one or more inner surfaces 310S of the vibratory hopper 310 may define the vibratory hopper conduit 310V as tapering at a continuous, fixed rate as a function of vertical level from the vibratory hopper top opening 310U to the vibratory hopper bottom opening 310B, but example embodiments are not limited thereto. For example, the one or more inner surfaces 310S may define the vibratory hopper conduit 310V to have any shape where the vibratory hopper top opening 310U is larger in area than the vibratory hopper bottom opening 310B, including a vibratory hopper conduit 310V that tapers at a non-linear rate (e.g., a continuously changing rate of tapering, a discontinuously changing rate of tapering or any combination thereof) as a function of vertical level from the vibratory hopper top opening 310U to the vibratory hopper bottom opening 310B.

In some example embodiments, the vibratory hopper bottom opening 310B has a particular smallest diameter 310BD that is smaller than a minimum opening size configured to avoid bridging of the granular material 192 in the vibratory hopper conduit 310V. As a result, the particular smallest diameter 310BD of the vibratory hopper bottom opening 310B may be sufficiently small that the vibratory hopper 310 is configured to induce bridging of the granular material 192 at, above, or immediately (e.g., adjacently) above the vibratory hopper bottom opening 310B (e.g., at a bottom 192B of the granular material 192 held in the vibratory hopper conduit 310V). The vibratory hopper 310 may be configured to induce bridging of the granular material 192 at least at the vibratory hopper bottom opening 310B based on the certain depth 192H of the granular material 192 held in the vibratory hopper conduit 310V (above the bottom 192B of the granular material 192) being at or above a threshold value corresponding to the head pressure of the granular material 192 in the vibratory hopper conduit 310V being at or above a threshold magnitude associated with bridging of the granular material 192 at least at the bottom 192B thereof where the vibratory hopper bottom opening 310B has a particular smallest diameter 310BD that is smaller than a minimum opening size configured to avoid bridging of the granular material 192 in the vibratory hopper conduit 310V.

As shown in FIGS. 1, 2A to 2C, and 3A to 3C, the vibratory hopper 310 may include a support structure portion 312 extending away from the vibratory hopper conduit 310V. The support structure portion 312 may be configured to couple with one or more separate structures in order to position the vibratory hopper 310, and particularly the vibratory hopper conduit 310V, in a fixed position in relation to the one or more separate structures.

In some example embodiments, the throttle device 300 includes a vibration device 316 mechanically coupled to the vibratory hopper 310. As shown in at least FIG. 2B, the vibration device 316 may be at least partially integrated into the structure of the vibratory hopper 310 (e.g., at least partially integrated into the support structure portion 312), such that the vibration device 316 may be considered to be integrated into (and thus a part of) the vibratory hopper 310. But example embodiments are not limited thereto, and in some example embodiments the vibration device 316 may be partially or entirely separate from the vibratory hopper 310 and may be mechanically coupled to the vibratory hopper 310 via one or more structures, members (e.g., one or more arms) or the like.

The vibration device 316 may be a device that is configured to induce vibration of the vibratory hopper 310. For example, the vibration device 316 may be mechanically coupled 402 to a driving device 400, where the driving device 400 may drive the vibration device 316 to induce the vibration of the vibratory hopper 310. In some example embodiments, the vibration device 316 is a pneumatic ball vibration device, the driving device 400 includes a pressurized air supply (e.g., pressurized air container) and an adjustable control valve configured to adjustably control a flow of the pressurized air from the pressurized air supply, and the coupling 402 includes a conduit (e.g., flexible tube) coupling the vibration device 316 to the adjustably control valve of the driving device 400. The control device 500 may be communicatively coupled to the driving device 400 and/or to the vibration device 316 to adjustably control (e.g., throttle, meter, etc.) the vibrations generated by the vibration device 316 and thus the vibrations induced in the vibratory hopper 310. It will be understood that example embodiments of the vibration device 316 and the driving device 400 are not limited to a pneumatic ball vibration device and pressurized air supply, respectively, and the vibration device 316 may include any known vibration device configured to induce vibration of the vibratory hopper 310, and the driving device 400 may include any known driver of any known vibration device. In some example embodiments, the driving device 400 may be omitted as a separate device from the vibration device, for example the vibration device 316 may include the driving device as a part of the vibration device 316, such that the vibration device 316 (e.g., any known electromechanical vibration device configured to generate machine vibrations) is communicatively coupled to the control device 500. The control device 500 may be thereby configured to adjustably control operation of the vibration device 316 (e.g., based on transmitting electrical signals to the vibration device 316).

In some example embodiments, the vibration device 316 may be configured to break (e.g., overcome) the bridging of the granular material 192 at the vibratory hopper bottom opening 310B, for example breaking the bridging at the bottom 192B of the mass of the granular material 192 held in the vibratory hopper conduit 310V, based on inducing vibration of the vibratory hopper 310. Such vibration of the vibratory hopper 310 and the resultant breaking of the bridging of the granular material 192 may induce a flow 193 of the granular material 192 from the vibratory hopper conduit 310V through the vibratory hopper bottom opening 310B. As shown in at least FIGS. 3B-3C, such flow 193 may be from the vibratory hopper conduit 310V to the doser reservoir 130 via the vibratory hopper bottom opening 310B. The doser apparatus 10 (e.g., the throttle device 300) may be configured to controllably adjust (e.g., throttle, meter, restrict, etc.) the flow 193 of the granular material (e.g., mass flow rate thereof, volumetric flow rate thereof, etc.) through the vibratory hopper bottom opening 310B based on adjusting the amplitude and/or frequency of the vibration of the vibratory hopper 310 that is induced by the vibration device 316 (e.g., based on adjustably controlling, throttling, metering, etc. the vibration device 316 and/or the driving device 400). The doser apparatus 10 may be configured to controllably adjust the flow 193 to have a constant flow rate based on adjustably controlling the vibrations generated by the vibration device 316, to thereby cause the throttle device 300 to provide a flow 193 of granular material into the doser reservoir 130 which is a constant flow rate which may be equal to or less than the time-average flow rate of granular material 196 drawn out of the doser reservoir 130 by the conveyor device 120 during one or more indexing operations to discharge one or more index amounts of granular material 198 from the doser mechanism 100.

Still referring to FIGS. 1, 2A to 2C, and 3A to 3C, the flow 193 of the granular material 192 from the vibratory hopper 310 to the doser reservoir 130 of the doser mechanism 100 may be adjustably controlled (e.g., throttled, metered, restricted, etc.) in order to adjustably control the depth 194H, and thus the head pressure, of the granular material 194 in the doser reservoir 130 at the portion 120A of the conveyor device 120 extending into and/or exposed to the doser reservoir 130, based on operating the vibration device 316 and/or the driving device 400 to adjustably control the vibrations of the vibratory hopper 310 and thus adjustably control the breaking of bridging of the granular material 192 held in the vibratory hopper conduit 310V. Such adjustable control may include balancing the tendency of the granular material 192 to bridge at the bottom 192B thereof, within a lower portion of the vibratory hopper conduit 310V proximate to the vibratory hopper bottom opening 310B due to the particular smallest diameter 310BD of the vibratory hopper bottom opening 310B and at least a certain head pressure of the granular material 192 at the bottom 192B due to at least a certain depth 192H of the granular material 192 held in the vibratory hopper conduit 310V and thus reduce or inhibit the flow 193 through the vibratory hopper bottom opening 310B, against the vibrations of the vibratory hopper 310 induced by the vibration device 316 having a tendency to break such bridging and induce and/or increase the flow 193 through the vibratory hopper bottom opening 310B. Such adjustable control may enable the throttle device 300 to isolate the head pressure of the granular material 192 in the vibratory hopper 310 from the doser reservoir 130 and thus from the conveyor device 120. Such adjustable control may reduce, minimize, or prevent excess head pressure of granular material 194 at the exposed portion 120A of the conveyor device 120 that may lead to bridging, ratholing, etc. of the granular material 194 at the exposed portion 120A of the conveyor device 120. Accordingly, such adjustable control may reduce, minimize, or prevent operational defects of the conveyor device 120 due to bridging of the granular material 194 at the conveyor device 120 due to excessive head pressure of the depth 194H of granular material 194 at the conveyor device 120. Additionally or alternatively, such adjustable control may reduce, minimize, or prevent operational defects of the conveyor device 120 due to overfilling of the doser reservoir 130 and/or at least the lower portion 130-1 thereof which may be to overflow of the granular material out of the doser reservoir 130 via the doser reservoir inlet opening 130U.

In some example embodiments, the throttle device 300 is configured to adjustably control a balance between the bridging tendency of the granular material 194 in the vibratory hopper conduit 310V to reduce or inhibit flow 193 and the configuration of the throttle device 300 to induce or increase flow 193 based on vibration of the vibratory hopper 310 in order to control (e.g., throttle, meter, restrict, etc.) the flow 193 and thus to control (e.g., throttle, meter, restrict, etc.) the head pressure of the granular material 194 in the doser reservoir 130. The vibration device 316 may be controlled to inhibit vibration of the vibratory hopper 310 such that the granular material 192 in the vibratory hopper conduit 310V may bridge at the bottom 192B to inhibit the flow 193 out of the vibratory hopper conduit 310V via the vibratory hopper bottom opening 310B and thus to hold the granular material 192 within the vibratory hopper conduit 310V without or substantially without loss (e.g., leakage, drainage, etc.) of granular material 192 through the vibratory hopper bottom opening 310B when the vibration is inhibited. As a result of the flow 193 being inhibited, maintenance of the doser mechanism 100 may be more easily performed (e.g., the doser cartridge 110 may be removed from conduit 134V for maintenance) with reduced, minimized, or prevented need to clean out the entire doser mechanism 100 of granular material, and the flow 193 of granular material into the doser mechanism 100 can be easily restarted based on resuming vibration of the vibratory hopper 310 due to operation of the vibration device 316. Additionally, the head pressure (e.g., due to depth 194H) of the granular material 194 at the exposed portion 120A of the conveyor device 120 may be adjustably controlled based on adjustably controlling (e.g., throttling, metering, etc.) the vibration of the vibratory hopper 310 by the vibration device 316, which may prevent the head pressure of the granular material 194 (e.g., due to depth 194H) from exceeding a threshold magnitude that may induce bridging of the granular material 194 at the exposed portion 120A of the conveyor device 120 and thus may reduce, minimize, or prevent such bridging at the conveyor device 120. The doser apparatus 10 may therefore be configured to discharge index amounts of granular material 198 that have improved uniformity and consistency due to reduced, minimized, or prevented variation in the flow of granular material 196 drawn from the doser reservoir 130 by the conveyor device 120 due to reduced, minimized, or prevented bridging, ratholing, etc. of the granular material 194 at the portion 120A of the conveyor device 120 that is exposed to the doser reservoir 130.

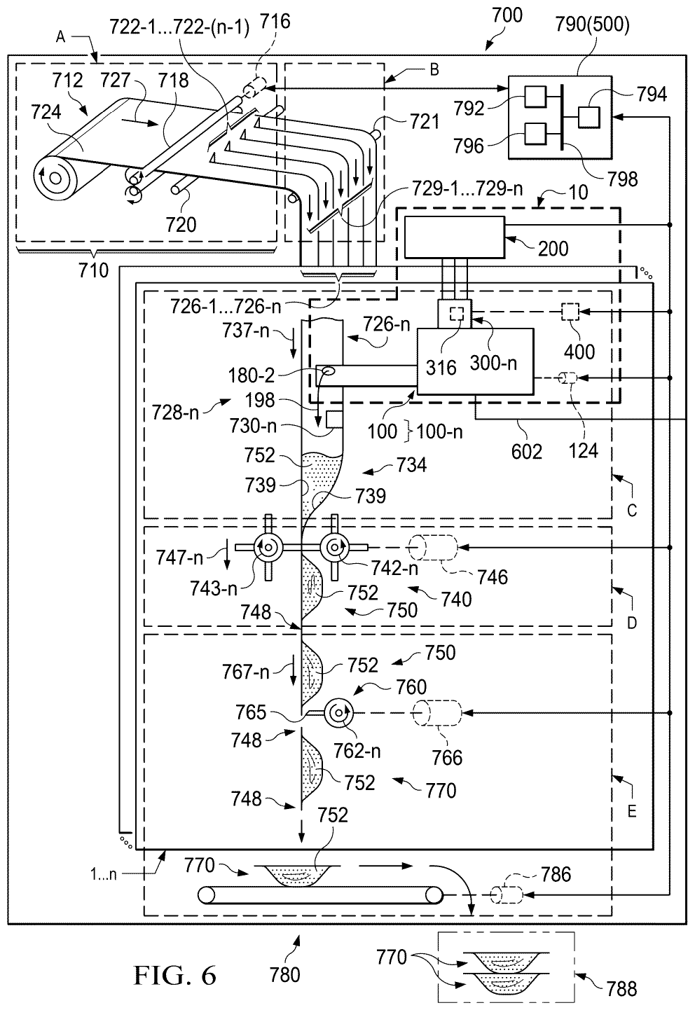

As shown in at least FIG. 2B, the doser apparatus 10 may include a control device 500 which may be communicatively coupled to at least one of the drive motor 124 of the doser mechanism 100, the driving device 400, and/or to the vibration device 316. The control device 500 may be configured to adjustably control the driving device 400 and/or vibration device 316 in order to adjustably control the vibration of the vibratory hopper 310 by the vibration device 316, including controlling (e.g., throttling, metering, etc.) the amplitude and/or frequency of the vibration of the vibratory hopper 310 that is induced by the vibration device 316. The control device 500 may be configured to adjustably control the drive motor 124 in order to adjustably control the operation of the conveyor device 120. The control device 500 may be implemented by the control device 790 of the packaging machine 700 as shown in FIG. 6 and may include, for example, an electronic device including a memory (e.g., solid state drive memory) storing a program of instructions and a processor (e.g., central processing unit) configured to execute the program of instructions to implement the functionality of the control device 500.

In some example embodiments, the throttle device 300 is configured to enable the vibratory hopper 310 to move (e.g., engage in damped movement, engage in free movement, etc.) in relation to the doser mechanism 100. The throttle device 300 may at least partially vibrationally isolate (e.g., damp) the vibratory hopper 310 from the doser mechanism 100, so that the induced vibration of the vibratory hopper 310, induced by the vibration device 316, may be partially or entirely inhibited (e.g., damped) from being transferred to the doser mechanism 100, thereby reducing, minimizing, or preventing damage to the doser mechanism 100 due to such vibration of the vibratory hopper 310.

As shown, the throttle device 300 may include an interface structure 320 (e.g., a plate) which may be coupled (e.g., fixed, via one or more fasteners) to the doser mechanism 100. The interface structure 320 may be fixed (e.g., affixed) in position in relation to the doser mechanism 100 (e.g., by one or more fasteners) to thereby fix the throttle device 300 in position in relation to the doser mechanism 100. The throttle device 300 may include one or more standoff members 340 which are coupled to the vibratory hopper 310 and which are configured to enable the vibratory hopper 310 to move in relation to another structure (e.g., the doser mechanism 100, the interface structure 320, etc.). As shown, for example, the standoff members 340 may be connected between the vibratory hopper 310 and the interface structure 320, where the interface structure 320 may be affixed to the doser mechanism 100, so that the vibratory hopper 310 is positioned in relation to the doser mechanism 100 by the interface structure 320 and standoff members 340 while the standoff members 340 configure the vibratory hopper 310 to move in relation to the interface structure 320 and thus in relation to the doser mechanism 100. In some example embodiments, the one or more standoff members 340 may be coupled between the vibratory hopper 310 and the doser mechanism 100, partially or entirely independent of any interface structure 320, where the standoff members 340 configure the vibratory hopper 310 to move in relation to the doser mechanism 100 The vibratory hopper 310 may be partially or entirely structurally supported on the doser mechanism 100 and/or the interface structure 320 by the one or more standoff members 340, such that the one or more standoff members 340 may support some or all of the weight (e.g., load) of the vibratory hopper 310 on the doser mechanism 100 and/or the interface structure 320. The standoff members 340 may be configured to enable relative movement of the vibratory hopper 310 in relation to the doser mechanism 100, the interface structure 320, or the like while damping and/or inhibiting vibrations of the vibratory hopper 310 from being transmitted from the vibratory hopper 310 through the standoff members 340. The one or more standoff members 340 may thereby partially or entirely isolate the vibratory hopper 310 from the doser mechanism 100 (and, in some example embodiments, the interface structure 320). In some example embodiments, the standoff members 340 may include any known spring device, any known flexible structure configured to damp vibrations therethrough, any known flexible structure that enables relative movement between structures coupled to opposite ends of the flexible structure while damping vibration transmission between the structures via the flexible structure, any combination thereof, or the like.

At least a portion 310P of the vibratory hopper 310 extends (protrudes) into the doser reservoir 130 via the doser reservoir inlet opening 130U such that the vibratory hopper bottom opening 310B is between the doser reservoir inlet opening 130U and the doser reservoir outlet opening 130O that exposes at least the portion 120A of the conveyor device 120 to the doser reservoir 130. As shown, the vibratory hopper conduit 310V, tapering downward from the vibratory hopper top opening 310U toward the vibratory hopper bottom opening 310B, may be positioned by the throttle device 300 to extend (protrude) through the doser reservoir inlet opening 130U of the doser reservoir 130 and into the doser reservoir 130, for example such that at least a portion 310P of the vibratory hopper 310 is located within the doser reservoir 130 and the vibratory hopper bottom opening 310B is vertically between the doser reservoir inlet opening 130U and the doser reservoir outlet opening 130O that exposes at least the portion 120A of the conveyor device 120 to the doser reservoir 130 interior. As shown in at least FIGS. 1, 2A, 2B, 2C, 3A, 3B, and 3C, the vibratory hopper 310 may be configured to be isolated from direct contact with the doser mechanism 100, including any inner surface thereof at least partially defining the doser reservoir 130. For example, as shown, the outer surface(s) of the portion 310P of the vibratory hopper 310 extending (protruding) into the doser reservoir 130 may be isolated from direct contact with any inner surface 130S of the doser mechanism 100 that at least partially defines the doser reservoir 130 by at least a spacing distance 310PD. An escape pathway for granular material directed from the vibratory hopper 310 into doser reservoir 130 through the vibratory hopper bottom opening 310B, to escape the doser reservoir 130 via the doser reservoir inlet opening 130U, may be an upwards-directed pathway, thereby mitigating the potential for granular material escape through the doser reservoir inlet opening 130U while maintaining isolation of the vibratory hopper 310 from direct contact with the doser reservoir and thus reducing, minimizing, or preventing transmission of vibrations from the vibratory hopper 310 to the doser reservoir 130. As a result, the throttle device 300 may be configured to mitigate flow of the granular material out of the doser reservoir 130 through an annular portion of the doser reservoir inlet opening 130U defined between an outer surface of the bottom portion (e.g., protruding portion 310P) of the vibratory hopper 310 and an inner surface 130S of the doser mechanism 100 defining an upper portion 130-2 of the doser reservoir 130.

In some example embodiments, the vibratory hopper 310 protrudes into a limited portion of the doser reservoir 130. For example, the portion 310P of the vibratory hopper extending (protruding) into the doser reservoir 130 may be entirely within the upper portion 130-2 of the doser reservoir 130 and may be spaced apart (e.g., vertically spaced apart) from the lower portion 130-1 of the doser reservoir that is defined by the doser cartridge 110, for example such that the vibratory hopper 310 (e.g., the protruding portion 310P) does not horizontally overlap with any portion of the doser cartridge 110 and/or any inner surface 130S-1 thereof defining the lower portion 130-1 of the doser reservoir 130. For example, as shown, the vibratory hopper bottom opening 310B of the vibratory hopper 310 may be positioned to be vertically spaced apart by a spacing distance 310H from a top end 130-1H (e.g., uppermost portion) of the inner surface 130-1S of the cartridge structure 132 defining the lower portion 130-1 of the doser reservoir 130. As a result, the projection of at least the protruding portion 310P of the vibratory hopper 310 into the doser reservoir 130 may be limited to the upper portion 130-2 of the doser reservoir 130, and therefore the doser cartridge 110, including the portions of cartridge structure 132 defining the lower reservoir 130-1, may be easily removed and replaced without requiring adjustment or removal of the throttle device 300, thereby improving ease of maintenance of the doser apparatus 10.

The vibratory hopper 310 may be configured to be isolated from direct contact with the interface structure 320. For example, the vibratory hopper 310 may be indirectly coupled with the doser mechanism 100 via the support structure portion 312 that is coupled to the interface structure 320 that is fastened to the doser mechanism 100 via one or more standoff members 340, where the one or more standoff members 340 may be configured to enable movement of the vibratory hopper 310 in relation to the interface structure 320 and thus in relation to the doser mechanism 100 and may damp or isolate such movement (e.g., vibration) from at least the interface structure 320 (and thus the doser mechanism 100 to which the interface structure 320 may be fastened). Accordingly, the vibratory hopper 310 may be at least partially isolated from the interface structure 320 and the doser mechanism 100. As shown in at least FIGS. 2A to 2C and 3A to 3C, the interface structure 320 may extend around the doser reservoir inlet opening 130U of the doser reservoir 130 and may include one or more inner surfaces 320S defining an opening 320D through the interface structure 320. The vibratory hopper 310 may extend through the opening 320D to further protrude into the doser reservoir 130 via the doser reservoir inlet opening 130U.

Still referring to FIGS. 1, 2A to 2C, and 3A to 3C, in some example embodiments the throttle device 300 may include an additional hopper, referred to herein as an intake hopper 330, on the vibratory hopper 310. The intake hopper 330 may include one or more inner surfaces 330S (e.g., inner surfaces) defining an intake hopper conduit 330V. The intake hopper conduit 330V may at least partially taper from an intake hopper top opening 330U toward an intake hopper bottom opening 330B. The intake hopper bottom opening 330B may vertically overlap the vibratory hopper top opening 310U. The intake hopper 330 may be configured to direct an intake flow of granular material from the intake hopper conduit 330V (received into the conduit from a supply source) through the intake hopper bottom opening 330B and into the vibratory hopper conduit 310V through the vibratory hopper top opening 310U.

In some example embodiments, the intake hopper 330 is fixed in position in relation to the doser mechanism 100, and the throttle device 300 is configured to enable movement of the vibratory hopper 310 in relation to the intake hopper 330. For example, as shown, the intake hopper 330 may include a support structure 334 (e.g., support plate) that is connected (e.g., via any known fastener) to a support structure 324 projecting from the interface structure 320, thereby fixing (e.g., fastening) the intake hopper 330 to the interface structure 320 which may be fixing to the doser mechanism 100, thereby in some example embodiments fixing the intake hopper 330 to the doser mechanism 100. Accordingly, where the vibratory hopper 310 is configured to move in relation to the doser mechanism 100 and/or to be isolated from direct contact with the doser mechanism 100 (e.g., inner surfaces 130S defining the doser reservoir 130), the vibratory hopper 310 may be configured to move in relation to the intake hopper 330 and may be isolated from direct contact with the intake hopper 330. As a further result, the intake hopper 330 may be at least partially isolated from induced vibrations of the vibratory hopper 310. As shown, the vibratory hopper top opening 310U may be vertically spaced apart from the bottom of the top portion 331 (and the support structure 334) by at least a vertical spacing distance 330PD. Such vertical spacing may further contribute to isolation of the vibratory hopper 310 from the intake hopper 330.

As shown, the intake hopper 330 may include a top portion 331 and a bottom portion 332 that includes a projecting portion 332P that at least partially projects into the vibratory hopper conduit 310V via the vibratory hopper top opening 310U. In some example embodiments, and as shown, the bottom portion 332 of the intake hopper 330 that extends into the vibratory hopper conduit 310V may be isolated from direct contact with the vibratory hopper 310 (e.g., isolated from direct contact with any inner surface 310S of the vibratory hopper 310 that defines the vibratory hopper conduit 310V) by a spacing distance 332D, thereby contributing to isolation of the intake hopper 330 (and any structures to which the intake hopper is fixed) from vibration of the vibratory hopper 310. In some example embodiments, the top and bottom portions 331 and 332 may define different shaped portions of the intake hopper conduit 330V. For example, in the example embodiments shown, the top portion 331 defines a tapered portion of the intake hopper conduit 330V and the bottom portion 332 defines a cylindrical (e.g., rectangular cylindrical) portion of the intake hopper conduit 330V. However, example embodiments are not limited thereto, and in some example embodiments the top and bottom portions 331 and 332 may define separate portions of an intake hopper conduit 330V having any shape, including for example a single, continuous shape (e.g., continuously tapering shape) intake hopper conduit 330V similar to the continuously tapering shape of the vibratory hopper conduit 310V as shown in the example embodiments illustrated in at least FIGS. 1, 2A to 2C, and 3A to 3C. While the bottom portion 332 of the intake hopper 330 is shown to have a different shape from the top portion 331 of the intake hopper 330, example embodiments are not limited thereto. For example, in some example embodiments the top and bottom portions 331 and 332 of the intake hopper 330 may be separate portions of a structure defining a single, continuously tapering conduit, where the bottom portion 332 may continue to protrude into the vibratory hopper conduit 310V (via extending through the vibratory hopper top opening 310U) as described herein.

In some example embodiments, the intake hopper 330 may include a bottom portion 332 that further includes a projecting portion 332P which projects (e.g., extends) through the vibratory hopper top opening 310U and into at least a portion (e.g., an upper portion) of the vibratory hopper conduit 310V, for example such that the intake hopper bottom opening 330B is vertically below the vibratory hopper top opening 310U, for example vertically between the vibratory hopper top opening 310U and the vibratory hopper bottom opening 310B. As a result, the vibratory hopper 310 may at least partially surround the bottom portion 332 (e.g., the projecting portion 332P thereof) of the intake hopper 330 (e.g., in a horizontal plane). Accordingly, an escape pathway for granular material directed from the intake hopper 330 into the vibratory hopper 310 through the intake hopper bottom opening 330B to escape the vibratory hopper 310 via the vibratory hopper top opening 310U may be an upwards-directed pathway. Such an upwards-directed pathway may be configured to mitigate (e.g., reduce, minimize, or prevent) the potential for granular material escape through the vibratory hopper top opening 310U while maintaining isolation of the intake hopper 330 and any structure affixed thereto (e.g., the interface structure 320 and the doser mechanism 100) from direct contact with the vibratory hopper 310 and thus reducing, minimizing, or preventing transmission of vibrations from the vibratory hopper 310 to the intake hopper 330 and any structure affixed thereto (e.g., the interface structure 320 and the doser mechanism 100). As a result, the throttle device 300 may be configured to mitigate flow of the granular material out of the vibratory hopper conduit 310V through an annular portion of the vibratory hopper top opening 310U defined between an outer surface of the bottom portion 332 of the intake hopper 330 and an inner surface 310S of the vibratory hopper defining an upper portion of the vibratory hopper conduit 310V.

Still referring to FIGS. 1, 2A to 2C, and 3A to 3C, the doser apparatus 10 may include a supply hopper 200. The supply hopper 200 may be on the throttle device 300. The supply hopper 200 may be configured to hold a supply amount of the granular material within a supply hopper conduit 200V, defined by one or more inner surfaces 200S of the supply hopper 200. The supply hopper conduit 200V may at least partially taper from a supply hopper top opening 200U towards a supply hopper bottom opening 200B. The supply hopper 200 may be referred to herein interchangeably as a feed hopper, a bulk hopper, any combination thereof, or the like. The supply hopper 200 may be configured to direct a supply flow (e.g., bulk flow, feed, flow, etc.) of granular material from the supply hopper conduit 200V to the throttle device 300 through the supply hopper bottom opening 200B.

In some example embodiments, the supply hopper 200 is fixed in position in relation to the doser mechanism 100, and thus in relation to the vibratory hopper 310. For example, as shown, the doser apparatus 10 may include one or more support structures 142, 144, 146 that may connect (e.g., affix, fasten, etc.) the supply hopper 200 to the doser mechanism 100. Accordingly, where the vibratory hopper 310 is configured to move in relation to the doser mechanism 100 and/or to be isolated from direct contact with the doser mechanism 100 (e.g., surfaces defining the doser reservoir 130), the vibratory hopper 310 may be configured to move in relation to the supply hopper 200 and may be isolated from direct contact with the supply hopper 200. As a further result, the supply hopper 200 may be at least partially isolated from induced vibrations of the vibratory hopper 310.

In some example embodiments, where the throttle device 300 includes the intake hopper 330, and as shown in at least FIGS. 1, 2A to 2C, and 3A to 3C, the supply hopper 200 may be on the intake hopper 330 such that the supply hopper bottom opening 200B vertically overlaps the intake hopper top opening 330U, and the supply hopper may be configured to direct a supply flow of the granular material from the supply hopper conduit 200V to the intake hopper conduit 330V through the supply hopper bottom opening 200B and the intake hopper top opening 330U.

As shown, the supply hopper 200 may include a top portion 202 and a bottom portion 204. In some example embodiments, the top and bottom portions 202 and 204 may define different shaped portions of the intake hopper conduits 330V. For example, in the example embodiments shown, the top portion 202 defines a tapered portion of the supply hopper conduit 200V and the bottom portion 204 defines a cylindrical (e.g., rectangular cylindrical) portion of the supply hopper conduit 200V. However, example embodiments are not limited thereto, and in some example embodiments the top and bottom portions 202 and 204 may define separate portions of a single, continuous shape (e.g., continuously tapering shape) supply hopper conduit 200V similar to the continuously tapering shape of the vibratory hopper conduit 310V as shown in the example embodiments. The bottom portion 204 may extend vertically (e.g., project) through the intake hopper top opening 330U and project 204P into at least a portion (e.g., an upper portion) of the intake hopper conduit 330V, such that the supply hopper bottom opening 200B may be located vertically below the intake hopper top opening 330U and thus may be vertically between the intake hopper top opening 330U and the intake hopper bottom opening 330B. As a result, the intake hopper 330 may at least partially surround the bottom portion 204 (e.g., the projecting 204P portion thereof) of the supply hopper 200 (e.g., in a horizontal plane). Accordingly, an escape pathway for granular material directed from the supply hopper 200 into the intake hopper 330 through the supply hopper bottom opening 200B to escape the intake hopper 330 via the intake hopper top opening 330U may be an upwards-directed pathway. Such an upwards-directed pathway may mitigate (e.g., reduce, minimize, or prevent) the potential for granular material escape through the intake hopper top opening 330U. As a result, the throttle device 300 may be configured to mitigate flow of the granular material out of the intake hopper conduit 330V through an annular portion of the intake hopper top opening 330U defined between an outer surface of the bottom portion 204 of the supply hopper 200 and an inner surface 330S of the intake hopper 330 defining an upper portion of the intake hopper conduit 330V.

In some example embodiments, and as shown, a bottom portion 204 of the supply hopper 200 that extends into the intake hopper conduit 330V may be isolated from direct contact with the intake hopper 330 by a spacing distance 200D, thereby contributing to isolation of the supply hopper 200 (and any structures to which the supply hopper 200 is fixed) from the throttle device 300 and any vibration of the vibratory hopper 310 therein.

While the bottom portion 204 of the supply hopper 200 is shown to have a different shape from the top portion 202 of the supply hopper 200, example embodiments are not limited thereto. For example, in some example embodiments the upper and bottom portions 202 and 204 of the supply hopper 200 may be separate portions of a structure defining a single, continuously tapering conduit, where the bottom portion 204 may continue to project 204P into the intake hopper conduit 330V (via extending through the intake hopper top opening 330U) or into the vibratory hopper conduit 310V (via extending through the vibratory hopper top opening 310U) as described herein.

As described herein, a “granular material” may be referred to interchangeably as a “material” and may include particulate matter comprising particles. The granular material may be a powder-like substance that may flow freely when shaken or tilted. In some example embodiments, the granular material may have a particle size (e.g., particle diameter) between about 0.1 μm to about 500 μm. In some example embodiments, the granular material may have a particle size (e.g., particle diameter) between about 0.1 μm to about 200 μm. In some example embodiments, the granular material may have a particle size between about 0.5 mm to about 1 mm, about 0.25 mm to about 0.5 mm, about 125 μm to about 250 μm, about 60 μm to about 125 μm, about 4 μm to about 60 μm, about 1 μm to about 4 μm, any combination thereof, or the like.

In some example embodiments, the granular material may have an average particle size of about 50 μm. In some example embodiments, the granular material may have an average particle size of about 200 μm. In some example embodiments, the granular material may have an average particle size of about 400 μm.

The granular material may partially or entirely comprise particles having a maximum diameter that is between about 0.1 μm to about 1 μm. The granular material may partially or entirely comprise particles having a maximum diameter that is equal to or greater than 1 μm.

The granular material may contain and/or partially or completely comprise at least one substance. In some example embodiments, the at least one substance is a consumer product.

In some example embodiments, the at least one substance and/or the consumer product is an inert powder material. In some example embodiments, the granular material may contain and/or partially or completely comprise a substance that is microcrystalline cellulose (MCC).

In some example embodiments, the at least one substance and/or the consumer product includes (e.g., partially or completely comprises) an oral product.

In some example embodiments, the oral product is an oral tobacco product, an oral non-tobacco product, an oral cannabis product, or any combination thereof. The oral product may be in a form of loose material (e.g., loose cellulosic material), shaped material (e.g., plugs or twists), pouched material, tablets, lozenges, chews, gums, films, any other oral product, or any combination thereof.

The oral product may include chewing tobacco, snus, moist snuff tobacco, dry snuff tobacco, other smokeless tobacco and non-tobacco products for oral consumption, or any combination thereof.

Where the oral product is an oral tobacco product including smokeless tobacco product, the smokeless tobacco product may include tobacco that is whole, shredded, cut, granulated, reconstituted, cured, aged, fermented, pasteurized, or otherwise processed. Tobacco may be present as whole or portions of leaves, flowers, roots, stems, extracts (e.g., nicotine), or any combination thereof.

In some example embodiments, the oral product includes a tobacco extract, such as a tobacco-derived nicotine extract, and/or synthetic nicotine. The oral product may include nicotine alone or in combination with a carrier (e.g., white snus), such as a cellulosic material. The carrier may be a non-tobacco material (e.g., microcrystalline cellulose) or a tobacco material (e.g., tobacco fibers having reduced or eliminated nicotine content, which may be referred to as “exhausted tobacco plant tissue or fibers”). In some example embodiments, the exhausted tobacco plant tissue or fibers can be treated to remove at least 25%, 40%, 50%, 60%, 70%, 75%, 80%, 85%, 90%, or 95% of the nicotine. For example, the tobacco plant tissue can be washed with water or another solvent to remove the nicotine.

In other example embodiments, the oral product may include cannabis, such as cannabis plant tissue and/or cannabis extracts. In some example embodiments, the cannabis material includes leaf and/or flower material from one or more species of cannabis plants and/or extracts from the one or more species of cannabis plants. The one or more species of cannabis plants may include Cannabis sativa, Cannabis indica, and/or Cannabis ruderalis. In some example embodiments, the cannabis may be in the form of fibers. In some example embodiments, the cannabis may include a cannabinoid, a terpene, and/or a flavonoid. In some example embodiments, the cannabis material may be a cannabis-derived cannabis material, such as a cannabis-derived cannabinoid, a cannabis-derived terpene, and/or a cannabis-derived flavonoid.

The oral product (e.g., the oral tobacco product, the oral non-tobacco product, or the oral cannabis product) may have various ranges of moisture. In some example embodiments, the oral product is a dry oral product having a moisture content ranging from 5% by weight to 10% by weight. In some example embodiments, the oral product has a medium moisture content, such as a moisture content ranging from 20% by weight to 35% by weight. In some example embodiments, the oral product is a wet oral product having a moisture content ranging from 40% by weight to 55% by weight.

In some example embodiments, oral product may further include one or more elements such as a mouth-stable polymer, a mouth-soluble polymer, a sweetener (e.g., a synthetic sweetener and/or a natural sweetener), an energizing agent, a soothing agent, a focusing agent, a plasticizer, mouth-soluble fibers, an alkaloid, a mineral, a vitamin, a dietary supplement, a nutraceutical, a coloring agent, an amino acid, a chemesthetic agent, an antioxidant, a food-grade emulsifier, a pH modifier, a botanical, a tooth-whitening agent, a therapeutic agent, a processing aid, a stearate, a wax, a stabilizer, a disintegrating agent, a lubricant, a preservative, a filler, a flavorant, flavor masking agents, a bitterness receptor site blocker, a receptor site enhancers, other additives, or any combination thereof.

In some example embodiments, the granular material may contain any product or substance. For example, the granular material may contain confectionary products, food products, medicines, or any other product.

In some example embodiments, the throttle device 300, including the vibratory hopper 310, the intake hopper 330, and/or the interface structure 320 may comprise one or more materials, including one or more metal materials (e.g., stainless steel, aluminum, etc.), one or more plastic materials (e.g., Nalgene®, polyether ether ketone (PEEK) plastic, liquid crystal polymer (LCP), Acetal, etc.), or the like. In some example embodiments, the throttle device 300, including the vibratory hopper 310, the intake hopper 330, and/or the interface structure 320 may comprise any metal material. In some example embodiments, the throttle device 300, including the vibratory hopper 310, the intake hopper 330, and/or the interface structure 320 comprise a same material (e.g., stainless steel, aluminum, plastic, etc.). In some example embodiments, the vibratory hopper 310 may include a single, unitary piece of material. In some example embodiments, the interface structure 320 may include a single, unitary piece of material. In some example embodiments, the intake hopper 330 may include a single, unitary piece of material.

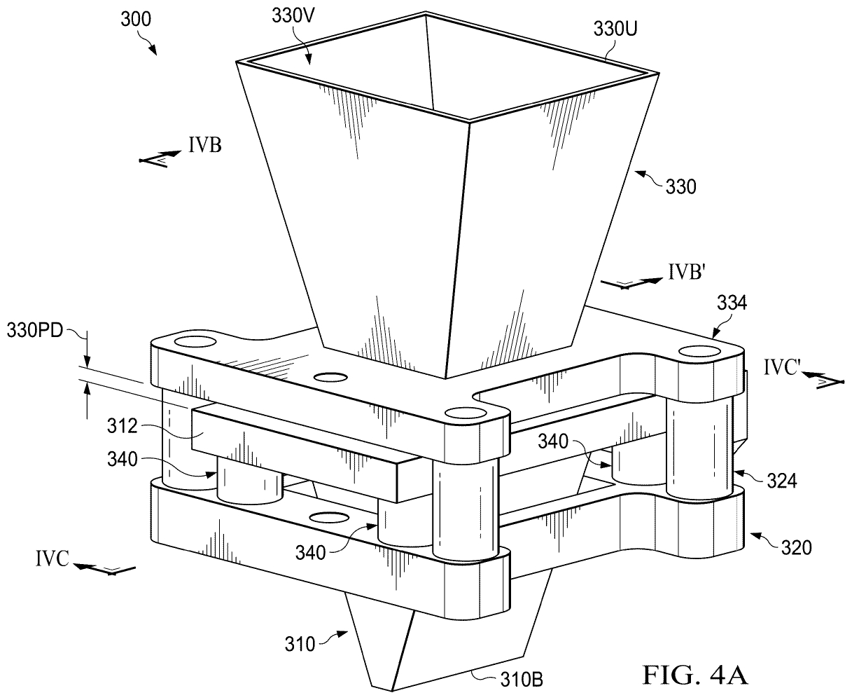

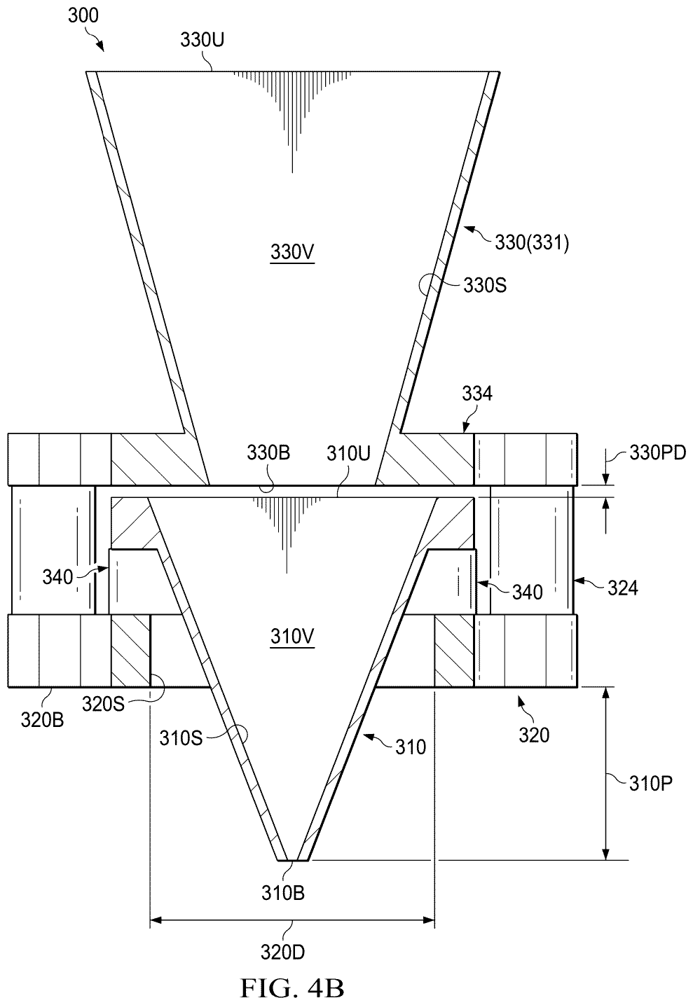

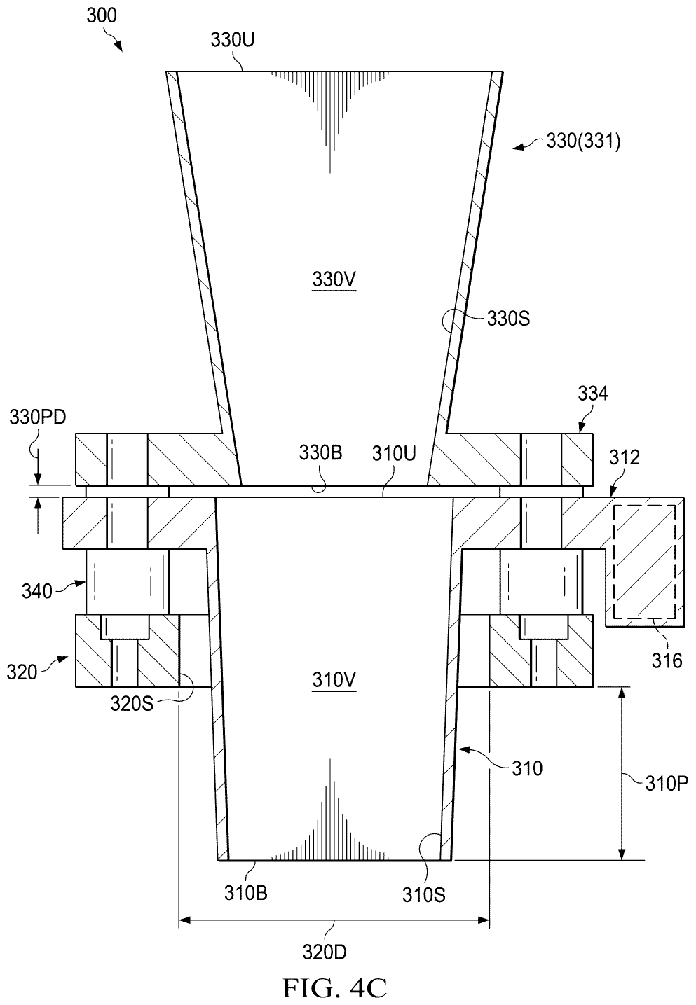

FIG. 4A is a perspective top view of a throttle device, according to some example embodiments. FIG. 4B is a cross-sectional view of the throttle device of FIG. 4A along cross-sectional view line IVB-IVB′ in FIG. 4A, according to some example embodiments. FIG. 4C is a cross-sectional view of the throttle device of FIG. 4A along cross-sectional view line IVC-IVC′ in FIG. 4A, according to some example embodiments.

Referring to FIGS. 4A-4C, the intake hopper 330 may be entirely vertically spaced apart from the vibratory hopper conduit 310V such that the intake hopper bottom opening 330B is vertically spaced apart from the vibratory hopper top opening 310U by a vertical spacing distance 330PD. For example, as shown in FIGS. 4A-4C the intake hopper 330 may omit the bottom portion 332 shown in FIGS. 1, 2A-2C, and 3A-3B, such that the intake hopper 330 includes the top portion 331 which defines a tapering intake hopper conduit 330V that tapers from an intake hopper top opening 330U to an intake hopper bottom opening 330B.

Referring back to FIGS. 1, 2A-2C, and 3A-3C, in some example embodiments, the supply hopper 200 may be entirely vertically spaced apart from the intake hopper 330 and/or the vibratory hopper 310 such that the supply hopper bottom opening 200B of the supply hopper 200 is vertically spaced apart from the intake hopper top opening 330U and/or from the vibratory hopper top opening 310U. For example, the supply hopper 200 may omit the bottom portion 204 shown in FIGS. 1, 2A-2B, and 3A-3B, such that the supply hopper 200 includes the top portion 202 which defines a tapering supply hopper conduit 200V that tapers from a supply hopper top opening 200U to a supply hopper bottom opening 200B at the bottom of the top portion 202 which is vertically spaced apart from the intake hopper top opening 330U and/or from the vibratory hopper top opening 310U.

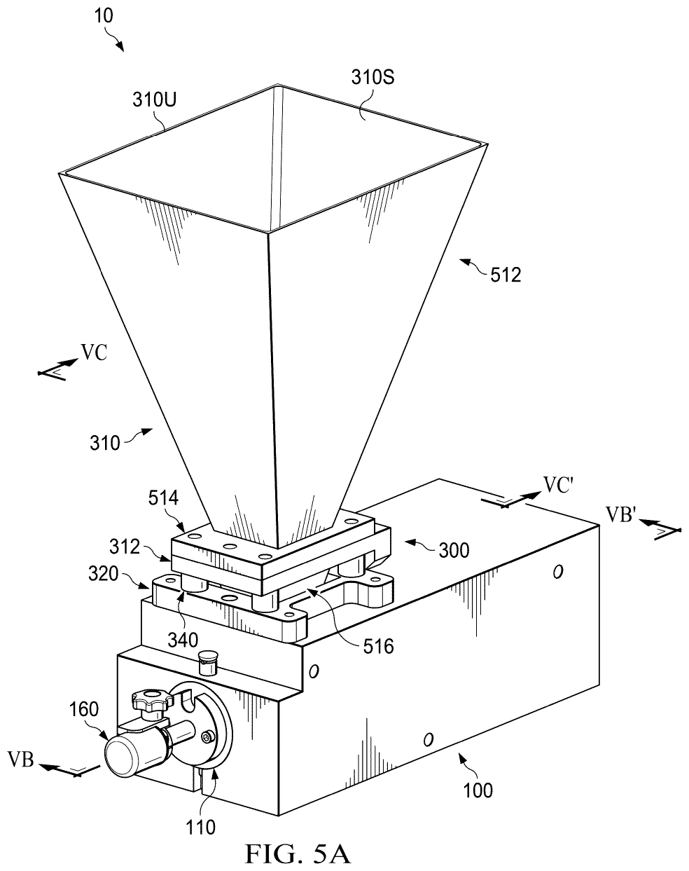

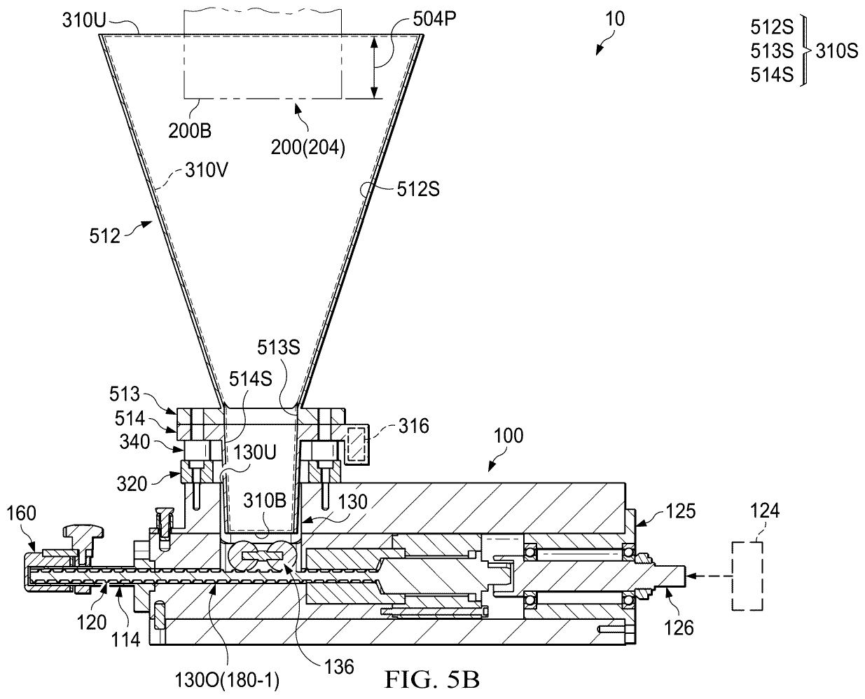

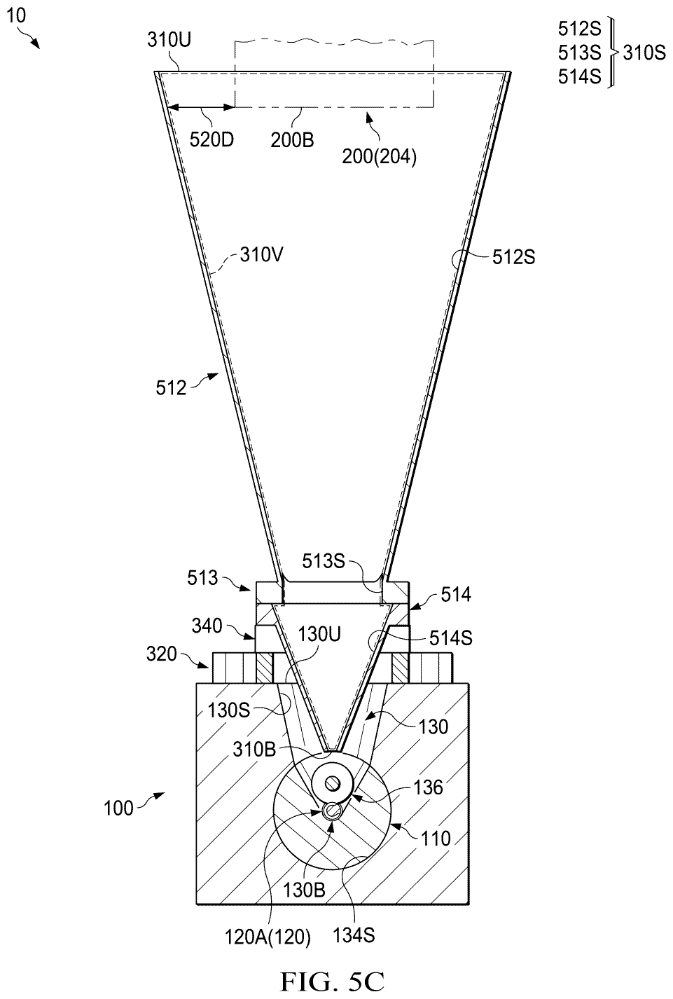

FIG. 5A is a perspective top view of a doser apparatus including a throttle device, according to some example embodiments. FIG. 5B is a cross-sectional view of the doser apparatus of FIG. 5A along cross-sectional view line VB-VB′ in FIG. 5A, according to some example embodiments. FIG. 5C is a cross-sectional view of the doser apparatus of FIG. 5A along cross-sectional view line VC-VC′ in FIG. 5A, according to some example embodiments.

Referring to FIGS. 5A-5C, in some example embodiments the throttle device 300 may omit the intake hopper 330, and the supply hopper 200 may be on the vibratory hopper 310 and/or may have a supply hopper bottom opening 200B that vertically overlaps the vibratory hopper top opening 310U. As shown, the vibratory hopper 310 may include one or more portions 512, 513, and/or 514 that have one or more inner surfaces 512S, 513S, and/or 514S that collectively define the one or more inner surfaces 310S that further define a vibratory hopper conduit 310V extending between a vibratory hopper top opening 310U and a vibratory hopper bottom opening 310B, where at least a portion (e.g., upper portion 512) of the vibratory hopper 310 may extend to at least partially horizontally overlap and/or surround at least a portion of the supply hopper 200 (e.g., the bottom portion 204 as shown in FIGS. 5A-5C). As a result, the supply hopper 200 may be configured to direct a supply flow of the granular material from the supply hopper conduit 200V to the vibratory hopper conduit 310V (e.g., directly to the vibratory hopper conduit 310V without passing through any interposing conduits or hoppers) through the supply hopper bottom opening 200B and the vibratory hopper top opening 310U. As shown, the vibration device 316 may be at least partially incorporated into at least one portion 514 of the vibratory hopper 310, but example embodiments are not limited thereto and in some example embodiments the vibration device 316 may be integrated in and/or mechanically coupled to any portion of the vibratory hopper 310.

The bottom portion 204 may extend vertically (e.g., project) through the vibratory hopper top opening 310U and project 504P into at least a portion (e.g., an upper portion) of the vibratory hopper conduit 310V, such that the supply hopper bottom opening 200B may be located vertically below the vibratory hopper top opening 310U and thus may be vertically between the vibratory hopper top opening 310U and the vibratory hopper bottom opening 310B. As a result, the vibratory hopper 310 may at least partially surround the bottom portion 204 (e.g., the projecting 504P portion thereof) of the supply hopper 200 (e.g., in a horizontal plane). Accordingly, an escape pathway for granular material directed from the supply hopper 200 into the vibratory hopper 310 through the supply hopper bottom opening 200B to escape the vibratory hopper 310 via the vibratory hopper top opening 310U may be an upwards-directed pathway. Such an upwards-directed pathway may mitigate (e.g., reduce, minimize, or prevent) the potential for granular material escape through the vibratory hopper top opening 310U. As a result, the throttle device 300 may be configured to mitigate flow of the granular material out of the vibratory hopper conduit 310V through an annular portion of the intake hopper top opening 330U defined between an outer surface of the bottom portion 204 of the supply hopper 200 and an inner surface 310S of the vibratory hopper 310 defining an upper portion of the vibratory hopper conduit 310V. In some example embodiments, and as shown, a bottom portion 204 of the supply hopper 200 that extends into the vibratory hopper conduit 310V may be isolated from direct contact with the intake hopper 330 by a spacing distance 520D, thereby contributing to isolation of the supply hopper 200 (and any structures to which the supply hopper 200 is fixed) from the throttle device 300 and any vibration of the vibratory hopper 310 therein.

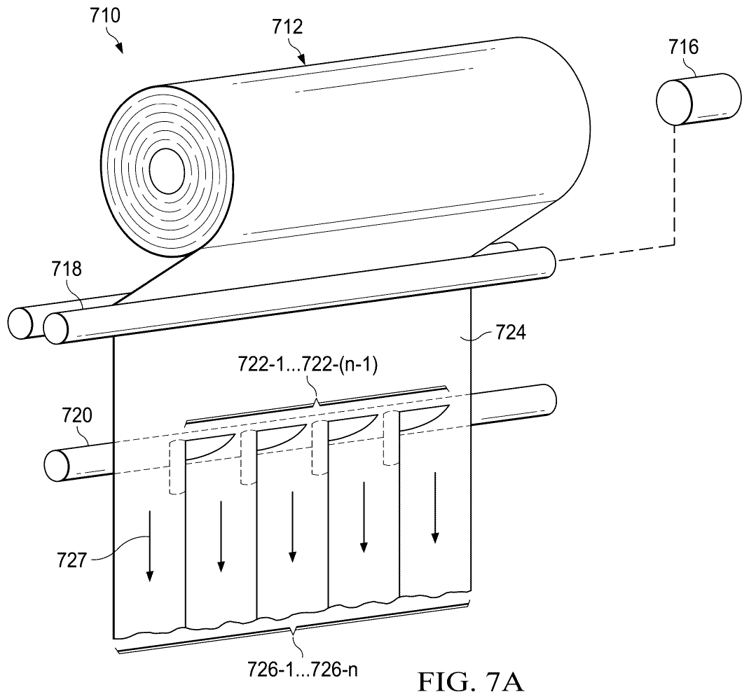

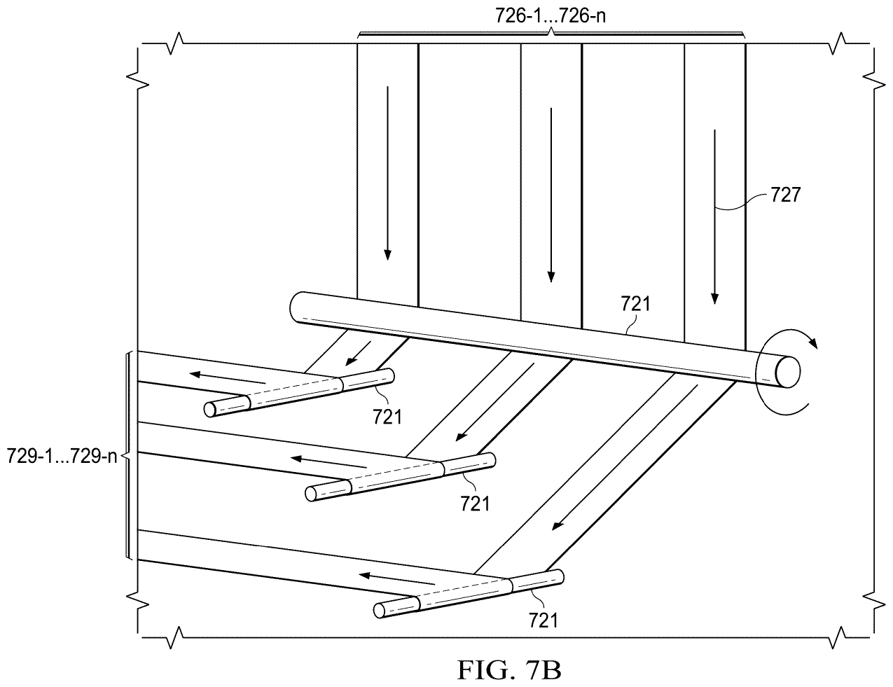

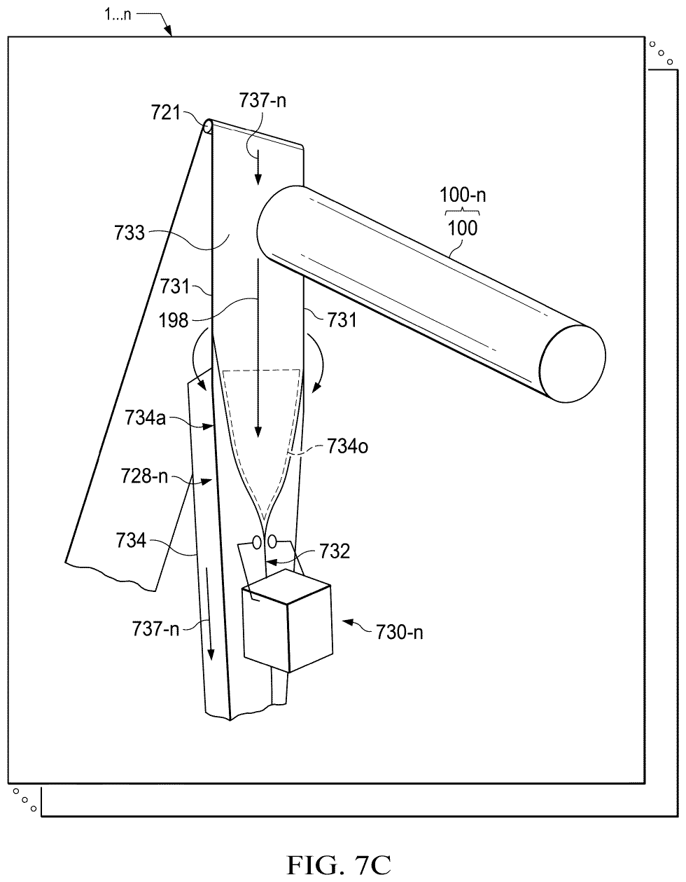

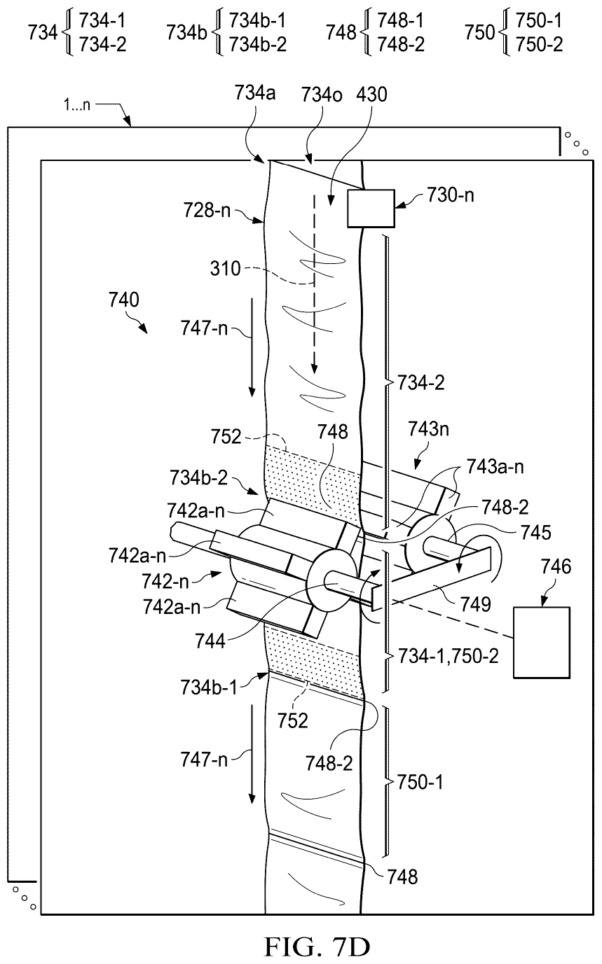

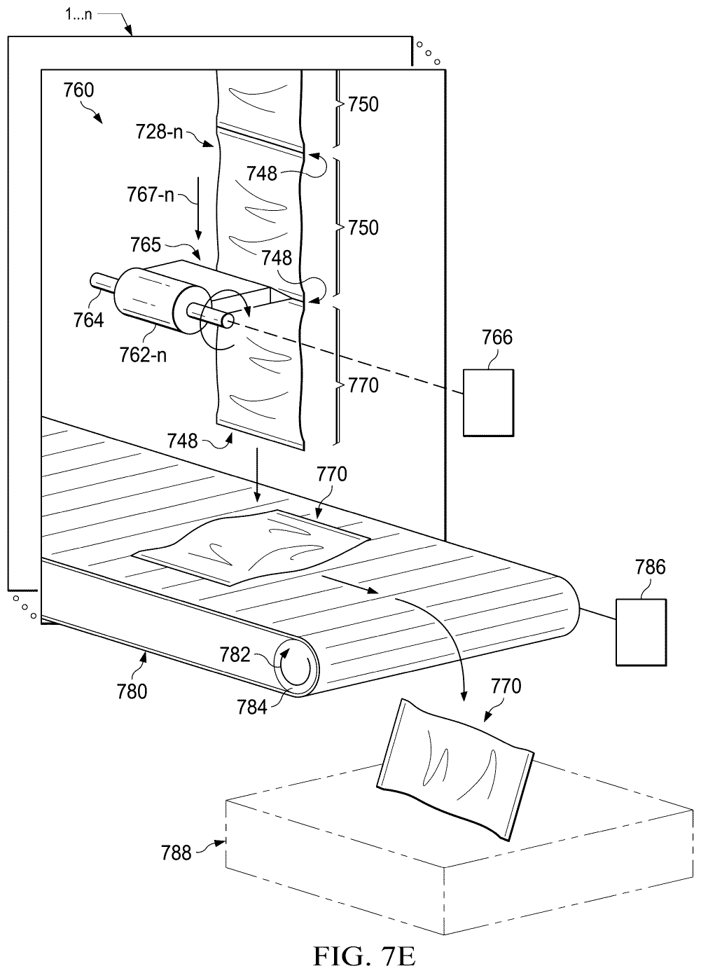

FIG. 6 is a schematic view of a packaging machine 700 that includes at least one doser apparatus 10, according to some example embodiments. FIGS. 7A, 7B, 7C, 7D, and 7E are expanded perspective views of respective regions A, B, C, D, and E of the packaging machine of FIG. 6, according to some example embodiments.

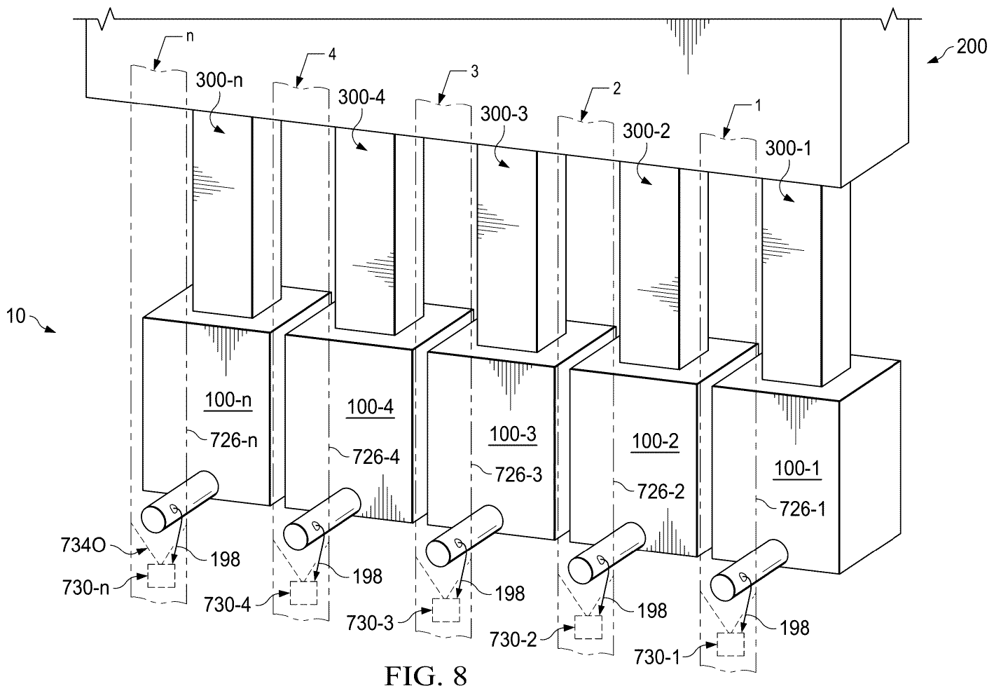

Referring to FIGS. 6 and 7A to 7E, the doser apparatus 10 according to any of the example embodiments may be included in a packaging machine 700 configured to supply granular material into one or more articles of packaging material (e.g., one or more folded strips of packaging material defining separate, respective open enclosures) may include “n” parallel process streams (e.g., process streams 1 to n) and thus may include “n” doser mechanisms 100-1 to 100-n that are configured to supply respective index amounts of granular material 198 into separate, respective “n” articles of packaging in separate, respective “n” parallel process streams, thereby enabling the packaging machine 700 to form packages of granular material in “n” parallel processes. While n is shown to be equal to 5 in FIGS. 7A-7E and also FIG. 8, it will be understood that “n” may be any positive integer equal to or greater than 1 (e.g., n may be equal to 1, 2, 3, 4, 5, 6, 7, 8, 9, 10, or any integer greater than 10 in a given packaging machine 700).

Each of the doser mechanisms 100-1 to 100-n may be a doser mechanism 100 of one or more doser apparatuses 10 according to any of the example embodiments, including any of the example embodiments of the doser mechanism 100 of any of the example embodiments of a doser apparatus 10. As further shown in FIG. 6, the doser apparatus 10 of the packaging machine 700 may include doser mechanisms 100-1 to 100-n, throttle devices 300-1 to 300-n coupled to separate, respective doser mechanisms 100-1 to 100-n, and one or more supply hoppers 200 coupled to the respective throttle devices 300-1 to 300-n. Each of the throttle devices 300-1 to 300-n may be a throttle device 300 of one or more doser apparatuses 10 according to any of the example embodiments, including any of the example embodiments of the throttle device 300 of any of the example embodiments of a doser apparatus 10.

Referring now to FIG. 6 and FIGS. 7A-7B, the packaging machine 700 may include a packaging supply device 710 configured to supply an article of packaging (e.g., one or more strips of packaging material) that may define an open enclosure in which granular material is supplied by the doser mechanism 100 as granular material 198. As shown, the packaging supply device 710 may include a roll 712 of a sheet of packaging material 724, where packaging supply device 710 may include a drive motor 716 (e.g., a servomotor) which may be configured to cause the roll 712 to rotate around its central axis (e.g., based on driving rotation of one or more rollers 718 of packaging supply device 710) and cause the sheet of packaging material 724 to be fed from the roll 712. In some example embodiments, the sheet of packaging material 724 may include a sheet of any suitable packaging material, including a sheet of paper material (e.g., cellulose), a sheet of plastic material (e.g., low density polyethylene (LDPE/LLDPE), high density polyethylene HDPE, polypropylene), a sheet of metal foil, or the like. In some example embodiments, the packaging material may be referred to as a “wrapper” material.

As shown, the one or more rollers 718, or one or more other rollers of the packaging machine 700, may be configured to redirect the sheet of packaging material 724 that is fed from the roll 712 to move to, and in contact with, a cutting assembly 720 so that the sheet of packaging material 724 is cut in a local feed direction 727 (e.g., cut lengthwise) into separate strips 726-1 to 726-n of packaging material (n=5 in FIG. 7A). As shown, the cutting assembly 720 includes “n−1” blades 722-1 to 722-(n−1) which may be metal blades (e.g., steel blades) and which may be spaced apart from each other in a direction perpendicular to the local feed direction 727 of the sheet of packaging material 724 and aligned with the respective cutting edges thereof facing opposite to the local feed direction 727. As a result, the blades 722-1 to 722-(n−1) may cut the sheet of packaging material 724 lengthwise into “n” strips 726-1 to 726-n as the sheet of packaging material 724 is fed from the roll 712 and thus fed from the packaging supply device 710 to other portions of the packaging machine 700. As shown in at least FIG. 7B, each separate strip 726-1 to 726-n of packaging material may be manipulated by the packaging machine 700 (e.g., by separate rollers 721) to be redirected in separate, respective local feed directions 729-1 to 729-n into separate, respective process streams 1 to n to form separate enclosures into which separate streams and/or amounts of granular material 194 may be supplied by separate doser mechanisms 100-1 to 100-n.

It will be understood that, when “n” equals 1, the cutting assembly 720 (and thus the blades 722-1 to 722-(n−1) may be absent from the packaging machine 700.

Referring now to FIG. 6 and FIG. 7B, the packaging machine 700 may include rollers 721 (e.g., multiple rollers 721 as shown in FIG. 7B) that are configured to redirect the respective feed directions of the strips 726-1 to 726-n of packaging material into separate, respective local feed directions 729-1 to 729-n to be fed into separate, respective “n” process streams to be aligned with separate, respective doser mechanisms 100-1 to 100-n of the doser apparatus 10 of the packaging machine 700. As shown, the packaging machine 700 may include multiple rollers 721 arranged to redirect (e.g., change the local feed direction by 90 degrees in various directions) separate strips 726-1 to 726-n to align (e.g., overlap in the vertical direction) with separate, respective doser mechanisms 100-1 to 100-n of the respective process streams 1 to n in the packaging machine 700.

Referring now to FIGS. 7C-7E, the packaging machine 700 may be configured to define process streams 1 to n (“n” being any positive integer) that may be operated in parallel. Accordingly, elements of the “nth” process stream are described in detail with reference to at least FIGS. 7C-7E, but it will be understood that elements of the packaging machine 700 with regard to the 1 to (n−1)th process streams may be identical or substantially identical to elements of the elements of the packaging machine 700 described with regard to the nth process stream in reference to at least FIGS. 7C-7E.

Referring now to FIG. 6 and FIG. 7C, each separate strip of packaging material, of the strips 726-1 to 726-n, may be fed in a separate respective process stream of process streams 1 to n to be folded by a separate folding device 730-1 to 730-n to form a folded strip 728-1 to 728-n defining an open enclosure 734 (e.g., to form an open wrapper, article of packaging, etc.), and to be at least partially filled with a particular amount (e.g., index 752) of granular material 198 that is supplied by a separate doser mechanism 100-1 to 100-n.

Each separate folding device 730-1 to 730-n may be aligned (e.g., vertically aligned) with a separate process stream of the 1 to n process streams of the packaging machine 700 and thus only the nth folding device 730-n with regard to the nth strip 726-n in the nth process stream is described, but it will be understood that elements of the folding devices 730-1 to 730-(n−1) with regard to strips 726-1 to 726-(n−1) in the 1 to (n−1)th process streams may be identical or substantially identical to elements of the nth folding device 730-n described with regard to the nth process stream.

Each separate doser mechanism 100-1 to 100-n may be aligned (e.g., vertically aligned) with a separate process stream of the 1 to n process streams of the packaging machine 700 and thus only the nth doser mechanism 100-n with regard to the nth strip 726-n in the nth process stream is described, but it will be understood that elements of the doser mechanisms 100-1 to 100-(n−1) with regard to strips 726-1 to 726-(n−1) in the 1 to (n−1)th process streams may be identical or substantially identical to elements of the nth doser mechanism 100-n described with regard to the nth process stream.

As shown in FIG. 7C, the nth folding device 730-n is configured to fold the nth strip 726-n of packaging material that is fed into the nth process stream to form an nth folded strip 728-n of packaging material that defines an open enclosure 734 defined by one or more surfaces 733 of the given nth folded strip 728-n. As shown in FIG. 7C, a given nth folding device 730-n may be configured to bring opposite side edges 731 of the given nth strip 726-n together and join and/or seal the opposite side edges 731 together as the given nth strip 726-n moves in a nth local feed direction 737-n past the nth folding device 730-n to thereby form a fin seal 732 of the opposite side edges 731 that extends in the nth local feed direction 737-n. The nth folding device 730-n may include a device configured to cause the opposite side edges 731 of the nth strip 726-n to be brought in contact with each other and pressed together to at least partially facilitate the formation of the fin seal 732 that extends in the nth local feed direction 737-n, as the nth strip 726-n moves past the nth folding device 730-n in the nth local feed direction 737-n, to form the nth folded strip 728-n. The nth folding device 730-n may include a device configured to attach the opposite side edges 731 of the nth strip 726-n together (e.g., to press the opposite side edges 731 together) to seal the opposite side edges 731 together to form the fin seal 732 that establishes the nth folded strip 728-n defining the open enclosure 734 therein. The nth folding device 730-n may include a heater (e.g., an electrically-powered resistive heater) that is configured to heat a portion of the nth folding device 730-n (e.g., to about 300 F) that contacts at least a portion of the nth strip 726-n in order to heat the opposite side edges 731 that are pressed together to cause the contacted opposite side edges 731 to adhere to each other to facilitate the formation of the fin seal 732 that extends in the nth local feed direction 737-n.

As shown, the open enclosure 734 of the nth folded strip 728-n may be closed in side directions perpendicular to the nth local feed direction 737-n based on the established fin seal 732 that extends parallel to the nth local feed direction 737-n along a side of the nth folded strip 728-n. The open enclosure 734 of the nth folded strip 728-n may be open at a proximate end that is proximate to the nth doser mechanism 100-n and may be closed at a distal end that is distal to the nth doser mechanism 100-n. In FIGS. 6 and 7C, the nth local feed direction 737-n is downwards in the direction of gravity, such that the open enclosure 734 of the nth folded strip 728-n that is formed based on folding the nth strip 726-n to join opposite side edges 731 thereof is open at a top end thereof and thus is understood to have a top opening 7340 at the proximate end of the open enclosure 734. As described further with reference to FIGS. 6 and 7D, the open enclosure 734 may be closed at the distal end that is opposite the top opening 7340 (e.g., at a bottom of the open enclosure 734) by an end seal 748.

Still referring to FIGS. 6 and 7C, and further referring to FIG. 7D, each given doser mechanism 100 of doser mechanisms 100-1 to 100-n of the doser apparatus 10 of the packaging machine 700 may be configured to execute an index operation to supply a particular index amount (e.g., index 752) of granular material 198 through the doser outlet opening 180-2 of the given doser mechanism 100 based on the conveyor device 120 of the given doser mechanism 100 being in the “on” operating state for a particular period of time at a particular rate such that the one or more conveyor devices 120 thereof are rotating 128 at particular respective rates of rotation for the particular period of time. As shown in FIGS. 6, 7C and 7D, the nth doser mechanism 100-n executing an index operation supplies (e.g., discharges) the particular index amount (e.g., index 752) of granular material 198 out of the nth doser mechanism 100-n and into the open enclosure 734 of the nth folded strip 728-n.

As shown in FIGS. 6, 7C, and 7D, the nth doser mechanism 100-n may be positioned to be vertically above (e.g., vertically aligned with) the top opening 7340 at the proximate end 734a of the open enclosure 734 of the nth folded strip 728-n, such that the given nth doser mechanism 100-n is configured to supply an amount of granular material 198 that falls from the nth doser mechanism 100-n, through the top opening 7340 of the open enclosure 734 at the proximate end 734a thereof, and to the distal end 734b of the open enclosure 734 adjacent to the end seal 748 that closes the distal end 734b of the open enclosure 734.

The doser apparatus 10 may include a drive motor 124 mechanically coupled to one or more of the doser mechanisms 100-1 to 100-n. The doser apparatus 10 may include a plurality of drive motors 124 mechanically coupled to separate, respective doser mechanisms 100-1 to 100-n. The drive motor 124 may be a servomotor that is controlled by a control device (e.g., control device 790 as described below) to, at particular intervals of time, rotate a driveshaft thereof at a particular rate of rotation for a particular period of time, to cause the one or more conveyor devices 120 of the nth doser mechanism 100-n to rotate 128 at respective rates of rotation for the particular period of time, in order to execute an index operation that causes the nth doser mechanism 100-n to supply a particular index amount (e.g., index 752) of granular material 198 into the open enclosure 734 of the nth folded strip 728-n. Each separate period of operation of the nth doser mechanism 100-n to supply a separate index 752 of granular material 198 may be understood to be a separate index operation performed by the nth doser mechanism 100-n. The nth doser mechanism 100-n may be controlled (e.g., by control device 790) to perform index operations that each have a particular start time, period of time, end time, and/or associated rate of rotation of the drive motor 124 at a particular time interval or “time spacing” between adjacent index operations.

When the conveyor device 120 of the given nth doser mechanism 100-n is stopped (e.g., is in the “off” operating state, at the end of an index operation and/or between index operations), the supply of granular material from the nth doser mechanism 100-n into the open enclosure 734 may be stopped.

As shown in FIGS. 6, 7C, and 7D, based on a particular index amount (e.g., index 752) of granular material 198 being supplied by the given nth doser mechanism 100-n into an open enclosure 734 of the nth folded strip 728-n of packaging material, said open enclosure 734 may be at least partially filled at the distal end 734b thereof by the index 752 of granular material. For example, as shown, open enclosure 734 of the folded strip 728-n may be open (e.g., have opening 7340) at the proximate end 734a (e.g., top end) and may be sealed at the distal end 734b (e.g., bottom end) by an end seal 748. A distal (e.g., bottom) portion of the open enclosure 734 that is adjacent to the distal end 734b (e.g., adjacent to and at least partially defined by the end seal 748 that seals the distal end 734b of the open enclosure 734) may be at least partially filled with the index 752 of granular material 198 that is supplied into the open enclosure 734 from the nth doser mechanism 100-n.

It will be understood, as described herein, that the nth doser mechanism 100-n of the doser apparatus 10 may be controlled to perform “index” operations to supply a particular amount (e.g., index 752) of granular material 198 into the open enclosure 734 of the folded strip 728-n, via the opening 7340 at the proximate end 734a of the open enclosure 734, at a particular time interval that may be controlled by the control device 790, where the index operation includes the control device 790 causing the drive motor 124 of the doser apparatus 10 that is mechanically coupled to the conveyor device 120 of the nth doser mechanism 100-n to rotate for a particular period of time and at a particular rate of rotation that is associated with the one or more conveyor devices 120 of the nth doser mechanism 100-n causing the particular amount (e.g., index 752) of granular material 198 to be supplied into the distal portion of the open enclosure 734 of the nth folded strip 728-n that is adjacent to the distal end 734b thereof.

As described herein, an nth throttle device 300-n of the doser apparatus 10 may be configured to control a depth 194H of granular material 194 in the respective doser reservoir 130 of the nth doser mechanism 100-n and thus to control a head pressure on a portion 120A of the conveyor device 120 of the nth doser mechanism 100-n that is exposed to the doser reservoir 130, thereby improving performance of the nth doser mechanism 100-n to supply indexes 752 with improved uniformity and consistency based on the head pressure acting on the conveyor device 120 in the nth doser mechanism 100-n being controlled (e.g., reduced, minimized, maintained within a certain range, optimized, or the like) based on the throttle device 300 restricting and/or controlling (e.g., throttling, metering, etc.) the flow 193 of granular material into the doser reservoir 130 of the nth doser mechanism 100-n.

Referring now to FIG. 6 and FIG. 7D, the packaging machine 700 may include a sealing device 740 that is configured to join opposing inner surfaces 739 defining opposite sides of the open enclosures 734 of the folded strips 728-1 to 728-n to establish respective new end seals 748-2 that each isolate at least a distal portion 734-1 of the open enclosures 734 defined by the folded strips 728-1 to 728-n of packaging material and adjacent to a previously-established end seal 748-1 from a remainder, proximate portion 734-2 of the open enclosures 734 to partition, in the local feed directions 747-1 to 747-n, the portions of the open enclosures 734 of the folded strips 728-1 to 728-n that each contain an index 752 of granular material into isolated sealed enclosures 750 each containing a separate, particular amount (e.g., index 752) of granular material.

As shown, the sealing device 740 may include a set of first projection devices 742-1 to 742-n connected via a central rod 744 and a set of second projection devices 743-1 to 743-n connected via a separate central rod 745 mechanically coupled to the first projection devices 742-1 to 742-n via meshed gears 749 to synchronize rotation of the first projection devices 742-1 to 742-n with the rotation (e.g., counter-rotation) of the second projection devices 743-1 to 743-n. The central rod 744 may be mechanically connected to a drive motor 746 (e.g., directly or via a drive transmission such as meshed gears 749) and thus may be configured to rotate around its longitudinal axis based on operation of the drive motor 746 to further cause the first projection devices 742-1 to 742-n to rotate around the longitudinal axis of the central rod 744. The central rod 745 may be mechanically connected to the drive motor 746 (e.g., directly or via a drive transmission such as meshed gears 749) and thus may be configured to rotate around its longitudinal axis based on operation of the drive motor 746 to further cause the second projection devices 743-1 to 743-n to rotate around the longitudinal axis of the central rod 745, for example in an opposite rotational direction than the first projection devices 742-1 to 742-n.

Each separate first projection device 742-1 to 742-n and second projection device 743-1 to 743-n may be aligned (e.g., vertically aligned and/or horizontally overlapped) with a separate nth process stream of the packaging machine 700 and thus only the portions of the sealing device 740 with regard to the nth process stream are described, but it will be understood that elements of the sealing device 740 with regard to the 1 to (n−1)th process streams may be identical or substantially identical to elements of the sealing device 740 described with regard to the nth process stream.

As shown in at least FIG. 7D, the nth first and second projection devices 742-n and 743-n may be arranged to be aligned with (e.g., horizontally overlap with) opposite sides of the nth folded strip 728-n that defines an open enclosure 734 containing an index 752 of granular material at a distal portion 734-1 thereof, adjacent to a distal end 734b of the open enclosure 734 that is closed by an end seal 748. The sealing device 740 may be located vertically below the nth doser mechanism 100-n of the nth process stream so that the nth folded strip 728-n moves downwards from the nth doser mechanism 100-n and nth folding device 730-n towards the nth first and second projection devices 742-n and 743-n of the sealing device 740 in the nth local feed direction 747-n.

The nth first projection device 742-n may include multiple pad projections 742a-n extending radially from a central axis of rotation of the nth first projection device 742-n (e.g., may extend radially from the central rod 744). The nth second projection device 743-n may include multiple pad projections 743a-n extending radially from a central axis of rotation of the nth second projection device 743-n (e.g., may extend radially from the central rod 745).

The nth first projection device 742-n may include a heater (e.g., a resistive heater) configured to heat the pad projections 742a-n (e.g., to about 300 F). The nth second projection device 743-n may or may not include a similar or identical heater.

The pad projections 742a-n may comprise a metal material (e.g., stainless steel, carbon steel, aluminum, or the like) a rubber material, a plastic material, or the like. The pad projections 743a-n may comprise a metal material (e.g., stainless steel, carbon steel, aluminum, or the like) a rubber material, a plastic material, or the like. The pad projections 742a-n and 743a-n may comprise a same material (e.g., pad projections 742a-n and 743a-n may both comprise stainless steel) or different materials (e.g., pad projections 742a-n may comprise stainless steel and pad projections 743a-n may comprise rubber).

As shown in at least FIGS. 6 and 7D, the nth first and second projection devices 742-n and 743-n may rotate (e.g., counter rotate in synchronized rates of rotation) around their respective longitudinal axes and in synchronization with each other as the nth folded strip 728-n is fed in the nth local feed direction 747-n in proximity to the nth first and second projection devices 742-n and 743-n. The rate of movement of the nth folded strip 728-n in the nth local feed direction 747-n may be synchronized with the rates of rotation of the nth first and second projection devices 742-n and 743-n around their respective longitudinal axes. The first and second projection devices 742-n and 743-n may be configured to rotate in synchronization and in opposite rotational directions, so that opposing pad projections 742a-n and 743a-n of the nth first and second projection devices 742-n and 743-n rotate into closest proximity with each other and with the nth folded strip 728-n (such that clearance between proximate pad projections 742a-n and 743a-n reaches a minimum) after a particular (e.g., fixed, constant, and/or predetermined) length of the nth folded strip 728-n has moved in the nth local feed direction 747-n past the nth first and second projection devices 742-n and 743-n.

Still referring to FIGS. 6 and 7D, as the nth first and second projection devices 742-n and 743-n rotate respective pad projections 742a-n and 743a-n thereof to a position of closest proximity to each other and to the nth folded strip 728-n, the proximate pad projections 742a-n and 743a-n may contact and press into opposite outer surfaces of the folded strip 728-n to cause opposing inner surfaces 739 of the open enclosure 734 of the nth folded strip 728-n to be joined (e.g., pressed together) and sealed to each other to form an end seal 748 (e.g., end seal 748-2), that extends across a width of the nth folded strip 728-n in a direction that is different from (e.g., perpendicular to) the nth local feed direction 747-n, thereby partitioning (e.g., isolating) a feed direction-leading portion (e.g., distal portion 734-1) of the open enclosure 734 of the nth folded strip 728-n from a remainder, proximate portion 734-2 (e.g., proximate portion) of the open enclosure 734 of the nth folded strip 728-n. The nth first projection device 742-n may include a heater configured to heat the pad projections 742a-n (e.g., to about 300 F) so that, when proximate pad projections 742a-n and 743a-n press opposing inner surfaces 739 of the open enclosure 734 together, the heated pad projections 742a-n may cause the pressed-together inner surfaces 739 of the open enclosure 734 to adhere to each other to form the end seal 748.

When the nth local feed direction 747-n of a given nth folded strip 728-n at the sealing device 740 is vertically downwards, the feed direction leading portion (e.g., distal portion 734-1) of the open enclosure 734 is a bottom portion of the open enclosure 734 that is below the nth first and second projection devices 742-n and 743-n when respective pad projections 742a-n and 743a-n thereof are rotated into closest proximity to each other and the nth folded strip 728-n and the remainder, proximate portion 734-2 of the open enclosure 734 is an upper portion of the open enclosure 734 that is above the sealing device 740 when the respective pad projections 742a-n and 743a-n are rotated into closest proximity to each other and to the nth folded strip 728-n. Prior to respective pad projections 742a-n and 743a-n being rotated into closest proximity to each other and to the nth folded strip 728-n, the end seal 748-2 shown in FIG. 7D may be absent such that the distal and proximate portions 734-1 and 734-2 are separate, continuous portions of a single open enclosure 734 that are not partitioned or sealed from each other. As shown, the distal portion 734-1 of the open enclosure 734 may be adjacent to, and at least partially defined by, the end seal 748-1 that defines distal end 734b-1 of the open enclosure 734 prior to end seal 748-2 being formed. In some example embodiments, when opposing pad projections 742a-n and 743a-n are at closest proximity to each other and to the nth folded strip 728-n, the pad projections 742a-n and 743a-n may form an end seal 748-2 that partitions the distal portion 734-1 (e.g., bottom portion) of the open enclosure 734 (that contains an index 752 of granular material from the remainder, proximate portion 734-2 (e.g., upper portion) of the open enclosure 734.

As a result, the open enclosure 734 of the nth folded strip 728-n may be partitioned, at end seal 748-2, by the sealing device 740 into separate sealed enclosures 750, isolated (e.g., partitioned) from each other in the nth local feed direction 747-n by respective end seals 748. For example, distal portion 734-1 and proximate portion 734-2 may be partitioned from each other by end seal 748-2 as shown in FIG. 7D so that distal portion 734-1 is partitioned to form sealed enclosure 750-2 and end seal 748-2 defines a new distal end 734-b2 of the open enclosure 734 that may be empty or substantially empty of granular material.

Each separate sealed enclosure 750 includes (e.g., contains, holds, etc.) a separate, particular amount (e.g., index 752) of granular material and is closed at opposite ends in the nth local feed direction 747-n by separate end seals (e.g., sealed enclosure 750-2 is closed at opposite ends by end seals 748-1 and 748-2). The sealed enclosures 750 may have a same or substantially same length in the nth local feed direction 747-n. As a result, each separate sealed enclosure 750 that is formed by the sealing device 740 may contain same or substantially same amounts of granular material (e.g., same-sized indexes 752).

The rate of movement of the nth folded strip 728-n in the nth local feed direction 747-n and the rates of rotation of the nth first and second projection devices 742-n and 743-n may be synchronized with the intervals and/or durations of index operations performed by the nth doser mechanism 100-n so that the nth doser mechanism 100-n begins an index operation to supply a single index 752 of granular material into the distal portion 734-1 of the open enclosure 734 after the nth first and second projection devices 742-n and 743-n have formed a first end seal 748-1 to partition (e.g., seal) a previously-supplied index 752 into a first sealed enclosure 750-1. Thus, the single index 752 is supplied into an empty distal portion 734-1 of the open enclosure 734 having an open proximate end 734a and a distal end 734b-1 closed by the first end seal 748-1. The nth doser mechanism 100-n ends the index operation prior to the particular length of the folded strip 728-n being moved past the nth first and second projection devices 742-n and 743-n. The nth first and second projection devices 742-n and 743-n may form a next end seal 748-2, above the fill line of the single index 752 in the distal portion 734-1, to seal the single index 752 into a next sealed enclosure 750-2 and to establish a new, closed distal end 734b-2 of the open enclosure 734 that is closed by next end seal 748-2 and is devoid or substantially devoid of granular material.

In some example embodiments, the first to nth second projection devices 743-1 to 743-n may be absent from the packaging machine 700.

Referring now to FIG. 6 and FIG. 7E, the packaging machine 700 may include a cutting device 760 that is configured to separate sealed enclosures 750 of each given folded strip 728-1 to 728-n of packaging material into separate packages 770 (also referred to herein as articles of packaging) that each contain a separate index 752 of granular material, where each index 752 may be a same or substantially same amount of granular material.

As shown, the cutting device 760 may include a plurality of blades 762-1 to 762-n, also referred to herein as “blades”, connected via a central rod 764. The central rod 764 may be mechanically connected to a drive motor 766 (e.g., a servomotor) and thus may be configured to rotate around its longitudinal axis based on operation of the drive motor 766 to further cause the blades 762-1 to 762-n to rotate around the longitudinal axis of the central rod 764.

Each separate blade 762-1 to 762-n may be aligned (e.g., vertically and/or horizontally overlapped) with a separate nth process stream of the packaging machine 700 and thus only the portions of the cutting device 760 with regard to the nth process stream are described, but it will be understood that elements of the cutting device 760 with regard to the 1 to (n−1)th process streams may be identical or substantially identical to elements of the cutting device 760 described with regard to the nth process stream.

As shown in at least FIG. 7E, the nth blade 762-n may be arranged to be aligned with (e.g., horizontally overlap with) the nth folded strip 728-n that defines at least one sealed enclosure 750 containing a particular amount (e.g., index 752) of granular material. The cutting device 760 may be located vertically below the sealing device 740 of the nth process stream so that the nth folded strip 728-n moves in an nth local feed direction 767-n (e.g., downwards) from the nth first and second projection devices 742-n and 743-n towards the nth blade 762-n of the cutting device 760.

As shown in at least FIGS. 6 and 7E, the nth blade 762-n may rotate around the longitudinal axis of the central rod 764 as the nth folded strip 728-n is fed in the nth local feed direction 767-n (e.g., downwards) in proximity to the nth blade 762-n. The rate of movement of the nth folded strip 728-n in the nth local feed direction 767-n may be synchronized with the rate of rotation of the nth blade 762-n around the central rod 764 so that the nth blade 762-n rotates into closest proximity with the nth folded strip 728-n after a particular (e.g., fixed, constant, and/or predetermined) length of the strip 728-n, which may be the length of each sealed enclosure 750 between opposite adjacent end seals 748, has moved in the nth local feed direction 767-n past the cutting device 760. As a result, the packaging machine 700 may be configured to move the nth folded strip 728-n and further rotate the nth blade 762-n in synchronization with such movement such that, when the nth blade 762-n rotates into closest proximity with the nth folded strip 728-n, the nth blade 762-n contacts and cuts through (e.g., bisects) an end seal 748 of the nth folded strip 728-n in the direction in which the seal 748 extends (e.g., perpendicular to the nth local feed direction 767-n). The aforementioned rotation and movements may be synchronized so that the nth blade 762-n cuts through the centerline (or approximately the centerline) of each end seal 748 extending in the direction perpendicular to the nth local feed direction 767-n to exactly or substantially exactly (e.g., ±10%) cut the end seal 748 in half in the direction perpendicular to the nth local feed direction 767-n. The rotation of the nth blade 762-n may be further synchronized with movement of the nth folded strip 728-n so that each sequential end seal 748 of the nth folded strip 728-n is contacted by the nth blade 762-n, and the nth blade 762-n only contacts end seals 748 of the nth folded strip 728-n when the nth blade 762-n is at a closest proximity to the nth folded strip 728-n, as the nth blade 762-n and strip 728-n move in synchronization with each other. For example, the movement of a given strip 728-n in the nth local feed direction 767-n may be synchronized with the rotation of a corresponding nth blade 762-n around the central rod 764 so the distal edge 765 of the nth blade 762-n rotates into contact with a seal 748 of the nth folded strip 728-n after each rotation of the nth blade 762-n around the central rod 764 and a length of a single sealed enclosure 750 between adjacent end seals 748 of the strip 728-n has moved past the cutting device 760 in the nth local feed direction 767-n during a single rotation of the nth blade 762-n around the central rod 764.

Still referring to FIGS. 6 and 7E, as the nth blade 762-n rotates to a position of closest proximity to the nth folded strip 728-n, the nth blade 762-n (e.g., distal edge 765 thereof) may contact and cut through the proximate end seal 748 of the nth folded strip 728-n to cause a feed direction-leading sealed enclosure 750 of the nth folded strip 728-n to be separated from a remainder of the nth folded strip 728-n as a discrete article of packaging, which is interchangeably referred to herein as a package 770 that includes a discrete (e.g., particular) amount (e.g., index 752) of granular material.

For example, when the nth local feed direction 767-n of a given nth folded strip 728-n at the cutting device 760 is vertically downwards, the feed direction leading sealed enclosure 750 is a bottom sealed enclosure 750 of the nth folded strip 728-n that is below the distal edge 765 of the nth blade 762-n when the nth blade 762-n is at closest proximity to the nth folded strip 728-n and the remainder portion of the nth folded strip 728-n is above the distal edge 765 of the nth blade 762-n when the nth blade 762-n is at closest proximity to the nth folded strip 728-n. In such example embodiments, when the nth blade 762-n is at closest proximity to the nth folded strip 728-n, the nth blade 762-n may cut through (e.g., bisect) an end seal 748 that joins the bottom sealed enclosure 750 to a remainder of the nth-folded strip 728-n into two physically separate sealed portions, thereby separating the bottom sealed enclosure 750, as a package 770, from the remainder of the nth folded strip 728-n.

As a result, the sealed enclosures 750 of the nth folded strip 728-n may be cut by the cutting device 760 into separate packages 770 (e.g., separate articles of packaging) containing separate, respective indexes 752 of granular material, where the separate packages 770 have a same or substantially same length between opposite end seals 748 at opposite longitudinal ends thereof. As a result, each separate package 770 may contain same or substantially same amounts (e.g., indexes 752) of granular material.

FIG. 7E shows a single nth blade 762-n horizontally aligned with the nth process stream and rotating around the central rod 764, but example embodiments are not limited thereto. For example, similarly to the nth projection device 742-n shown in FIG. 7D, the cutting device 760 may include multiple nth blades 762-n extending radially from the central rod 764 and spaced apart (e.g., equally apart) from each other, and the nth blades 762-n may be rotated around central rod 764 to cut separate end seals 748 as the nth folded strip 728-n is fed to the cutting device 760 in the nth local feed direction 767-n.

Still referring to FIGS. 6 and 7E, each newly established (e.g., newly formed) package 770, having been separated from the rest of the nth folded strip 728-n by the cutting device 760, may fall to a conveyor 780 or a collection area/bin. In FIGS. 6 and 7E, where the packaging machine 700 includes a conveyor 780, packages 770 established by the cutting device 760 may fall onto an upper surface of the conveyor 780. As shown, the conveyor 780 may have a driven shaft 784 that is driven by a drive motor 786 (e.g., a servomotor) to rotate 782 to cause the conveyor 780 to move packages 770 thereon towards a collection area 788, which may be a collection bin.

Accordingly, packages 770 containing respective indexes 752 of granular material may be formed by the packaging machine 700 in “n” process streams that each include a doser mechanism 100 according to any of the example embodiments, where the packages 770 may be formed with improved precision, accuracy, and consistency of the amount of granular material supplied from each doser mechanism 100 to form each separate index 752 in each separate package 770 based on one or more throttle devices 300-1 to 300-n of the doser apparatus 10 improving the functionality of “n” doser mechanisms 100-1 to 100-n of the doser apparatus 10 based on reducing, minimizing, maintaining (within a certain range), optimizing, etc. the head pressure of the depth 194H of granular material 194 at the exposed respective conveyor devices 120 in the respective doser reservoirs 130 of the doser mechanisms 100-1 to 100-n based on the one or more throttle devices 300-1 to 300-n controlling (e.g., restricting, metering, throttling, etc.) a flow 193 of granular material into the respective doser reservoirs 130 of the one or more doser mechanisms 100-1 to 100-n, based on both the respective vibratory hoppers 310 of the one or more throttle devices 300-1 to 300-n being configured to induce bridging of granular material 194 therein and the respective vibratory hoppers 310 further being configured to controllably break the bridging to induce and control (e.g., throttle, meter, etc.) respective flows 193 therefrom based on operation of respective vibration devices 316 to induce vibration of the respective vibratory hoppers 310. As a result, a packaging machine 700 that includes said one or more doser mechanisms 100 of the doser apparatus 10, one or more supply hoppers 200, and one or more throttle devices 300 may be configured to improve the precision, accuracy, and consistency of the amounts of granular material included in each package 770.

In some example embodiments, the control device 790 is configured to control the various drive motors of the packaging machine 700 to cause the sheet and strips 726-1 to 726-n, 728-1 to 728-n of packaging material to be fed through the packaging machine 700 at a particular rate of movement, and for the rotation of the projection devices 742-1 to 742-n and 743-1 to 743-n of the sealing device 740 and the blades 762-1 to 762-n of the cutting device 760 and the intervals of the index operations of the doser mechanisms 100-1 to 100-n to be synchronized with the rate of motion of the sheet and/or strips 726-1 to 726-n, 728-1 to 728-n of packaging material through the packaging machine 700.

As shown, the control device 790 may implement the control device 500 of the doser apparatus 10. The control device 790 may control the doser mechanisms 100-1 to 100-n of the doser apparatus 10 to perform index operations at a particular interval that is synchronized with movement of the packaging material and with operation of the sealing device 740 so that each index operation supplies an index 752 of granular material into an open enclosure 734 that has been newly formed due to the sealing device 740 forming a new end seal 748 in the folded strip 728-n that seals a previous distal portion 734-1 containing a previously-supplied index 752 into a separate sealed enclosure 750 and establishes a new, empty distal portion 734-1 of the open enclosure 734. The control device 790 may be configured to adjust the interval between index operations, the duration of each index operation, the rate of operation of the one or more conveyor devices 120 (e.g., rate of rotation of the one or more augers) of any of the doser mechanisms 100-1 to 100-n during the index operation, or the like in order to control the amount of granular material in each index 752 and to control the time spacing between the supplying of each index 752. The control device 790 may be configured to account for differing flow rates of different granular materials out of the doser mechanisms 100-1 to 100-n. The control device 790 may control operation of one or more driving devices 400 and/or vibration devices 316 to control operation of one or more vibration devices 316 of one or more throttle devices 300-1 to 300-n. For example, where the one or more throttle devices 300-1 to 300-n include respective vibratory hoppers 310 including respective vibration devices 316 that are pneumatic ball vibrators such that the one or more driving devices 400 include a pressurized air supply source, the control device 790 may adjustably control a supply of pressurized air from the one or more driving devices 400 to the one or more vibration devices 316 of the respective vibratory hoppers 310 of the one or more throttle devices 300 in order to adjustably control (e.g., increase, decrease, inhibit, initiate, throttle, meter, restrict, etc.) a flow 193 of granular material from one or more throttle devices 300-1 to 300-n to one or more doser mechanisms 100-1 to 100-n. In some example embodiments, the one or more driving devices 400 may be omitted and the control device 790 may be communicatively coupled to, and configured to control the operation of, one or more vibration devices 316 (e.g., one or more electromechanical vibration devices) included in the one or more throttle devices 300.

The control device 790 may store a look-up table, which may be empirically established, which associates different index 752 amounts of various types of granular material with corresponding operational parameters of the packaging machine 700, including corresponding drive motor 124 index rotation rates, index durations, index time spacings (e.g., duration between time-adjacent indexes), rate of movement of the sheet/strips of packaging material, rate of rotation of the projections 742/743 and/or blades 762, amplitude and/or frequency of vibration of one or more vibration devices 316, operating rate of one or more driving devices 400 and/or vibration devices 316, some combination thereof or the like. Operations of drive motors may be represented based on timings, amounts, and/or rates of electrical power to be applied (e.g., supplied) to said drive motors. Based on a determined amount of a determined type of granular material to be included in each index 752 (which may be provided to the control device 790 via a communication interface, user interface such as a touchscreen and/or keyboard interface, or the like), the control device 790 may access the look-up table, determine the corresponding operational parameters associated with the determined index amount and type of granular material and control one or more portions of the packaging machine 700, including for example the drive motor 124 of each doser mechanism 100-1 to 100-n but also or alternatively including some or all of the drive motors, driving devices, and/or vibration devices of the packaging machine 700, to ensure that the packaging machine 700 creates packages 770 each containing a constant or substantially constant (e.g., ±10%) amount (e.g., index 752) of granular material across a range of granular materials and/or desired index 752 amounts.

Referring back to FIG. 6, the control device 790 may be configured to control some or all of the packaging machine 700, including some or all of the doser apparatus 10. As shown in FIG. 6, the control device 790 may be communicatively coupled to the drive motors 716, 124, 746, 766, 786 that may be separate servomotors and may cause various portions of the packaging machine 700 to operate. As described herein, the control device 790 may control one or more driving devices 400 to control one or more vibration devices 316 of the one or more throttle devices 300-1 to 300-n and/or may control the one or more vibration devices 316 directly (e.g., based on transmitting electrical signals to be received at the one or more vibration devices 316). The control device 790 may control some or all of the drive motors, driving devices, vibration devices, etc. of the packaging machine 700 to cause the packaging machine 700 to operate in order to form packages 770 each containing a particular amount (e.g., index 752) of granular material. The control device 790 may be configured to adjustably control the one or more driving devices 400, the one or more vibration devices 316, or any combination thereof to control a head pressure of the depth 194H of the granular material 194 in one or more doser reservoirs 130 of the one or more doser mechanisms 100-1 to 100-n, to control the depth 194H of the granular material 194 in one or more doser reservoirs 130 of the one or more doser mechanisms 100-1 to 100-n, or the like.

In some example embodiments, some or all of the control device 790 may include, may be included in, and/or may be implemented by one or more instances (e.g., articles, pieces, units, etc.) of processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), or any other device or devices capable of responding to and executing instructions in a defined manner. As shown in FIG. 5, the control device 790 may include some or all of a processor 792 (e.g., a CPU), a memory 794 (e.g., a solid-state drive, or SSD), and a communication interface 796 that are communicatively coupled together via a bus connection 798. It will be understood that any type of non-transitory computer readable storage device may be used as the memory 794 in addition or alternative to an SSD. In some example embodiments, the processing circuitry may include a non-transitory computer readable storage device, or memory (e.g., memory 794), for example a solid state drive (SSD), storing a program of instructions, and a processor (e.g., processor 792) that is communicatively coupled to the non-transitory computer readable storage device (e.g., via a bus connection 798) and configured to execute the program of instructions to implement the functionality of some or all of any of the devices and/or mechanisms of any of the example embodiments and/or to implement some or all of any of the methods of any of the example embodiments. It will be understood that, as described herein, an element (e.g., processing circuitry, digital circuits, etc.) that is described as “implementing” an element (e.g., packaging machine 700) will be understood to implement the functionality of said implemented element (e.g., the functionality of the packaging machine 700).

In FIGS. 6 and 7A-7E, the packaging machine 700 is shown to include multiple separate drive motors 716, 124, 746, 766, 786 coupled to separate, respective portions of devices of the packaging machine 700. However, example embodiments are not limited thereto. In some example embodiments, some or all portions of the packaging machine 700 may be driven by a single, same drive motor (e.g., drive motor 124) that is controlled by the control device 790. In some example embodiments, the packaging machine 700 includes a single drive motor 124 that is mechanically coupled (e.g., via one or more drive transmission mechanisms, including one or more drive belts, meshed gear set, or the like) to each of the packaging supply device 710, doser mechanisms 100-1 to 100-n, sealing device 740, cutting device 760, and conveyor 780 and is configured to drive each of said devices under control of the control device 790 and also such that the operation of said devices (and movements of elements thereof) are at least partially synchronized with respect to each other to enable the movement synchronization of various elements as described herein.

In some example embodiments, one or more of the described devices of the packaging machine 700 may be absent. For example, in some example embodiments the packaging machine 700 may move pre-formed open packages of packaging material, defining respective open enclosures 734, into alignment with separate, respective doser mechanisms 100-1 to 100-n to be filled with granular material by the doser mechanisms 100-1 to 100-n, and the packaging machine 700 may include a sealing device 740 that seals the open enclosures 734 of said open packages to form packages 770 containing respective indexes 752 of granular material supplied into the open enclosures 734 from one or more of the doser mechanisms 100-1 to 100-n. The doser mechanisms 100-1 to 100-n may each be controlled (e.g., based on controlling operation of the respective conveyor devices 120 thereof via control of the drive motor(s) 124 of the doser mechanisms 100-1 to 100-n) to initiate supplying granular material out of the respective second openings 180-2 for a particular period of time in response to an open package being moved to be vertically underneath the given doser mechanism and/or to not supply granular material when an open packet is not vertically underneath the given doser mechanism, such that the doser mechanisms 100-1 to 100-n may each supply a particular amount (e.g., index 752) of granular material into separate open packages. In some example embodiments, the cutting device 760, folding devices 730-1 to 730-n, and at least a portion of the packaging supply device 710 may be absent from the packaging machine 700.

FIG. 8 is a perspective view of region C of the packaging machine 700 of FIG. 6, according to some example embodiments.

Referring to FIG. 8, in some example embodiments a doser apparatus 10 may include multiple doser mechanisms 100-1 to 100-n configured to supply separate, respective amounts of granular material 198 in parallel and a plurality of throttle devices 300-1 to 300-n coupled between the supply hopper 200 and separate, respective doser reservoirs 130 of separate, respective intake doser mechanisms 100-1 to 100-n, such that separate, respective parallel flows 193 of a granular material held in the supply hopper 200 may be controllably supplied via separate, respective throttle devices 300-1 to 300-n to separate doser reservoirs 130 to be conveyed by separate, respective doser mechanisms 100-1 to 100-n to supply parallel lanes of index amounts of granular material 198.

In some example embodiments, and as shown in FIG. 8, “n” may be greater than 1 (e.g., in FIG. 8 n may equal 5), and the packaging machine 700 may include a doser apparatus 10 that includes a plurality of doser mechanisms 100-1 to 100-n, each separate doser mechanism configured to be aligned with a separate folded strip 728-1 to 728-n of packaging material and a separate folding device 730-1 to 730-n that is configured to fold the respective aligned strip 726 of packaging material to form a separate open enclosure 734 that is vertically aligned with the respective doser mechanism 100-1 to 100-n.

Accordingly, and as shown in FIG. 8 in relation to FIGS. 6 and 7A-7E, the plurality of doser mechanisms 100-1 to 100-n may be configured to supply separate, respective amounts (e.g., indexes 752) of the granular material 194 in parallel, “n” process streams, and the packaging supply device 710 may be configured to supply a plurality of articles of packaging (e.g., strips 726-1 to 726-n) in parallel to the plurality of doser mechanisms 100-1 to 100-n to be folded into a plurality of separate folded strips 728-1 to 728-n that define separate, respective open enclosures 734 that may be filled in parallel with granular material 194 from separate, respective doser mechanisms 100-1 to 100-n.

Still referring to FIG. 8, the plurality of doser mechanisms 100-1 to 100-n may include separate, respective doser reservoirs 130 and may be configured to draw respective amounts of granular material from respective doser reservoirs 130 that are supplied with granular material from a single supply hopper 200 via separate, respective throttle devices 300-1 to 300-n, such that the doser apparatus 10 may be configured to direct separate, respective flows of granular material in parallel from the single supply hopper 200 to multiple separate doser mechanisms 100-1 to 100-n via separate, respective throttle devices 300-1 to 300-n. While the throttle devices 300-1 to 300-n in FIG. 8 are shown to have rectangular cylindrical outer shapes, it will be understood that example embodiments are not limited thereto. For example, in some example embodiments each of the throttle devices 300-1 to 300-n may have the same shape and structure as the throttle device 300 shown in at least FIGS. 1, 2A-2C, and 3A-3C, the throttle device 300 shown in at least FIGS. 4A-4C and/or FIGS. 5A-5C, any combination thereof, or the like. While the doser apparatus 10 shown in FIG. 8 illustrates a single supply hopper 200 coupled to separate, respective sets of throttle devices 300-1 to 300-n, example embodiments are not limited thereto. For example, in some example embodiments, a doser apparatus 10 may include multiple supply hoppers 200 that are each configured to supply granular material into one or more throttle devices 300, such that at least two of the doser mechanisms 100-1 to 100-n of the doser apparatus 10 are configured to receive granular material from separate, respective supply hoppers 200 via one or more throttle devices 300.

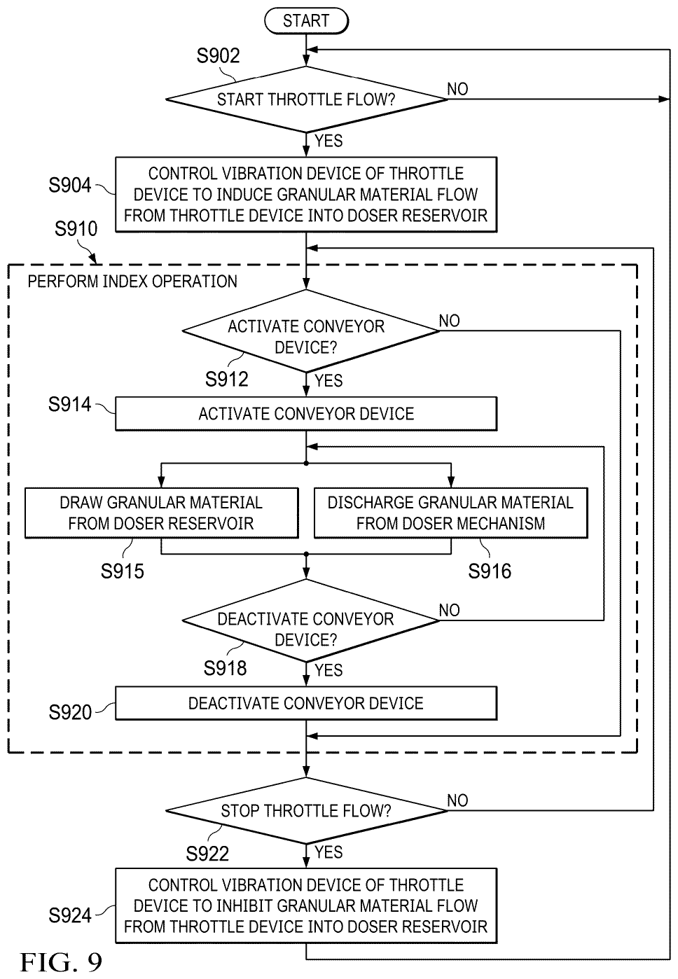

FIG. 9 is a flowchart illustrating a method of operating a doser apparatus that includes a throttle device, according to some example embodiments. The method shown in FIG. 9 may be implemented with regard to any of the doser apparatuses according to any of the example embodiments, including for example a control device configured to control one or more portions of the one or more doser apparatuses 10 (e.g., control device 790). The operations shown in FIG. 9 may be performed in parallel, simultaneously, independently of each other, sequentially, or any combination thereof. It will be understood that the operations of the method shown in FIG. 9 may be performed in a different order than shown in FIG. 9. It will further be understood that some operations shown in FIG. 9 may be omitted from the method in some example embodiments and/or some additional operations not shown in FIG. 9 may be added to the method shown in FIG. 9.

Referring to FIG. 9, at S902, a determination is made (e.g., based on processing programming of the control device 790, based on processing user input commands received at the control device 790 from an interface, or the like) whether to initiate flow of a granular material from at least a throttle device (e.g., throttle device 300) to a doser mechanism (e.g., doser mechanism 100). If not (S902=NO), the process repeats. If so (e.g., S902=YES), at S904 the vibration device of the throttle device is controlled (e.g., based on controlling the operation of a driving device 400 and/or based on transmitting a control signal to the vibration device 316) to generate vibrations having a particular amplitude and/or frequency, for example to “operate” and/or to be in an “on” operating state, to cause (e.g., induce) vibration of the vibratory hopper of the throttle device. Such induced vibration of the vibratory hopper at S904 may break (e.g., overcome) the bridging of such granular material in a vibratory hopper conduit (e.g., vibratory hopper conduit 310V) of the vibratory hopper to induce a flow (e.g., flow 193, also referred to as a first flow) of the granular material out of the vibratory hopper, and thus from the vibratory hopper conduit to the doser reservoir via vibratory hopper bottom opening (e.g., vibratory hopper bottom opening 310B). Accordingly, the controlling at S904 may include causing a flow (e.g., flow 193) of the granular material held in the vibratory hopper conduit (e.g., granular material 192) to be supplied from the vibratory hopper of the throttle device to the doser reservoir via the vibratory hopper bottom opening, where the flow (e.g., the magnitude, flow rate, etc. thereof) may be controlled (e.g., throttled, metered, restricted, etc.) based on operating the vibration device to controllably overcome bridging of the granular material in the vibratory hopper conduit of the vibratory hopper.

The controlling at S904 may include adjustably controlling the vibration device to adjustably control (e.g., throttle, meter, etc.) the amplitude and/or frequency of the vibrations generated by the vibration device and thus to adjustably control the amplitude and/or frequency of the vibrations induced in the vibratory hopper (e.g., also referred to as adjustable control of the vibration of the vibratory hopper). Such adjustable control of the vibration of the vibratory hopper may adjustably control (e.g., throttle, meter, control, restrict, etc.) the magnitude of the flow of granular material out of the throttle device and into the doser reservoir of the doser mechanism, thereby adjustably controlling (e.g., metering, throttling, restricting, controlling, etc.) the head pressure of granular material in the doser reservoir at an exposed portion of a conveyor device of the doser mechanism which is exposed to the doser reservoir. The controlling at S904 to operate the vibration device may cause a head pressure of the granular material (e.g., granular material 194) at the portion of the conveyor device extending into the doser reservoir to be less (e.g., smaller) than a threshold head pressure associated with bridging of the granular material at the conveyor device, thereby potentially reducing, minimizing, or preventing bridging of the granular material in the doser reservoir based on causing the head pressure in the doser reservoir at least at the exposed portion of the conveyor device to remain below a threshold head pressure at which bridging of the granular material is likely to occur, thereby reducing, minimizing, or preventing restriction of flow of granular material that may be drawn out of the doser reservoir by the conveyor device.

At S910, at least one index operation is performed to “index” a particular amount (e.g., index amount) of granular material from the doser mechanism (e.g., from opening 180-2 thereof as shown in at least FIGS. 2B-2C). At S912, the index operation S910 may include determining whether to start operation of (e.g., activate, turn on to an “on” operating state, etc.) the conveyor device (e.g., an auger conveyor) to initiate movement of granular material 196 out of the doser reservoir 130. If not (S912=NO), a determination is made regarding whether to stop the flow induced by the throttle device at S922, for example to prevent excessive granular material buildup in the doser reservoir. If so (S912=YES), at S914 the conveyor device is controlled to activate (e.g., turn on, induce rotation of the auger conveyor, etc.).

At S915, the activated conveyor device operates to draw at least a portion of granular material out of the doser reservoir and convey granular material towards an outlet opening of the doser mechanism. At S916, the activated conveyor device operates to move an amount (e.g., index amount) of granular material through the outlet opening to be discharged from the doser mechanism. It will be understood that the operations at S915 and S916 may be performed simultaneously, for example to draw a first amount of the granular material out of the doser reservoir and to discharge a second amount (e.g., a separate amount) of the granular material from the doser mechanism via the doser outlet based on operation of the activated conveyor device for a period of time in response to activation of the conveyor device at S914 in response to S912=YES. For example, at S915 a portion of the conveyor device that is exposed to the doser reservoir may draw a first portion of granular material from the doser reservoir to be moved by the conveyor device towards the outlet opening, while simultaneously at S916 a separate, distal portion of the conveyor device that is proximate to the outlet opening causes a second portion of granular material to be moved through the outlet opening to be discharged as the index amount. For example, referring to FIGS. 1, 2A-2D, and 3A-3C, the conveyor device 120 may discharge an amount of granular material 198 through outlet opening 180-2 as an index amount while simultaneously moving a separate amount of granular material 196 through a tubular conduit 118 toward the opening 180-2 and further drawing at least a portion of the granular material 194 into the tubular conduit 118 as granular material 196 via the inlet opening 180-1 and/or doser reservoir outlet opening 130O to replace the amount of granular material 198 discharged from the tubular conduit 118 via the outlet 180-2 as the index amount. For example, an amount of granular material drawn from the doser reservoir (e.g., as granular material 196) at S915 in a given index operation S910 may not be included in the amount of granular material discharged from the doser mechanism at S916 (e.g., as an index amount of granular material 198) during the same index operation S910. At least a portion of the granular material 196 being conveyed through the tubular conduit 118 may remain within the conduit between separate index operations S910 and/or may be progressively conveyed towards the outlet opening (e.g., 180-2) by the conveyor device over the course of multiple index operations S910 and may be discharged from the doser mechanism at S916 in a separate, subsequent index operation S910.

The operating of the conveyor device at S914 to S916 may be performed concurrently (e.g., simultaneously) with the vibration device of the throttle device operating (e.g., being activated, turned on, etc.) to control (e.g., throttle, meter, etc.) a flow of the granular material from the vibratory hopper conduit to the doser reservoir through the vibratory hopper bottom opening to cause the head pressure of the granular material at the portion of the conveyor device that is exposed to the doser reservoir to be less than a threshold pressure magnitude that is associated with bridging of the granular material at the conveyor device in the doser reservoir, thereby reducing, minimized, or preventing bridging in the doser reservoir (e.g., at the exposed portion of the conveyor device) and corresponding flow restrictions of the granular material out of the doser reservoir via the conveyor device.

The operations at S914 to S916 may be performed based on operating the conveyor device to convey granular material for a particular period of time, such that an amount of granular material is discharged through the outlet opening over the particular period of time, thereby causing the index amount of granular material to have a particular mass corresponding to the amount of granular material discharged over the particular period of time.

At S918, a determination is made regarding whether to stop operation of the conveyor device (e.g., deactivate the conveyor device, turn off the conveyor device to an “off” operating state, etc.) to thereby inhibit (e.g., cease, stop, etc.) discharge of granular material through the outlet opening and thus end the index operation S910. If not (S918=NO), the operations at S915 and S916 continue. If so (S918=YES), the conveyor device is deactivated (stopped), thereby stopping both the drawing of granular material from the doser reservoir by the conveyor device and stopping the discharge of granular material from the doser mechanism by the conveyor device, and thus ending the given index operation S910. As shown, based on a subsequent determination of S922-NO, multiple index operations S910 may be performed sequentially (e.g., at a fixed interval between sequential index operations S910).

At S922, a determination is made regarding whether to control the throttle device to stop (e.g., inhibit) the flow of granular material in to the doser reservoir of the doser mechanism (e.g., to cease indexing operations, to take the doser mechanism off-line for maintenance operations, etc.). If not (S922=NO), the process reverts to start another index operation S910 at S912. The reverting to start another index operation may include a time delay of a particular period of time before re-starting the conveyor device at S912=YES to begin indexing another index amount of granular material from the doser mechanism. If S922=YES, at S924 a vibration device of the throttle device may be controlled (e.g., via control of a driving device and/or via control of the vibration device via electrical signals transmitted thereto) to reduce or inhibit vibrations generated by the vibration device, thereby reducing or inhibiting vibrations of the vibratory hopper. The reduced or inhibited vibrations of the vibratory hopper may cause the vibratory hopper to induce bridging of the granular material held in the vibratory hopper, thereby reducing or inhibiting the flow of granular material out of the vibratory hopper via the bottom opening thereof into the doser reservoir. The doser mechanism may be taken off-line and subjected to maintenance operations subsequent to S924, while the throttle device may hold bridged granular material therein. As shown, the process may then revert to S902 to determine whether to re-start flow of granular material from the throttle device to the doser reservoir of the doser mechanism.

In some example embodiments, the determination at S918 may be based on a determination of whether the conveyor device of the doser mechanism has been in the “on” state (e.g., that the drive motor 124 has been rotating the driveshaft thereof) for at least a particular (e.g., threshold) period of time. For example, an operation timer for conveyor device operation may be initialized and/or reset to t=0 seconds at S914 when the conveyor device is caused to be switched to the “on” operating state (e.g., activated). The conveyor device may be associated with a threshold operating time (e.g., t=1.2 seconds), which may be stored at a control device controlling the conveyor device (e.g., in a memory 794 of control device 790). The control device may determine at S918 whether the elapsed time “t” since performance of S914 equals or exceeds the threshold operating time (e.g., whether t≥1.2). If not, S918=NO. If so, S918=YES and the method proceeds to S920 where the conveyor device (and, in some example embodiments, a vibration device of the throttle device) is caused to stop.

As described herein, the control device 790 may determine a particular duration of an index operation S910 and/or a rate of operation of a conveyor device (e.g., a rate of rotation of one or more augers of the conveyor device) based on a determined (e.g., desired, commanded, etc.) granular material type and/or granular material index amount. The control device 790 may access a database (e.g., empirically-generated look-up table) to determine the particular duration (e.g., threshold operating time) of an index operation S910 (e.g., duration of rotation of the drive motor 124, which may be represented by a duration that electrical power is controlled to be supplied to the drive motor), amount and/or rate of electrical power supplied to the drive motor 124, and/or a rate of rotation of the driveshaft of the drive motor 124 during the index operation (which may be represented by amount and/or rate of power applied to drive motor 124) that is associated with the determined (e.g., desired, commanded, etc.) granular material type and/or granular material index amount and may control the drive motor 124 (and, in some example embodiments, the vibration device 316) at S914-S920 to operate at the determined rate and for the determined duration (e.g., supply the determined amount and/or rate of power for the determined duration), to cause the conveyor device to operate at a particular operating rate (e.g., to cause one or more augers thereof to rotate at a particular corresponding rate) for the determined duration, to cause the doser mechanism 100 to supply a particular amount of an index (e.g., 752) of granular material. The aforementioned look-up table may be empirically generated using a same type of doser mechanism as the doser mechanism being controlled by the control device to perform the index operation, such that the index duration (e.g., drive motor operation duration) and drive motor rate of rotation (e.g., amount and/or rate of supplied electrical power, driveshaft rate of rotation, etc.) stored in the look-up table correspond accurately to the corresponding index amount and type of the granular material.

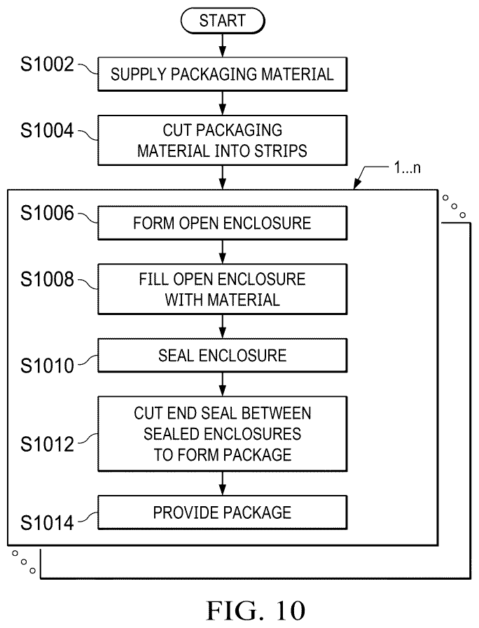

FIG. 10 is a flowchart illustrating a method of operating a packaging machine that includes a doser apparatus that further includes a drop-down device, according to some example embodiments. The method shown in FIG. 10 may be implemented with regard to any of the packaging machines according to any of the example embodiments (e.g., implemented by a control device controlling the packaging machine and/or doser mechanism). The method shown in FIG. 10 may be implemented with regard to any of the packaging machines according to any of the example embodiments, including for example a control device configured to control one or more portions of the packaging machines (e.g., control device 790). It will be understood that operations of the method shown in FIG. 10 may be performed in a different order than shown in FIG. 10. It will further be understood that some operations shown in FIG. 10 may be omitted from the method in some example embodiments and/or some additional operations not shown in FIG. 10 may be added to the method.

At S1002, a packaging supply device of the packaging machine (e.g., packaging supply device 710) is operated (e.g., based on controlling a drive motor and/or drive transmission) to supply a sheet of packaging material (e.g., from a roll of packaging material).

At S1004, the sheet of packaging material is supplied into contact with an array of cutting devices (e.g., blades 722-1 to 722-(n−1)) which may divide the sheet of packaging material into a plurality of separate strips of packaging material (e.g., strips 726-1 to 726-n).

At S1006-S1014, each separate strip of packaging material may be directed to be fed through a separate process stream of “n” process streams of the packaging machine 700. Step S1004 may be absent when the packaging machine 700 includes a single process stream. Steps S1006-S1014 may be each described with reference to an nth process stream, but it will be understood that steps S1006-S1014 may be performed at least partially in parallel in the 1 to nth process streams.

At S1006, each separate strip of packaging material may be folded, for example by a separate folding device (e.g., 730-n), into a separate folded strip (e.g., 728-n) defining an open enclosure (e.g., 734) having an opening (e.g., 7340) at a proximate end (e.g., 734a) and an end seal (e.g., 748) at a distal end (e.g., 734b). The strip may be fed to the folding device (e.g., 730-n) so that the nth folded strip defines an open enclosure that is enclosed perpendicularly to the local feed direction of the strip and is open at a top end that faces upwards as the folded strip is continued to be fed in the given process stream and is closed (e.g., by an end seal 748) at a bottom end.

At S1008, each separate doser mechanism of the doser apparatus of the packaging machine (e.g., 100-n) may supply a particular amount (e.g., index 752) of granular material into a separate open enclosure (e.g., 734) defined by a separate folded strip of packaging material (e.g., 728-n) through the open end thereof to at least partially fill the distal end of the open enclosure of the folded strip (e.g., fill at least a distal portion of the open enclosure that is adjacent to the end seal (e.g., 748) that closes the distal end of the open enclosure) with at least a particular amount (e.g., index 752) of granular material. As shown in FIGS. 6 and 7C, each doser mechanism of each respective process stream may be at least partially vertically aligned (e.g., at least partially vertically overlapped) with the open top end of a separate open enclosure of a separate folded strip of packaging material. Each doser mechanism may be controlled to implement an index operation that supplies a flow of granular material (e.g., granular material 198) at a particular rate, for a particular duration, before stopping the flow, to cause the particular amount (e.g., index 752) of granular material to be supplied into the open enclosure, for example as shown in the method illustrated in FIG. 9. Such control may be implemented based on controlling a duration, applied power, and/or rate of rotation of a drive motor (e.g., servomotor) of the doser mechanism and/or controlling a vibration device of a vibratory hopper of a throttle device to adjustably control (e.g., throttle, meter, etc.) a flow of granular material into the doser mechanism.

At S1010, a folded strip having an open enclosure at least partially filled (e.g., at least the distal portion 734-1 is filled) with an index (e.g., 752) of granular material supplied from a doser mechanism is fed in a local feed direction (e.g., downwards) to a sealing device (e.g., sealing device 740) that seals at least the filled portion (e.g., distal portion 734-1) of the open enclosure to partition the distal portions (e.g., 734-1) of the open enclosure, and the index of granular material contained therein, into a separate sealed enclosure (e.g., 750), also referred to as a sealed article of packaging, sealed pouch, sealed package, sealed packet, or the like, that is defined to extend between adjacent and opposite end seals in the folded strip and contains a particular amount of granular material therein (e.g., index 752), the sealed enclosure being partitioned in the nth local feed direction by an end seal (e.g., 748) formed by sealing opposing inner surfaces of the open enclosure. The packaging machine 700 may be configured to partition the folded strips 728-1 to 728-n into sealed enclosures 750 that each contain an index 752 of granular material that is a same or substantially same amount (e.g., dose) of granular material. The operation of the sealing device may be synchronized with the operation of a doser mechanism so that the sealing device forms an end seal to seal a given distal portion of the open enclosure, and index contained therein, after the completion of an index operation by the doser mechanism and prior to the starting of a next index operation (e.g., the doser mechanism is in an “off” operating state and is not presently supplying granular material). As a result, the operation of the sealing device, by sealing a given distal portion of the open enclosure and contained index from a proximate portion of the open enclosure, forms a new end seal that establishes a new distal end and distal portion of the open enclosure that is devoid (e.g., empty) or substantially devoid of granular material prior to the start of a new index operation by the doser mechanism to at least partially fill the new distal portion of the open enclosure with a new index of granular material. As a result, such synchronization may improve the accuracy and precision of the amount of each index of granular material in each sealed enclosure and may further reduce or prevent granular material from being trapped in a formed end seal.

At S1012, each nth folded strip having isolated (e.g., partitioned) sealed enclosures separated by end seals is fed in an nth local feed direction (e.g., downwards) from the sealing device to a cutting device (e.g., cutting device 760) that cuts through each separate end seal of the nth folded strip to separate distal (e.g., bottom) sealed enclosures of the nth folded strip from a remainder of the nth folded strip to thus establish (e.g., form) packages (e.g., packages 770, also referred to herein as articles of packaging) that each contain a particular amount (e.g., index 752, dose, etc.) of granular material. At S1014, the packages are provided, or supplied, to a collection area or bin. The packages may be allowed to fall from the cutting device to a collection area or bin. The packages may be directed to a conveyor that transports the packages to a collection area or bin.

In some example embodiments, the method shown in FIG. 10 may include any operations of the method shown in FIG. 9 in any order. For example, the method shown in FIG. 10 may further include, at any time during the method, performing any of S902 to S924 of the method shown in FIG. 9.

Some Example Embodiments of the inventive concepts are as follows below:
Example Embodiment 1: A doser apparatus (10), comprising:
a doser mechanism (100), the doser mechanism including a conveyor device (120) and one or more inner surfaces (130S) defining a doser reservoir (130), the doser reservoir having a reservoir inlet opening (130U) and a reservoir outlet opening (130O), at least a portion of the conveyor device extending into the doser reservoir through the reservoir outlet opening, the doser mechanism configured to discharge an index amount of a granular material based on operation of the conveyor device to draw a portion of the granular material from the doser reservoir through the reservoir outlet opening and to discharge the portion of the granular material from a doser outlet (180-3); and
a throttle device (300) on the doser mechanism, the throttle device including
   a vibratory hopper (310) defining a vibratory hopper conduit (310V) tapering from a vibratory hopper top opening (310U) towards a vibratory hopper bottom opening (310B), the vibratory hopper configured to hold a first amount of the granular material within the vibratory hopper conduit, the vibratory hopper configured to induce bridging of the granular material at the vibratory hopper bottom opening, and
   a vibration device (316) mechanically coupled to the vibratory hopper, the vibration device configured to break the bridging of the granular material at the vibratory hopper bottom opening to induce a flow of the granular material from the vibratory hopper conduit to the doser reservoir through the vibratory hopper bottom opening, based on inducing vibration of the vibratory hopper,
wherein the throttle device is configured to control a head pressure of the granular material at the portion of the conveyor device extending into the doser reservoir based on operating the vibration device to adjustably control the flow of the granular material from the vibratory hopper conduit to the doser reservoir through the vibratory hopper bottom opening.
Example Embodiment 2: The doser apparatus of Example Embodiment 1, further comprising:
a supply hopper (200) on the throttle device, the supply hopper configured to hold a supply amount of the granular material within a supply hopper conduit (200V) at least partially tapering from a supply hopper top opening (200U) towards a supply hopper bottom opening (200B), the supply hopper configured to direct a supply flow of the granular material from the supply hopper conduit to the vibratory hopper conduit through the supply hopper bottom opening.
Example Embodiment 3: The doser apparatus of Example Embodiment 2, further comprising:
a plurality of doser mechanisms (100-1 to 100-n), the plurality of doser mechanisms including the doser mechanism, the plurality of doser mechanisms each having a separate doser reservoir (130) and a separate conveyor device (120), the plurality of doser mechanisms configured to discharge separate, respective amounts of the granular material in parallel, and
a plurality of throttle devices (300-1 to 300-n) coupled between the supply hopper and separate, respective doser mechanisms of the plurality of doser mechanisms, the plurality of throttle devices including the throttle device, the plurality of throttle devices configured to supply multiple, parallel flows of the granular material from the supply hopper to separate, respective doser reservoirs of the plurality of doser mechanisms.
Example Embodiment 4: The doser apparatus of Example Embodiment 1, wherein the throttle device is configured to enable the vibratory hopper to move in relation to the doser mechanism.
Example Embodiment 5: The doser apparatus of Example Embodiment 1, wherein at least a portion of the vibratory hopper extends into the doser reservoir such that the vibratory hopper bottom opening is between the reservoir inlet opening and the reservoir outlet opening.
Example Embodiment 6: The doser apparatus of Example Embodiment 1, wherein the throttle device includes an intake hopper (330) on the vibratory hopper, the intake hopper defining an intake hopper conduit (330V) at least partially tapering from an intake hopper top opening (330U) to an intake hopper bottom opening (330B), the intake hopper configured to direct an intake flow of the granular material from the intake hopper conduit through the intake hopper bottom opening and into the vibratory hopper conduit through the vibratory hopper top opening.
Example Embodiment 7: The doser apparatus of Example Embodiment 6, wherein the intake hopper is fixed in position in relation to the doser mechanism, and the throttle device is configured to enable movement of the vibratory hopper in relation to the intake hopper.
Example Embodiment 8: The doser apparatus of Example Embodiment 7, wherein a bottom portion (332) of the intake hopper extends vertically through the vibratory hopper top opening and into the vibratory hopper conduit, such that
the vibratory hopper at least partially surrounds the bottom portion of the intake hopper, and
the throttle device is configured to mitigate flow of the granular material out of the vibratory hopper conduit through an annular portion of the vibratory hopper top opening defined between an outer surface of the bottom portion of the intake hopper and an inner surface of the vibratory hopper defining an upper portion of the vibratory hopper conduit.
Example Embodiment 9: The doser apparatus of Example Embodiment 8, wherein the bottom portion of the intake hopper that extends into the vibratory hopper conduit is isolated from direct contact with the vibratory hopper.
Example Embodiment 10: The doser apparatus of Example Embodiment 6, further comprising:
a supply hopper (200) on the throttle device, the supply hopper configured to hold a supply amount of the granular material within a supply hopper conduit (200V) at least partially tapering from a supply hopper top opening (200U) towards a supply hopper bottom opening (200B), the supply hopper configured to direct a supply flow of the granular material from the supply hopper conduit to the intake hopper conduit through the supply hopper bottom opening and the intake hopper top opening.
Example Embodiment 11: The doser apparatus of claim 10, wherein a bottom portion (204) of the supply hopper extends vertically through the intake hopper top opening and into the intake hopper conduit, such that
the intake hopper at least partially surrounds the bottom portion of the supply hopper, and
the throttle device is configured to mitigate flow of the granular material out of the intake hopper conduit through an annular portion of the intake hopper top opening defined between an outer surface of the bottom portion of the supply hopper and an inner surface of the intake hopper defining an upper portion of the intake hopper conduit.
Example Embodiment 12: The doser apparatus of Example Embodiment 11, wherein the bottom portion of the supply hopper that extends into the intake hopper conduit is isolated from direct contact with the intake hopper.
Example Embodiment 13: A packaging machine (700), comprising:
the doser apparatus of Example Embodiment 1;
a packaging supply device (710) configured to supply a strip of packaging material (726) that is folded to establish a folded strip of packaging material (728) that defines an open enclosure (734) having an enclosure opening, wherein the doser apparatus is configured to discharge the index amount of the granular material into the open enclosure through the enclosure opening to at least partially fill a distal portion of the open enclosure with the index amount of the granular material;
a sealing device (740) configured to join opposing surfaces of the folded strip of packaging material to isolate the distal portion of the open enclosure from a remainder of the open enclosure that includes the enclosure opening such that the isolated distal portion of the open enclosure establishes a sealed enclosure (750) that contains the index amount of the granular material in the folded strip of packaging material; and
a cutting device (760) configured to separate the sealed enclosure from a remainder of the folded strip of packaging material to establish an article of packaging (770) that contains the index amount of the granular material.
Example Embodiment 14: A method of operating the doser apparatus of Example Embodiment 1, the method comprising:
controlling the conveyor device of the doser mechanism to operate to draw a granular material out of the doser reservoir and to discharge the granular material from the doser mechanism via the doser outlet; and
operating the vibration device of the throttle device on the doser mechanism to induce a flow of the granular material from the vibratory hopper conduit to the doser reservoir through the vibratory hopper bottom opening based on inducing vibration of the vibratory hopper to overcome the bridging of the first amount of the granular material in the vibratory hopper conduit,
wherein the vibration device is operated to control the flow of the granular material from the vibratory hopper conduit to the doser reservoir through the vibratory hopper bottom opening concurrently with the operating of the conveyor device to cause the head pressure of the granular material at the portion of the conveyor device that is exposed to the doser reservoir to be less than a threshold pressure magnitude that is associated with bridging of the granular material at the conveyor device in the doser reservoir.
Example Embodiment 15: A doser apparatus (10), comprising:
a doser mechanism (100), the doser mechanism including a conveyor device (120) and one or more inner surfaces (130S) defining a doser reservoir (130), the doser reservoir having a reservoir inlet opening (130U) and a reservoir outlet opening (130O), at least a portion of the conveyor device extending into the doser reservoir through the reservoir outlet opening, the conveyor device further extending at least between the reservoir outlet opening and a doser outlet opening (180-3); and
a throttle device (300) on the doser mechanism, the throttle device including
   a vibratory hopper (310) defining a vibratory hopper conduit (310V) tapering from a vibratory hopper top opening (310U) towards a vibratory hopper bottom opening (310B), the vibratory hopper bottom opening vertically overlapping the reservoir inlet opening, and
   a vibration device (316) mechanically coupled to the vibratory hopper.
Example Embodiment 16: The doser apparatus of Example Embodiment 15, further comprising:
a supply hopper (200) on the throttle device, the supply hopper defining a supply hopper conduit (200V) tapering from a supply hopper top opening (200U) towards a supply hopper bottom opening (200B), the supply hopper bottom opening vertically overlapping the vibratory hopper top opening.
Example Embodiment 17: The doser apparatus of Example Embodiment 16, wherein at least a portion of the supply hopper extends into the vibratory hopper conduit such that the supply hopper bottom opening is between the vibratory hopper top opening and the vibratory hopper bottom opening.
Example Embodiment 18: The doser apparatus of Example Embodiment 16, further comprising:
a plurality of doser mechanisms (100-1 to 100-n), the plurality of doser mechanisms including the doser mechanism, the plurality of doser mechanisms each having a separate doser reservoir (130) and a separate conveyor device (120) at least partially extending into the separate doser reservoir, and
a plurality of throttle devices (300-1 to 300-n) coupled between the supply hopper and separate, respective doser reservoirs of separate, respective doser mechanisms of the plurality of doser mechanisms, the plurality of throttle devices including the throttle device.
Example Embodiment 19: The doser apparatus of Example Embodiment 15, wherein the throttle device includes
an interface structure (320) coupled to the doser mechanism such that the interface structure is fixed in position in relation to the doser mechanism, and
at least one standoff member (340) configured to couple the vibratory hopper to the interface structure such that the vibratory hopper is structurally supported on the interface structure by the at least one standoff member, the at least one standoff member configured to enable the vibratory hopper to move in relation to the interface structure.
Example Embodiment 20: The doser apparatus of Example Embodiment 15, wherein at least a portion of the vibratory hopper extends into the doser reservoir such that the vibratory hopper bottom opening is between the reservoir inlet opening and the reservoir outlet opening.
Example Embodiment 21: The doser apparatus of Example Embodiment 20, wherein the portion of the vibratory hopper extending into the doser reservoir is isolated from direct contact with any inner surface of the doser mechanism defining the doser reservoir.
Example Embodiment 22: The doser apparatus of Example Embodiment 20, wherein
the doser mechanism includes a doser cartridge (110) that is removably coupled to a remainder of the doser mechanism (134), the doser cartridge including the conveyor device and defining a lower portion (130-1) of the doser reservoir, the remainder of the doser mechanism defining an upper portion (130-2) of the doser reservoir, and
the portion of the vibratory hopper extending into the doser reservoir is entirely within the upper portion of the doser reservoir and is spaced apart from the lower portion of the doser reservoir that is defined by the doser cartridge.
Example Embodiment 23: The doser apparatus of Example Embodiment 15, wherein the throttle device includes an intake hopper (330) on the vibratory hopper, the intake hopper defining an intake hopper conduit (330V) tapering from an intake hopper top opening (330U) towards an intake hopper bottom opening (330B), the intake hopper bottom opening vertically overlapping the vibratory hopper top opening.
Example Embodiment 24: The doser apparatus of Example Embodiment 23, wherein at least a portion of the intake hopper extends into the vibratory hopper conduit such that the intake hopper bottom opening is between the vibratory hopper top opening and the vibratory hopper bottom opening.
Example Embodiment 25: The doser apparatus of Example Embodiment 24, wherein the portion of the intake hopper extending into the vibratory hopper conduit is isolated from direct contact with any inner surface of the vibratory hopper defining the vibratory hopper conduit.
Example Embodiment 26: The doser apparatus of Example Embodiment 23, wherein the intake hopper is fixed in position in relation to the doser mechanism, and the vibratory hopper is movable in relation to the intake hopper.
Example Embodiment 27: The doser apparatus of Example Embodiment 23, further comprising:
a supply hopper (200) on the throttle device, the supply hopper defining a supply hopper conduit (200V) tapering from a supply hopper top opening (200U) towards a supply hopper bottom opening (200B), the supply hopper bottom opening vertically overlapping the intake hopper top opening, the supply hopper bottom opening between the supply hopper top opening and the intake hopper top opening.
Example Embodiment 28: The doser apparatus of Example Embodiment 27, wherein at least a portion of the supply hopper extends into the intake hopper conduit such that the supply hopper bottom opening is between the intake hopper top opening and the intake hopper bottom opening.
Example Embodiment 29: The doser apparatus of Example Embodiment 15, wherein the vibration device is a pneumatic ball vibration device.
Example Embodiment 30: A packaging machine (700), comprising:
the doser apparatus of Example Embodiment 15;
a packaging supply device (710) configured to supply a strip of packaging material (726) that is folded to establish a folded strip of packaging material (728) that defines an open enclosure (734) having an enclosure opening, wherein the doser apparatus is configured to discharge an index amount of a granular material into the open enclosure through the enclosure opening to at least partially fill a distal portion of the open enclosure with the index amount of the granular material;
a sealing device (740) configured to join opposing surfaces of the folded strip of packaging material to isolate the distal portion of the open enclosure from a remainder of the open enclosure that includes the enclosure opening such that the isolated distal portion of the open enclosure establishes a sealed enclosure (750) that contains the index amount of the granular material in the folded strip of packaging material; and
a cutting device (760) configured to separate the sealed enclosure from a remainder of the folded strip of packaging material to establish an article of packaging (770) that contains the index amount of the granular material.
Example Embodiment 31: A method of operating the doser apparatus of Example Embodiment 15, the method comprising:
controlling the conveyor device of the doser mechanism to operate to draw a granular material out of the doser reservoir and to discharge the granular material from the doser mechanism via the doser outlet; and causing a flow of the granular material to be supplied from the vibratory hopper of the throttle device to the doser reservoir via the vibratory hopper bottom opening, based on operating the vibration device to controllably overcome bridging of the granular material in the vibratory hopper conduit of the vibratory hopper.
Example Embodiment 32: The method of Example Embodiment 31, wherein the operating the vibration device causes a head pressure of the granular material at the portion of the conveyor device extending into the doser reservoir to be less than a threshold head pressure associated with bridging of the granular material at the conveyor device.

Some example embodiments have been disclosed herein; it should be understood that other variations may be possible. Such variations are not to be regarded as a departure from the spirit and scope of the present inventive concepts, and all such modifications as would be obvious to one skilled in the art are intended to be included within the scope of the following claims.

What is claimed:

1. A doser apparatus, comprising:
a doser mechanism, the doser mechanism including a conveyor device and one or more inner surfaces defining a doser reservoir, the doser reservoir having a reservoir inlet opening and a reservoir outlet opening, at least a portion of the conveyor device extending into the doser reservoir through the reservoir outlet opening, the doser mechanism configured to discharge an index amount of a granular material based on operation of the conveyor device to draw a portion of the granular material from the doser reservoir through the reservoir outlet opening and to discharge the portion of the granular material from a doser outlet; and
a throttle device on the doser mechanism, the throttle device including
a vibratory hopper defining a vibratory hopper conduit tapering from a vibratory hopper top opening towards a vibratory hopper bottom opening, the vibratory hopper configured to hold a first amount of the granular material within the vibratory hopper conduit, the vibratory hopper configured to induce bridging of the granular material at the vibratory hopper bottom opening, and
a vibration device mechanically coupled to the vibratory hopper, the vibration device configured to break the bridging of the granular material at the vibratory hopper bottom opening to induce a flow of the granular material from the vibratory hopper conduit to the doser reservoir through the vibratory hopper bottom opening, based on inducing vibration of the vibratory hopper,
wherein the throttle device is configured to control a head pressure of the granular material at the portion of the conveyor device extending into the doser reservoir based on operating the vibration device to adjustably control the flow of the granular material from the vibratory hopper conduit to the doser reservoir through the vibratory hopper bottom opening.

2. The doser apparatus of claim 1, further comprising:
a supply hopper on the throttle device, the supply hopper configured to hold a supply amount of the granular material within a supply hopper conduit at least partially tapering from a supply hopper top opening towards a supply hopper bottom opening, the supply hopper configured to direct a supply flow of the granular material from the supply hopper conduit to the vibratory hopper conduit through the supply hopper bottom opening.

3. The doser apparatus of claim 2, further comprising:
a plurality of doser mechanisms, the plurality of doser mechanisms including the doser mechanism, the plurality of doser mechanisms each having a separate doser reservoir and a separate conveyor device, the plurality of doser mechanisms configured to discharge separate, respective amounts of the granular material in parallel, and
a plurality of throttle devices coupled between the supply hopper and separate, respective doser mechanisms of the plurality of doser mechanisms, the plurality of throttle devices including the throttle device, the plurality of throttle devices configured to supply multiple, parallel flows of the granular material from the supply hopper to separate, respective doser reservoirs of the plurality of doser mechanisms.

4. The doser apparatus of claim 1, wherein the throttle device is configured to enable the vibratory hopper to move in relation to the doser mechanism.

5. The doser apparatus of claim 1, wherein at least a portion of the vibratory hopper extends into the doser reservoir such that the vibratory hopper bottom opening is between the reservoir inlet opening and the reservoir outlet opening.

6. The doser apparatus of claim 1, wherein the throttle device includes an intake hopper on the vibratory hopper, the intake hopper defining an intake hopper conduit at least partially tapering from an intake hopper top opening to an intake hopper bottom opening, the intake hopper configured to direct an intake flow of the granular material from the intake hopper conduit through the intake hopper bottom opening and into the vibratory hopper conduit through the vibratory hopper top opening.

7. The doser apparatus of claim 6, wherein the intake hopper is fixed in position in relation to the doser mechanism, and the throttle device is configured to enable movement of the vibratory hopper in relation to the intake hopper.

8. The doser apparatus of claim 7, wherein a bottom portion of the intake hopper extends vertically through the vibratory hopper top opening and into the vibratory hopper conduit, such that
the vibratory hopper at least partially surrounds the bottom portion of the intake hopper, and
the throttle device is configured to mitigate flow of the granular material out of the vibratory hopper conduit through an annular portion of the vibratory hopper top opening defined between an outer surface of the bottom portion of the intake hopper and an inner surface of the vibratory hopper defining an upper portion of the vibratory hopper conduit.

9. The doser apparatus of claim 8, wherein the bottom portion of the intake hopper that extends into the vibratory hopper conduit is isolated from direct contact with the vibratory hopper.

10. The doser apparatus of claim 6, further comprising:
a supply hopper on the throttle device, the supply hopper configured to hold a supply amount of the granular material within a supply hopper conduit at least partially tapering from a supply hopper top opening towards a supply hopper bottom opening, the supply hopper configured to direct a supply flow of the granular material from the supply hopper conduit to the intake hopper conduit through the supply hopper bottom opening and the intake hopper top opening.

11. The doser apparatus of claim 10, wherein a bottom portion of the supply hopper extends vertically through the intake hopper top opening and into the intake hopper conduit, such that
the intake hopper at least partially surrounds the bottom portion of the supply hopper, and
the throttle device is configured to mitigate flow of the granular material out of the intake hopper conduit through an annular portion of the intake hopper top opening defined between an outer surface of the bottom portion of the supply hopper and an inner surface of the intake hopper defining an upper portion of the intake hopper conduit.

12. The doser apparatus of claim 11, wherein the bottom portion of the supply hopper that extends into the intake hopper conduit is isolated from direct contact with the intake hopper.

13. A packaging machine, comprising:
the doser apparatus of claim 1;
a packaging supply device configured to supply a strip of packaging material that is folded to establish a folded strip of packaging material that defines an open enclosure having an enclosure opening, wherein the doser apparatus is configured to discharge the index amount of the granular material into the open enclosure through the enclosure opening to at least partially fill a distal portion of the open enclosure with the index amount of the granular material;
a sealing device configured to join opposing surfaces of the folded strip of packaging material to isolate the distal portion of the open enclosure from a remainder of the open enclosure that includes the enclosure opening such that the isolated distal portion of the open enclosure establishes a sealed enclosure that contains the index amount of the granular material in the folded strip of packaging material; and
a cutting device configured to separate the sealed enclosure from a remainder of the folded strip of packaging material to establish an article of packaging that contains the index amount of the granular material.

14. A method of operating the doser apparatus of claim 1, the method comprising:
controlling the conveyor device of the doser mechanism to operate to draw a granular material out of the doser reservoir and to discharge the granular material from the doser mechanism via the doser outlet; and
operating the vibration device of the throttle device on the doser mechanism to induce a flow of the granular material from the vibratory hopper conduit to the doser reservoir through the vibratory hopper bottom opening based on inducing vibration of the vibratory hopper to overcome the bridging of the first amount of the granular material in the vibratory hopper conduit,
wherein the vibration device is operated to control the flow of the granular material from the vibratory hopper conduit to the doser reservoir through the vibratory hopper bottom opening concurrently with the operating of the conveyor device to cause the head pressure of the granular material at the portion of the conveyor device that is exposed to the doser reservoir to be less than a threshold pressure magnitude that is associated with bridging of the granular material at the conveyor device in the doser reservoir.

15. A doser apparatus, comprising:
a doser mechanism, the doser mechanism including a conveyor device and one or more inner surfaces defining a doser reservoir, the doser reservoir having a reservoir inlet opening and a reservoir outlet opening, at least a portion of the conveyor device extending into the doser reservoir through the reservoir outlet opening, the conveyor device further extending at least between the reservoir outlet opening and a doser outlet opening; and
a throttle device on the doser mechanism, the throttle device including
a vibratory hopper defining a vibratory hopper conduit tapering from a vibratory hopper top opening towards a vibratory hopper bottom opening, the vibratory hopper bottom opening vertically overlapping the reservoir inlet opening, and
a vibration device mechanically coupled to the vibratory hopper.

16. The doser apparatus of claim 15, wherein the throttle device includes
an interface structure coupled to the doser mechanism such that the interface structure is fixed in position in relation to the doser mechanism, and
at least one standoff member configured to couple the vibratory hopper to the interface structure such that the vibratory hopper is structurally supported on the interface structure by the at least one standoff member, the at least one standoff member configured to enable the vibratory hopper to move in relation to the interface structure.

17. The doser apparatus of claim 15, wherein at least a portion of the vibratory hopper extends into the doser reservoir such that the vibratory hopper bottom opening is between the reservoir inlet opening and the reservoir outlet opening.

18. The doser apparatus of claim 17, wherein the portion of the vibratory hopper extending into the doser reservoir is isolated from direct contact with any inner surface of the doser mechanism defining the doser reservoir.

19. The doser apparatus of claim 17, wherein
the doser mechanism includes a doser cartridge that is removably coupled to a remainder of the doser mechanism, the doser cartridge including the conveyor device and defining a lower portion of the doser reservoir, the remainder of the doser mechanism defining an upper portion of the doser reservoir, and
the portion of the vibratory hopper extending into the doser reservoir is entirely within the upper portion of the doser reservoir and is spaced apart from the lower portion of the doser reservoir that is defined by the doser cartridge.

20. The doser apparatus of claim 15, wherein the vibration device is a pneumatic ball vibration device.
